(19) United States
(12) Patent Application Publication
(10) Pub. No.: US 2008/0083597 A1
(43) Pub. Date: Apr. 10, 2008

(54) PRODUCT TRANSPORT APPARATUS

(75) Inventors: Heizaburo KATO, Kikugawa-shi (JP); Toshinao KATO, Kikugawa-shi (JP)

Correspondence Address: MORRISON & FOERSTER LLP, 1650 TYSONS BOULEVARD, SUITE 400, MCLEAN, VA, 22102, US

(73) Assignee: SANKYO SEISAKUSHO CO., Tokyo (JP)

(21) Appl. No.: 11/865,546

(22) Filed: Oct. 1, 2007

(30) Foreign Application Priority Data
Oct. 4, 2006 (JP) 2006-273011
Feb. 28, 2007 (JP) 2007-049756
Feb. 28, 2007 (JP) 2007-049757

(51) Int. Cl. B65G 21/10; B65G 47/14

(52) U.S. Cl. 198/631.1

(57) ABSTRACT

A product transport apparatus is provided that includes a transport section that oscillates in a transport direction and in a vertical direction in order to transport a product; a plurality of oscillation imparting sections including a first cam mechanism for causing the transport section to oscillate in the transport direction and a second cam mechanism for causing the transport section to oscillate in the vertical direction; and a single driving source that drives the plurality of oscillation imparting sections.

### CROSS-REFERENCE TO RELATED APPLICATIONS

The present application claims priority of Japanese Patent Application No. 2006-273011 filed on Oct. 4, 2006, Japanese Patent Application No. 2007-49756 filed on Feb. 28, 2007, and Japanese Patent Application No. 2007-49757 filed on Feb. 28, 2007, which are incorporated herein by reference.

### BACKGROUND

1. Technical Field

The present invention relates to product transport apparatuses.

2. Related Art

Product transport apparatuses are known that include a transport section that oscillates in a transport direction and a vertical direction, and an oscillation imparting section that includes a first cam mechanism for oscillating the transport section in the transport direction and a second cam mechanism for oscillating the transport section in the vertical direction, in order to transport a product (See for example Japanese Patent Application Laid-open Publication No. 2006-124111.). The transport section is a device for forming a transport path when transporting a product, and when the transport section oscillates, the product placed on this transport section (more precisely, a transport surface provided at the upper end of the transport section) is transported along the transport path.

There are also product transport apparatuses including a plurality of oscillation imparting sections. In this case, the product is moved on the transport section by oscillating the transport section due to the cooperation of this plurality of oscillation imparting sections.

Now, in order to properly transport a product, it is necessary that the oscillation imparting operation of each of the plurality of oscillation imparting sections is synchronized. Here, if the speed of the oscillations (that is, the number of oscillations) is adjusted individually for each of the plurality of oscillation imparting sections in order to change the transport speed of the product for example, there is a risk that there are shifts in the timing at which each of the oscillation imparting sections impart the oscillations. As a result, the oscillations from each of the oscillation imparting sections are not transmitted properly to the transport section, and it becomes difficult to properly transport a product with the product transport apparatus.

Furthermore, product transport apparatuses are known to include an oscillation plate that oscillates in a transport direction and a vertical direction, in order to linearly transport a product. With such product transport apparatuses, oscillations in the transport direction and the vertical direction are imparted to the oscillation plate with a cam mechanism, for example (see for example, Japanese Patent Application Laid-open Publication No. 2006-199416). That is to say, by oscillating the oscillation plate in the transport direction and the vertical direction with a cam mechanism, relative slipping of the products on the oscillation plate with respect to the oscillation plate occurs, and as a result, the products are transported in the transport direction.

Now, the more the area of the surface of the oscillation plate on which the products are placed (“placement surface” hereafter) is expanded, the amount of products that can be placed on the placement surface increases, so that the transport capability of the product transport apparatus is improved. However, when the area of the placement surface is expanded, it becomes difficult for the oscillation plate to oscillate properly. That is to say, since oscillations imparted on the oscillation plate attenuate while being transmitted to each part of the oscillation plate, there is the risk that the oscillations are not transmitted properly, the greater the distance from the point where the oscillations are imparted to the oscillation plate. In particular, the oscillations in the vertical direction attenuate easily, and therefore the oscillations are not transmitted properly, as the distance increases from the point where the oscillations in the vertical direction are imparted. As a result, oscillation irregularities occur in the oscillation plate, and it becomes difficult to transport the products on the placement surface properly.

Furthermore, product transport apparatuses for transporting a product are well known (see for example, Japanese Patent Application Laid-open Publication No. 2006-124111). There are also product transport apparatuses in which the product is subjected to an operation such as an inspection, processing or the like while being transported by the product transport apparatus. In order to perform such operation during the transport of the product, for example, a plurality of transport platforms may be provided in the product transport apparatus, and a long transport path may be formed by combining the plurality of transport platforms. Thus, it becomes possible to ensure the space and time for carrying out the operation on the product during transport.

On the other hand, when each of the transport platforms of the product transport apparatus oscillate, relative slipping of the products on each of the transport platforms with respect to the transport platforms occurs. Utilizing this phenomenon of relative slipping of the products, it becomes possible to transport the products on each of the transport platforms. Moreover, if a plurality of transport platforms are provided, after the products have moved on the transport platforms, they are transferred among the transport platforms. As a result, it becomes possible to transport the products along the transport path formed by the plurality of transport platforms.

If the transport path is formed in this way by a plurality of transport platforms, then each of the transport platforms must be properly oscillated in order to transport the product along this transport path. However, if an oscillation imparting mechanism for imparting oscillations is provided for each transport platform individually in order to oscillate each of the transport platforms, then the number of oscillation imparting mechanisms increases, and also the manufacturing costs of the product transport apparatus becomes relatively high.

### SUMMARY

An advantage of some aspects of the present invention is that it is possible to realize a product transport apparatus with which products can be properly transported.

An aspect of the first invention is, a product transport apparatus that includes a transport section that oscillates in a transport direction and a vertical direction in order to transport a product; a plurality of oscillation imparting sections including a first cam mechanism for causing the transport section to oscillate in the transport direction and a second cam mechanism for causing the transport section to oscillate in the vertical direction; and a single driving source that drives each of the plurality of oscillation imparting sections.

An advantage of some aspects of the present invention is that it is possible to realize a product transport apparatus with which products can be properly transported.

Another aspect of the second invention is, a product transport apparatus that includes an oscillation plate that oscillates in a transport direction and a vertical direction in order to linearly transporting a product; at least one first oscillation imparting unit that imparts oscillations in the transport direction to the oscillation plate through a cam mechanism; and at least three second oscillation imparting units that impart oscillations in the vertical direction to the oscillation plate through a cam mechanism.

An advantage of some aspects of the present invention is that it is possible to realize a less expensive product transport apparatus.

Another aspect of the third invention is, a product transport apparatus that includes a transport platform for revolvingly transporting a product by oscillating in a revolving transport direction and a vertical direction; a transport platform for linearly transporting the product by oscillating in a linear transport direction and a vertical direction; a cam-type oscillation imparting mechanism that imparts oscillations on one of the two transport platforms; and an oscillation transmitting member that transmits oscillations from one transport platform to another transport platform, the oscillation transmitting member straddling product transfer sections that are provided on each of the transport platforms for performing a product transfer from one transport platform to the other transport platform.

Features and objects of the present invention other than the above will become clear by reading the description of the present specification with reference to the accompanying drawings.

### BRIEF DESCRIPTION OF THE DRAWINGS

FIG. 1 is a schematic top view of a product transport apparatus 1.

FIG. 2 is a diagram showing the internal structure of the rotary feeder 100, taken along the sectional plane H-H in FIG. 1.

FIG. 3 is a diagram showing the internal structure of the rotary feeder 100, taken along the sectional plane I-I in FIG. 2.

FIG. 4 is a diagram showing the internal structure of the rotary feeder 100, and shows the periphery of the turret 122.

FIG. 5 is a diagram showing the internal structure of the rotary feeder 100, taken along the sectional plane J-J in FIG. 2.

FIG. 6 is a diagram showing the internal structure of the rotary feeder 100, taken along the sectional plane K-K in FIG. 3.

FIG. 7 is a diagram illustrating a modified example of the lift arm 154.

FIG. 8 is a diagram illustrating the operation of the first cam mechanism 140 and the second cam mechanism 150. FIG. 8A is a diagram showing the state of the first cam mechanism 140 and the second cam mechanism 150 before the input shaft 110 rotates. FIG. 8B is a diagram showing the changed state of the first cam mechanism 140 and the second cam mechanism 150 after the input shaft 110 has rotated.

FIG. 9 is an example of a timing chart of the oscillations imparted by the rotary feeder 100.

FIG. 10 is a diagram illustrating the trajectory of the first transport platform 12 when the first transport platform 12 oscillates in the transport direction and the vertical direction.

FIG. 11 is a diagram illustrating the relative slipping phenomenon of the product W.

FIG. 12 is a diagram showing the internal structure of the linear feeder 200, taken along the sectional plane L-L in FIG. 1.

FIG. 13 is a diagram showing the internal structure of the linear feeder 200, taken along the sectional plane M-M in FIG. 12.

FIG. 14 is a diagram illustrating the reciprocal movement in the vertical direction of the lifting platform 256. FIG. 14A is a diagram showing the state when the lifting platform 256 has reached the upper dead center. FIG. 14B is a diagram showing the state when the lifting platform 256 has reached the lower dead center.

FIG. 15 is a diagram illustrating the relation between the operation of the first cam mechanism 240 and the operation of the second cam mechanism 250. FIG. 15A is a diagram illustrating that the first cam mechanism 240 does not impede the oscillation in the vertical direction of the output section 220. FIG. 15B is a diagram illustrating that the second cam mechanism 250 does not impede the oscillation in transport direction of the output section 220.

FIG. 16 is a diagram illustrating the trajectory of the second transport platform 14 when the second transport platform 14 oscillates in the transport direction and the vertical direction.

FIG. 17 is a schematic top view of the product transport apparatus 2 according to a first modified example.

FIG. 18 is a schematic top view of the product transport apparatus 3 according to a second modified example.

FIG. 19 is a schematic top view of the product transport apparatus 4 according to a third modified example.

FIG. 20 is a schematic top view of the product transport apparatus 5 according to a fourth modified example.

FIG. 21 is a schematic top view of the product transport apparatus 6 according to a fifth modified example.

FIG. 22 is a view of a modified example of the transmission mechanism of the driving force from the drive motor 300 in the product transport apparatus 6 according to the fifth modified example.

FIG. 23 is a schematic view of the layout of the product transport apparatus 1001.

FIG. 24 is a diagram showing the internal structure of the first oscillation imparting unit 1100.

FIG. 25 is a diagram showing the internal structure of the second oscillation imparting unit 1200.

FIG. 26 is a diagram schematically showing the layout of the product transport apparatus 1002 according to a first modified example.

FIG. 27 is a diagram schematically showing the layout of the product transport apparatus 1003 according to a second modified example.

FIG. 28 is a diagram schematically showing the layout of the product transport apparatus 1004 according to a third modified example.

FIG. 29 is a diagram showing the product transport apparatus 2001 of the present embodiment.

FIG. 30 is a cross-sectional view showing the main structural components of the first oscillation imparting unit 2100, in a sectional plane that intersects the axial direction of the input shaft 2110.

FIG. 31 is a cross-sectional view showing the main structural components of the first oscillation imparting unit 2100, in a sectional plane taken along A-A in FIG. 30.

FIG. 32 is a cross-sectional view showing the main structural components of the first oscillation imparting unit 2100, taken along a sectional plane that intersects the vertical direction.

FIG. 33 is a cross-sectional view of a section that intersects the axial direction of the input shaft 2110, and illustrates the first cam mechanism 2150.

FIG. 34 is a cross-sectional view of a section that intersets the axial direction of the input shaft 2110, and illustrates the second cam mechanism 2140.

FIG. 35 is a diagram illustrating the output section 2120.

FIG. 36 is a cross-sectional view showing the main structural components of the second oscillation imparting unit 2200, taken along a plane that intersects the axial direction of the input shaft 2210.

FIG. 37 is a cross-sectional view showing the main structural components of the second oscillation imparting unit 2200, taken along B-B in FIG. 36.

FIG. 38 is a cross-sectional view showing the main structural components of the second oscillation imparting unit 2200, taken along a plane that intersects the vertical direction.

FIG. 39 is a diagram illustrating the output section 2220.

FIG. 40 is a diagram showing the product transport apparatus 2002 according to a first modified example.

FIG. 41 is a diagram showing the product transport apparatus 2003 according to a second modified example.

FIG. 42 is a diagram showing the product transport apparatus 2004 according to a third modified example.

FIG. 43 is a diagram showing the product transport apparatus 2005 according to a fourth modified example.

FIG. 44 is a schematic cross-sectional view of the first compound oscillation imparting unit 2600.

FIG. 45 is a schematic cross-sectional view of the second compound oscillation imparting unit 2700.

### DESCRIPTION OF EXEMPLARY EMBODIMENTS

At least the following matters will be made clear by the explanation in the present specification and the description of the accompanying drawings.

A product transport apparatus is provided that includes a transport section that oscillates in a transport direction and a vertical direction in order to transport a product;

a plurality of oscillation imparting sections including a first cam mechanism for causing the transport section to oscillate in the transport direction and a second cam mechanism for causing the transport section to oscillate in the vertical direction; and

a single driving source that drives each of the plurality of oscillation imparting sections.

With this product transport apparatus, it is possible to transport products more properly.

Moreover, the number of oscillations imparted by each of the plurality of oscillation imparting sections in the transport direction and the vertical direction may be the same among the oscillation imparting sections.

With this configuration, the oscillation imparting operations of the oscillation imparting sections are synchronized by driving each of the plurality of oscillation imparting sections with a single driving source, so that the products can be transported even more properly.

Moreover, each of the plurality of oscillation imparting sections may include

a housing for containing the first cam mechanism and the second cam mechanism;

an input shaft rotatably supported by the housing in order to drive the first cam mechanism and the second cam mechanism, and

an output section that fastens and supports the transport section above the output section, the output section being supported by the housing so that it can oscillate in the transport direction and the vertical direction, and

wherein the first cam mechanism and the second cam mechanism oscillate the output section and the transport section integrally.

In this case, the first cam mechanism and the second cam mechanism oscillate the transport section through an output section. Here, the transport section is fastened to this output section, so that the oscillations generated by the cooperation of the first cam mechanism and the second cam mechanism are properly transmitted through the output section to the transport section.

Moreover, a rotatable first cam of the first cam mechanism and a rotatable second cam of the second cam mechanism are supported by the input shaft, and the first cam and the second cam may rotate integrally with the input shaft.

In this case, it is easy to synchronize the rotation of the first cam and the rotation of the second cam, and it becomes possible to impart to the transport section oscillations with which the product placed on the transport section can be transported more easily.

Moreover, the first cam of each of the plurality of oscillation imparting sections may have such a cam profile that the amplitude in the transport direction of the oscillations imparted by each of the plurality of oscillation imparting sections is the same among the oscillation imparting sections.

The transport speed of the products at the various positions of the transport section depends on the amplitude in the transport direction of the oscillations imparted by the various oscillation imparting sections. Consequently, if the amplitudes in the transport direction of the oscillations imparted by the oscillation imparting sections are the same among the oscillation imparting sections, then it is easy to make the transport speed uniform. As a result, transport irregularities that occur when the transport speed becomes non-uniform at the various positions of the transport section are suppressed.

Moreover, the second cam of each of the plurality of oscillation imparting sections may have such a cam profile that the amplitude in the vertical direction of the oscillations imparted by each of the plurality of oscillation imparting sections is the same among the oscillation imparting sections.

The transport speed depends on the amplitude in the vertical direction of the oscillations imparted by the various oscillation imparting sections. Consequently, if the amplitudes in the vertical direction of the oscillations imparted by the oscillation imparting sections are the same among the oscillation imparting sections, then the transport irregularities are suppressed. Furthermore, it becomes easy to match the phases in the vertical direction at the various positions of the transport section, so that the transport path formed by the transport section is not undulated, and the product can be transported properly.

Moreover, the transport section may include a plurality of transport platforms that are lined up in the transport direction; a gap may be formed between the neighboring transport platforms; and an oscillation imparting section may be provided for each of the plurality of transport platforms.

By synchronizing the oscillation imparting operations of the various oscillation imparting sections, it becomes possible to set the necessary width of the gaps to a short width. As a result, the transfer of the products among the transport platforms is carried out properly, and the effect of the present invention becomes even more significant.

Moreover, the plurality of transport platforms may be lined up in the transport direction such that they form an oval path.

In this case, it becomes possible to ensure a relatively long transport distance while keeping the set-up space for the transport section as small as possible. Therefore, it becomes possible to perform processing and inspections of the products while transporting the product.

Moreover, the transport section may be a rectangular transport platform whose longitudinal direction coincides with the transport direction; and the plurality of oscillation imparting sections may be lined up in a straight line in the longitudinal direction of the transport platform.

If the transport section is a rectangular transport platform, it is necessary to provide a plurality of oscillation sections for preventing deflection in its longitudinal direction. Consequently, the effect of the present invention becomes more significant. Moreover, when deviation in the oscillation imparting operation of the oscillation imparting sections occur, the transport platforms rattles and it become difficult to transport the products properly. Therefore, rattling of the transport platforms can also be suppressed by driving the plurality of oscillation imparting sections with a single driving source.

Moreover, the transport section may be a rectangular transport platform whose transverse direction coincides with the transport direction; and the plurality of oscillation imparting sections may be lined up in a straight line in the longitudinal direction of the transport platform.

Also in this case, due to the object of preventing deflection of the transport platforms, it is necessary to provide a plurality of oscillation sections, so that the effect of the present invention becomes even more significant. Moreover, as noted above, by driving the plurality of oscillation imparting sections with a single driving source, rattling of the transport platforms can be suppressed as well. Furthermore, since the transport section is a transport platform that is wide in the transport direction, it becomes possible to transport a large amount of products at the same time by oscillating the transport section in a state in which the oscillation imparting operations of the oscillation imparting sections are synchronized.

First, a product transport apparatus is provided that includes an oscillation plate that oscillates in a transport direction and a vertical direction in order to linearly transport a product;

at least one first oscillation imparting unit that imparts oscillations in the transport direction to the oscillation plate through a cam mechanism; and

at least three second oscillation imparting units that impart oscillations in the vertical direction to the oscillation plate through a cam mechanism.

With such a product transport apparatus, at least three second oscillation imparting units are provided that impart oscillations in the vertical direction, which tend to attenuate easily, so that the oscillations in the vertical direction are properly transmitted across a broad range. As a result, oscillation irregularities of the oscillation plate are prevented, and it becomes possible to linearly transport the product properly.

Moreover, the oscillation plate may include a rectangular placement surface for placing the product thereon; the longitudinal direction and the transverse direction of the placement surface may lie in a horizontal plane; and the transport direction may coincide with either the longitudinal direction or the transverse direction of the placement surface.

In this case, it is possible to realize a product transport apparatus with higher versatility.

Moreover, the at least three second oscillation imparting units may include a second oscillation imparting unit that imparts oscillations on the oscillation plate at a position that is different, with respect to the longitudinal direction of the placement surface, from another second oscillation imparting unit; and a second oscillation imparting unit that imparts oscillations on the oscillation plate at a position that is different, with respect to the transverse direction of the placement surface, from another second oscillation imparting unit.

In this case, the transmission range of the oscillations in the vertical direction that are imparted by the at least three second oscillation imparting units is broadened, and the effect of preventing oscillation irregularities of the oscillation plate is improved.

Moreover, each of the at least three second oscillation imparting units may impart oscillations at an end portion of the oscillation plate in at least one direction of the longitudinal direction and the transverse direction of the placement surface.

In this case, the transmission range of the oscillations in the vertical direction that are imparted by the at least three second oscillation imparting units is broadened, and the effect of preventing oscillation irregularities of the oscillation plate is improved.

Moreover, a single drive motor may be provided for driving the at least one first oscillation imparting unit and the at least three second oscillation imparting units.

In this case, the driving of the first oscillation imparting unit can be easily synchronized with the driving of the second oscillation imparting units. As a result, adverse influences on the product transport, such as rattling of the oscillation plate that occurs when there are shifts in the timing at which the oscillations are imparted, can be prevented.

Moreover, each of the at least one first oscillation imparting unit may include

a first output section that fastens and supports the oscillation plate by an upper surface of the first output section, a first output section being able to be oscillated in the transport direction, and

a first cam mechanism for oscillating the first output section and the oscillation plate integrally in the transport direction, and each of the at least three second oscillation imparting units includes

a second output section that fastens and supports the oscillation plate by an upper surface of the second output section, second output section being able to be oscillated in the vertical direction, and

a second cam mechanism for oscillating the second output section and the oscillation plate integrally in the vertical direction.

In this case, the oscillation plate is fastened to the first output section and the second output sections, so that the first cam mechanism and the second cam mechanism properly oscillate the oscillation plate through the first output section and the second output sections.

Moreover, a cam profile of a first cam provided in a first cam mechanism of each of the at least one first oscillation imparting unit may be the same among the first oscillation imparting units; and a cam profile of a second cam provided in a second cam mechanism of each of the at least three second oscillation imparting units may be the same among the second oscillation imparting units.

The product transport speed at each region of the placement surface depends on the amplitude of the oscillations of the oscillation plate at each of those regions. With the above-described configuration, the amplitude of the oscillations in the transport direction imparted by the first oscillation imparting unit is the same among the first oscillation imparting units, and the amplitude of the oscillations in the vertical direction imparted by the second oscillation imparting unit is the same among the second oscillation imparting units. As a result, the product transport speed at the various regions becomes uniform, and the products can be linearly transported more properly. Moreover, if the amplitude of the oscillations in each direction is the same, then rattling of the oscillation plate can be prevented.

Moreover, a number of oscillations in the transport direction imparted by each of the at least one first oscillation imparting unit may be the same among the first oscillation imparting units; a number of oscillations in the vertical direction imparted by each of the at least three second oscillation imparting units may be the same among the second oscillation imparting units; and the number of oscillations in the transport direction and the number of oscillations in the vertical direction may be the same.

The product transport speed at each region of the placement surface depends on the number of oscillations of the oscillation plate at each of those regions. With the above-described configuration, the uniformity of the product transport speed is improved, and it becomes possible to linearly transport the products even more properly.

Moreover, only one first oscillation imparting unit may be provided.

The oscillations in the transport direction imparted by the first oscillation imparting unit attenuate less easily than the oscillations in the vertical direction, so that there is a high possibility that one first oscillation imparting unit is sufficient. With the above-described configuration, a product transport apparatus can be realized that is advantageous with regard to cost.

First, a product transport apparatus is provided that includes

a transport platform for revolvingly transporting a product by oscillating in a revolving transport direction and a vertical direction;

a transport platform for linearly transporting the product by oscillating in a linear transport direction and a vertical direction;

a cam-type oscillation imparting mechanism that imparts oscillations on one of the two transport platforms; and

an oscillation transmitting member that transmits oscillations from one transport platform to another transport platform, the oscillation transmitting member straddling product transfer sections that are provided on each of the transport platforms for performing a product transfer from one transport platform to the other transport platform.

With this product transport apparatus, a cam-type oscillation imparting mechanism is not provided for each transport platform, and the oscillations are transmitted to all transport platforms through the oscillation transmitting member. Thus, it becomes possible to reduce the number of cam-type oscillation imparting mechanisms while properly oscillating the transport platforms, and as a result, the product transport apparatus can be made less expensive. It should be noted that throughout this specification, “vertical direction” means the direction that intersects the surface for placing the products with which the transport platforms are provided (hereinafter referred as also “placement surface”).

Moreover, the one transport platform may be a first transport platform for revolvingly transporting the product by oscillating in the revolving transport direction and the vertical direction; and the other transport platform may be a second transport platform for linearly transporting the product by oscillating in the linear transport direction and the vertical direction.

Moreover, the oscillation transmitting member may be a first oscillation transmitting member for transmitting the oscillations from the first transport platform to the second transport platform; and the product transport apparatus may further include a third transport platform for revolvingly transporting the product by oscillating in the revolving transport direction and the vertical direction; and a second oscillation transmitting member that straddles product transfer sections that are provided on each of the second transport platform and the third transport platform for performing a product transfer from the second transport platform to the third transport platform, the second oscillation transmitting member transmitting the oscillations from the second transport platform to the third transport platform. With this configuration, a longer transport path is formed, so that it becomes easy to carry out operations on the products while they are being transported. Moreover, due to the second oscillation transmitting member transmitting the oscillations to the third transport platform, it becomes possible to make the product transport apparatus having the third transport platform less expensive.

Moreover, the product transport apparatus may further include a fourth transport platform for linearly transporting the product by oscillating in the linear transport direction and the vertical direction; and a third oscillation transmitting member that straddles product transfer sections that are provided on each of the third transport platform and the fourth transport platform for performing a product transfer from the third transport platform to the fourth transport platform, the third oscillation transmitting member transmitting the oscillations from the third transport platform to the fourth transport platform; and the first transport platform, the second transport platform, the third transport platform and the fourth transport platform may form an oval transport path. With this configuration, a longer transport path is formed, and it becomes possible to form this transport path into a closed path, for example. As a result, it becomes possible to ensure a sufficient transport distance, while avoiding a broadening of the set-up space for the product transport apparatus, and it becomes easier to carry out operations on the products while they are being transported. Moreover, owing to the third oscillation transmitting member transmitting the oscillations to the fourth transport platform, it becomes possible to make the product transport apparatus having an oval transport path less expensive.

Moreover, the first oscillation transmitting member, the second oscillation transmitting member and the third oscillation transmitting member may be strip-shaped steel belts; and the steel belts may straddle the product transfer sections bridging gaps that are formed between the product transfer sections.

In this case, since the steel belts, which have considerable rigidity, straddle the product transfer sections, it is possible to properly link the product transfer sections. Thus, the oscillations are properly transmitted to the transport platforms.

Moreover, each of the first transport platform, the second transport platform, the third transport platform and the fourth transport platform may include a placement surface for placing the product; and a side wall that is provided at an end portion in a width direction of the placement surface, so as to intersect the placement surface; and both end portions in the longitudinal direction of the steel belts may be fastened to the side walls. In this case, the fastening of the steel belts become easier. Furthermore, during the transmission of the oscillations, the steel belts can convert oscillations in the revolving transport direction into oscillations in the linear transport direction, or oscillations in the linear transport direction into oscillations in the revolving transport direction. As a result, the transport platforms to which the oscillations are transmitted by the steel belts can properly oscillate in their transport direction.

Moreover, the cam-type oscillation imparting mechanism may be a first cam-type oscillation imparting mechanism that imparts oscillations in the revolving transport direction and the vertical direction on the first transport platform; and the product transport apparatus may further include a second cam-type oscillation imparting mechanism that imparts oscillations in the vertical direction on the third transport platform. With this configuration, the oscillations in the vertical direction, which tend to attenuate easily, are supplemented by the second cam-type oscillation imparting mechanism, so that the transport platforms oscillate properly and the product transport apparatus transports the products properly.

Moreover, a single drive motor may be provided for driving the first cam-type oscillation imparting mechanism and the second cam-type oscillation imparting mechanism. In this case, it becomes easy to drive the first cam-type oscillation imparting mechanism and the second cam-type oscillation imparting mechanism such that they are synchronized to each other. Thus, shifts in the timing at which the oscillations are imparted by the cam-type oscillation imparting mechanisms are suppressed and the oscillations are properly transmitted by the oscillation transmitting members, so that as a result, the products can be properly transported by the product transport apparatus.

Moreover, the number of oscillations imparted by the first cam-type oscillation imparting mechanism may be the same as the number of oscillations imparted by the second cam-type oscillation imparting mechanism. With this configuration, shifts in the oscillations among the transport platforms tend to occur less, and the product transport apparatus can transport the products even more properly.

Moreover, a cam profile with which the first cam-type oscillation imparting mechanism is provided for imparting the oscillations in the vertical direction may be the same as a cam profile with which the second cam-type oscillation imparting mechanism is provided for imparting the oscillations in the vertical direction. With this configuration, the amplitude of the oscillations of the transport platforms in the vertical direction becomes uniform, and the product transport apparatus can transport the products more properly.

### 1. First Embodiment

(1) Configuration Example of a Product Transport Apparatus

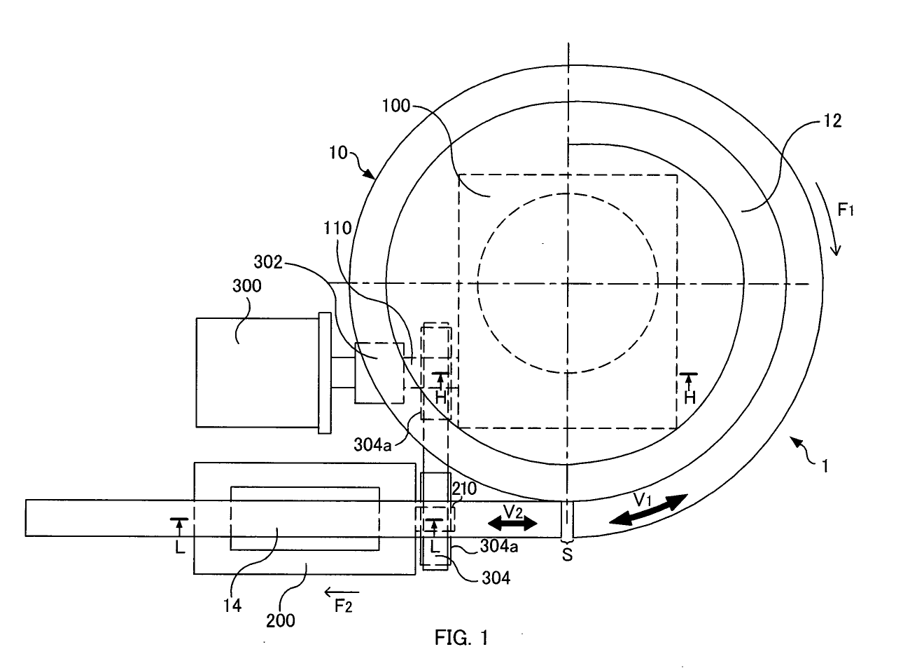

First, a configuration example of a product transport apparatus 1 according to the present embodiment is explained with reference to FIG. 1. FIG. 1 is a schematic top view of this product transport apparatus 1.

As shown in FIG. 1, the product transport apparatus 1 includes a transport section 10, a rotary feeder 100 and a linear feeder 200, which are examples of oscillation imparting sections, and a drive motor 300, which serves as a single driving source. That is to say, the product transport apparatus 1 is provided with a plurality (two in the present embodiment) of oscillation imparting sections. In this product transport apparatus 1, products W placed on the transport section 10 (more specifically, a transport surface that is positioned at the upper end of the transport section 10) are transported in a state in which they are lined up in a predetermined transport direction (the directions of the arrows marked F1 and F2 in FIG. 1), due to the oscillations of the transport section 10. That is to say, the transport section 10 forms a transport path for the products W, and the products W are transported along this transport path. For the transport of the products W, the present embodiment utilizes the phenomenon of relative slipping of the products W with respect to the transport path 10, which occurs when the transport path 10 oscillates in the transport direction and the vertical direction. It should be noted that “product W” is a general term for objects that are transported by the product transport apparatus 1, such as machine components or medical pills or the like. The following is an explanation of the various structural components of the product transport apparatus 1.

Transport Section 10

Referring to the above-mentioned FIG. 1, explanation of the transport section 10 will follow.

As shown in FIG. 1, the transport section 10 according to the present embodiment is configured of a bowl-shaped first transport platform 12 and a linear second transport platform 14. That is to say, the transport section 10 according to the present embodiment includes a plurality of transport platforms. Moreover, the first transport platform 12 and the second transport platform 14 are arranged one behind the other in the transport direction of the products W, and together the first transport platform 12 and the second transport platform 14 form a transport path of the products W.

More specifically, the first transport platform 12 forms a transport path for transporting the products W in the circumferential direction of the first transport platform 12, from the bottom of the first transport platform 12 upward. That is to say, the transport path of the first transport platform 12 is restricted to a spiral-shaped transport direction (“spiral-shaped transport path” hereafter). On the other hand, the transport path of the second transport platform 14 forms a path that is restricted to a linear transport direction (“linear transport path” hereafter). Furthermore, as shown in FIG. 1, the first transport platform 12 and the second transport platform 14 are arranged such that the second transport platform 14 is aligned with a tangential direction of the circumference of the first transport platform 12. Moreover, the end of the spiral-shaped transport path and the beginning of the linear transport path are aligned in the transport direction, and a product W that is transported to the end of the spiral-shaped transport path is transferred to the beginning of the linear transport path. It should be noted that the end portion of the spiral-shaped transport path and the linear transport path are aligned in the horizontal direction.

Moreover, a rotary feeder 100 is arranged below the first transport platform 12 and a linear feeder 200 is arranged below the second transport platform 14. The first transport platform 12 is oscillated in the transport direction and the vertical direction by oscillations that are imparted by the rotary feeder 100, whereas the second transport platform 14 is oscillated in the transport direction and the vertical direction by oscillations that are imparted by the linear feeder 200. In other words, the transport section 10 is oscillated in the transport direction and in the vertical direction through cooperation of the rotary feeder 100 and the linear feeder 200. Here, the transport direction of the first transport platform 12 is the circumferential direction of the first transport platform 12 (that is, the circumferential direction along the spiral-shaped transport path, direction V1 in FIG. 1). Further, “oscillation in the transport direction of the first transport platform 12” means a reciprocating movement in the circumferential direction in a plane intersecting with the vertical direction, that is, within the horizontal plane. On the other hand, the transport direction of the second transport platform 14 is the longitudinal direction of the second transport platform 14 (that is, the direction along the linear transport path, direction V2 in FIG. 1). Further, “oscillation in the transport direction of the second transport platform 14” means a reciprocating movement in the longitudinal direction within the horizontal plane.

In a transport section 10 with a configuration mentioned above, before startup of the product transport apparatus 1, the products W are retained at the bottom of the first transport platform 12. When the product transport apparatus 1 is started, the products W move on the first transport platform 12 in a state in which they are lined up along the spiral-shaped transport path, due to the oscillations of the first transport platform 12 in the transport direction and the vertical direction. Then, the products W are transferred from the spirals-shaped transport path to the linear transport path (that is, the products W transferred from the first transport platform 12 to the second transport platform 14) and are moved on the second transport platform 14 in a state in which they are lined up along the linear transport path, brought about by the oscillations of the second transport platform 14 in the transport direction and the vertical direction.

In this respect, the product transport apparatus 1 of the present embodiment can be said to be a combination of a product transport apparatus comprising a transport section forming a spiral-shaped transport path and a product transport apparatus comprising a transport section forming a linear transport path.

As shown in FIG. 1, a gap S is formed between the front end of the first transport platform 12 in the transport direction (that is, the end of the spiral-shaped transport path) and the rear end of the second transport platform 14 in the transport direction (that is, the beginning of the linear transport path). This gap S is provided in order to prevent the first transport platform 12 from colliding with the second transport platform 14 during oscillation. Moreover, the products W that are transported up to the front end of the first transport platform 12 in the transport direction are passed over this gap S and are transferred to the second transport platform 14. It should be noted that in the present embodiment, the width of the gap S in the transport direction is set in consideration of such as the thermal expansion and the influence of inertia of the first transport platform 12 and the second transport platform 14.

The Rotary Feeder 100

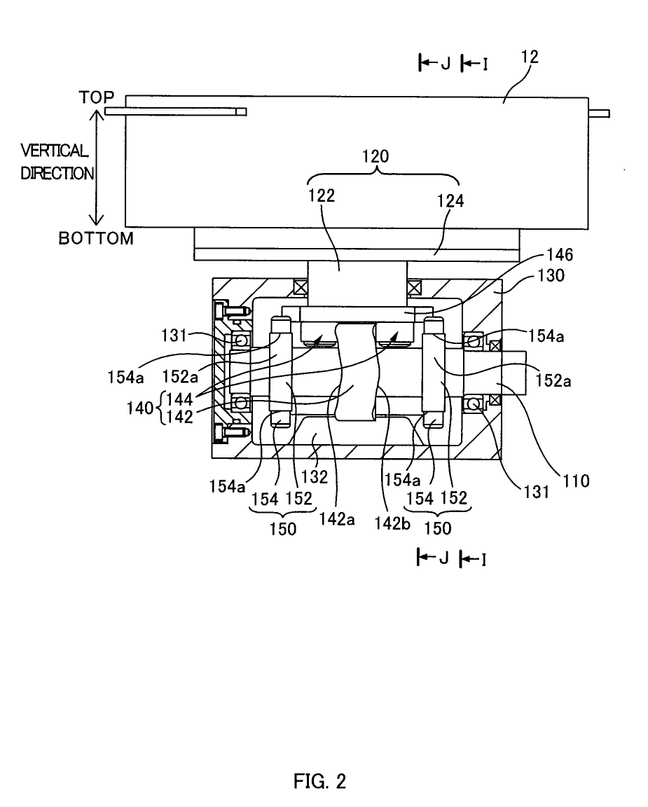

Referring to FIGS. 2 to 11, explanation of a configuration example and an operation example of the rotary feeder 100 will follow.

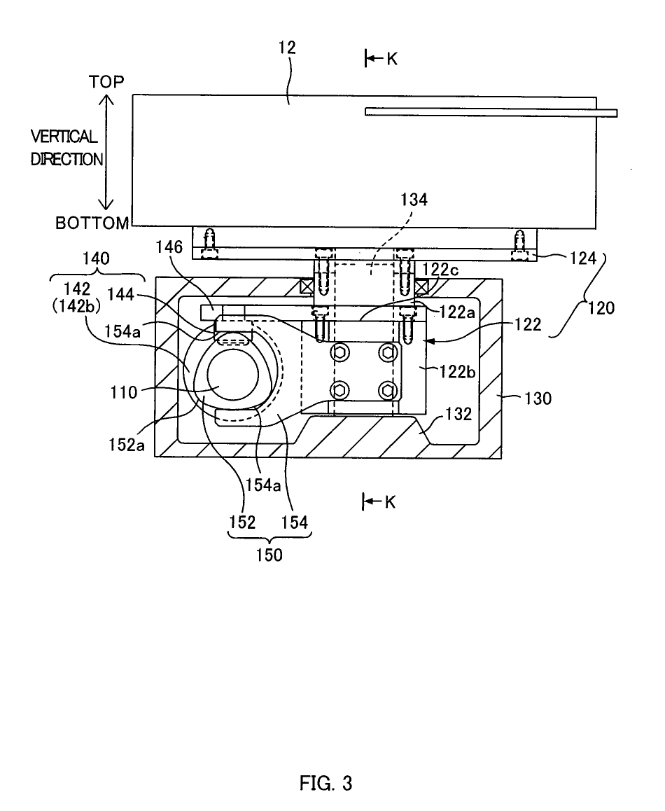

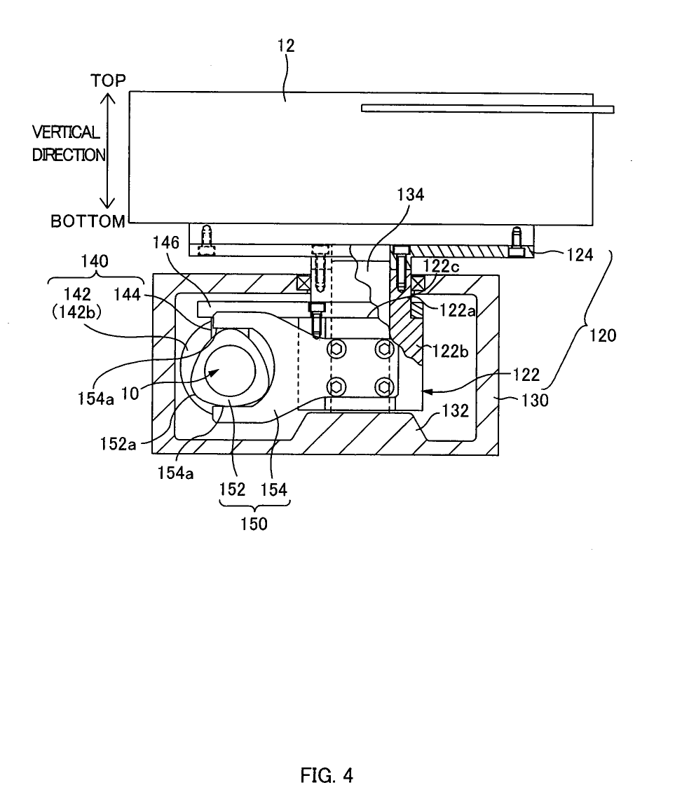

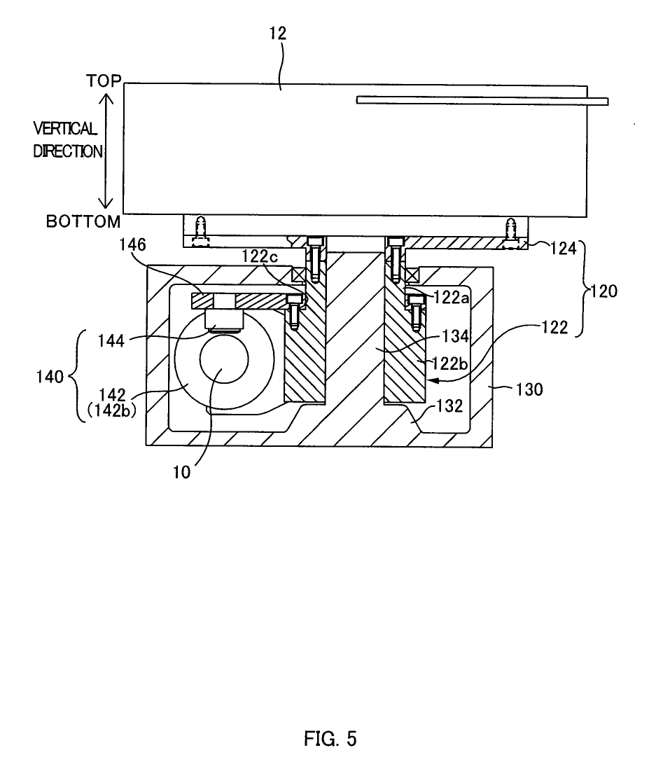

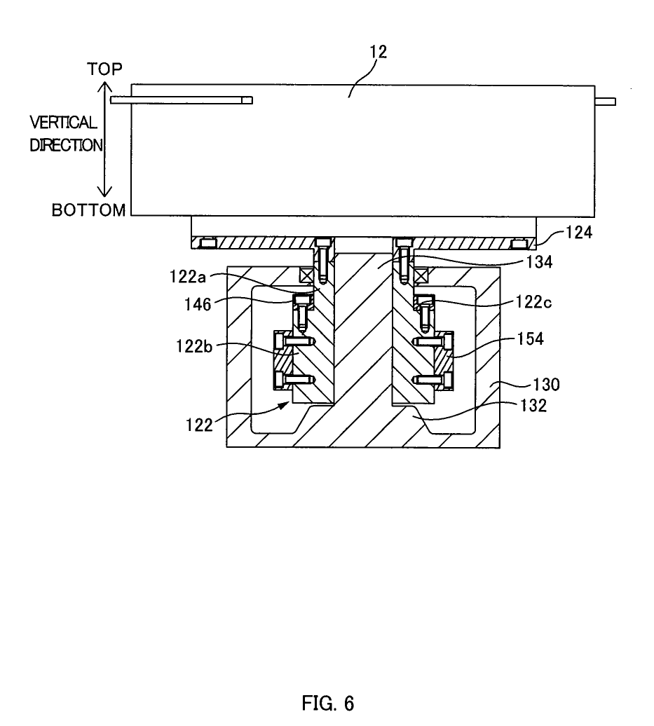

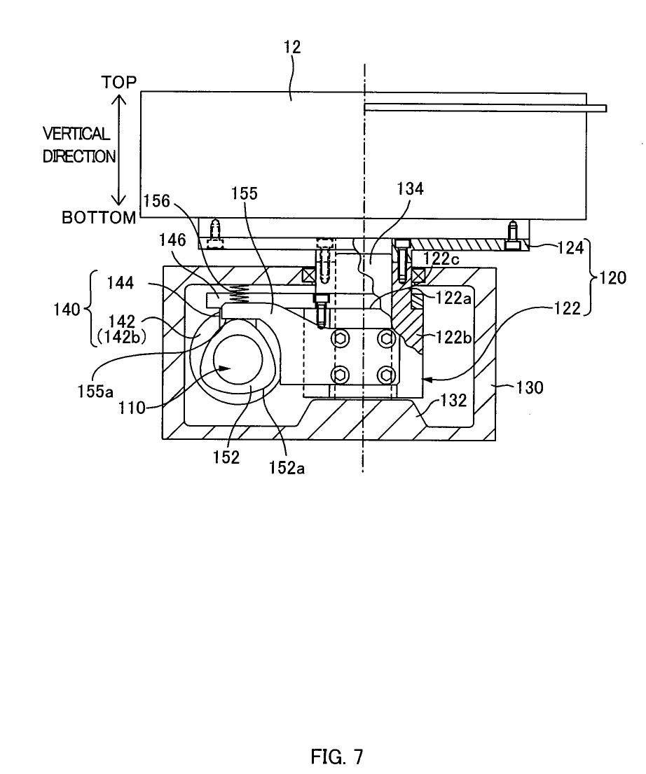

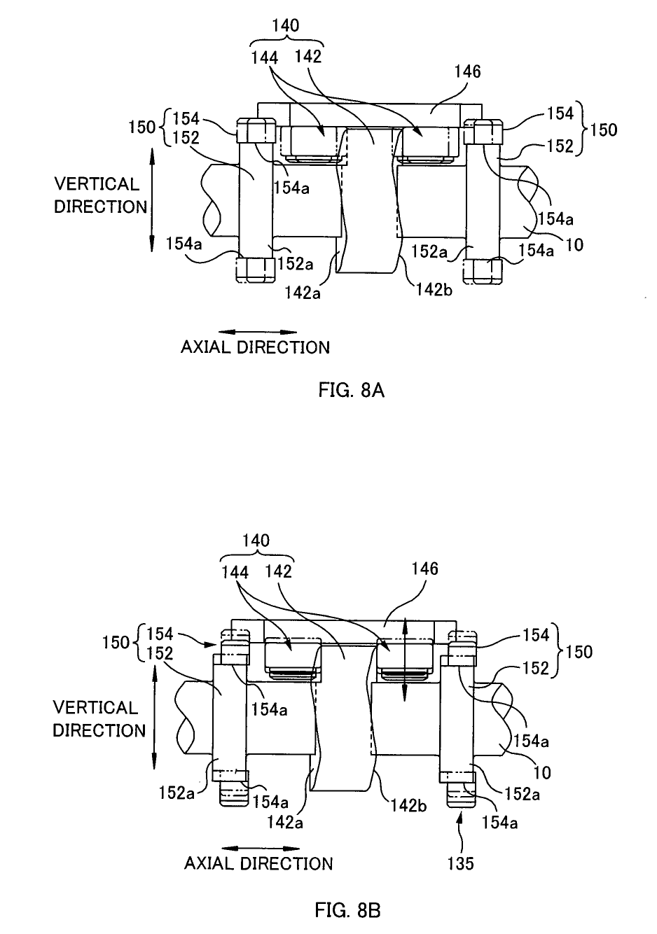

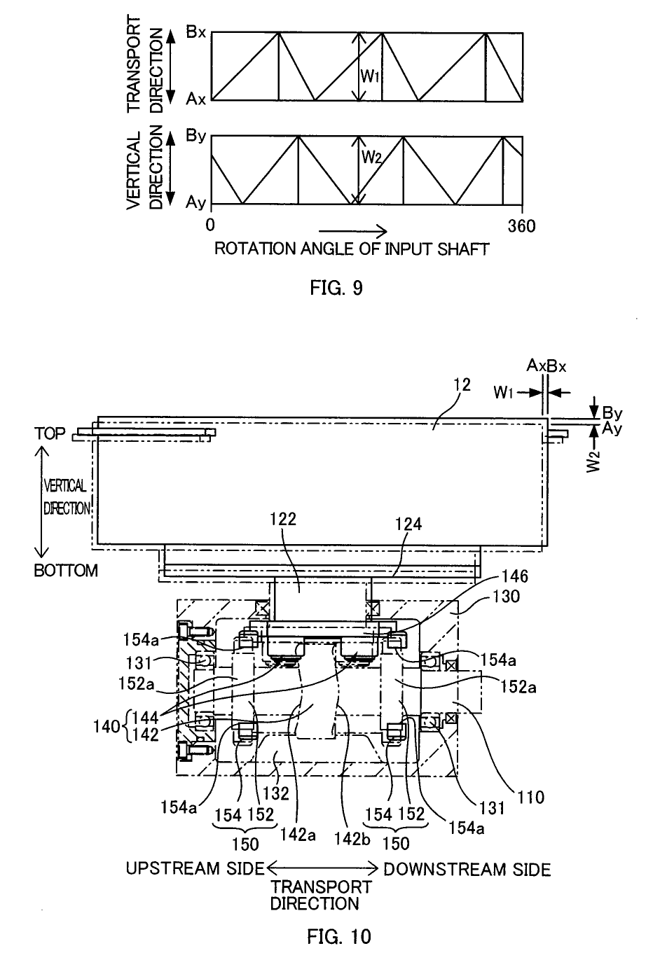

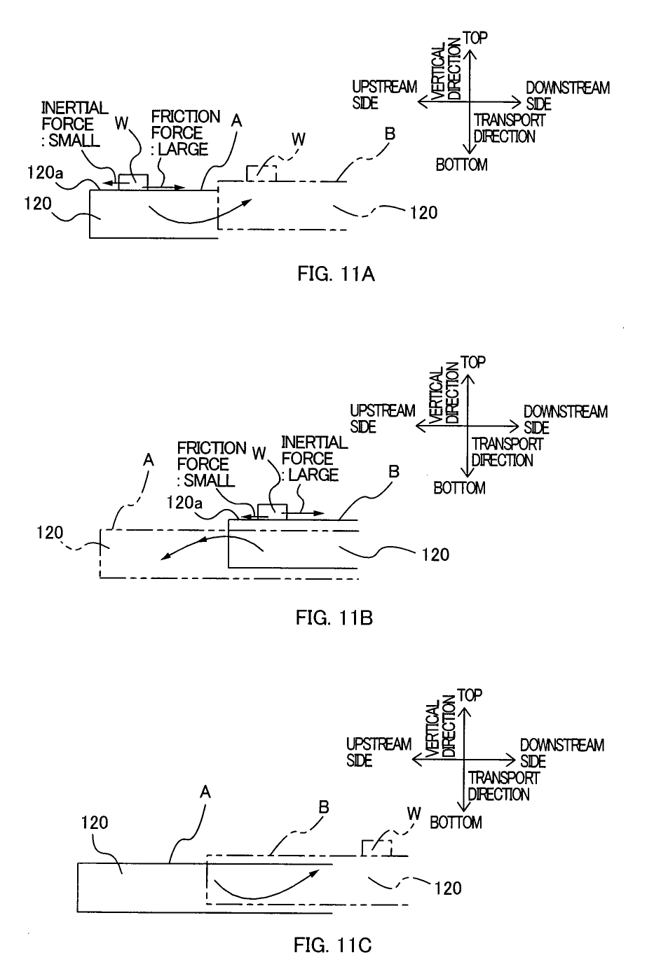

FIGS. 2 to 6 are diagrams showing the internal structure of the rotary feeder 100. FIG. 2 is a sectional view along H-H in FIG. 1, FIG. 3 is a sectional view along I-I in FIG. 2, FIG. 4 is a diagram showing the periphery of the turret 122, FIG. 5 is a sectional view along J-J in FIG. 2, and FIG. 6 is a sectional view along K-K in FIG. 3. Note that, in FIGS. 2 to 6, cut surfaces are hatched, and FIG. 4 shows a partially different sectional plane for illustrative reasons. FIG. 7 is a diagram illustrating a modified example of a lift arm 154 and is a view corresponding to FIG. 4. FIG. 8 is a diagram illustrating the operation of the first cam mechanism 140 and the second cam mechanism 150. FIG. 8A shows the state of the first cam mechanism 140 and the second cam mechanism 150 before the input shaft 110 rotates, whereas FIG. 8B shows the state wherein the input shaft 110 rotates to drive the first cam mechanism 140 and the second cam mechanism 150. FIG. 9 is an example of a timing chart of the oscillations imparted by the rotary feeder 100 and is a diagram showing the displacement of the first transport platform 12 in the transport direction during one rotation of the input shaft 110 (upper diagram) as well as the displacement of the first transport platform 12 in the vertical direction during one rotation of the input shaft 110 (lower diagram). FIG. 10 is a diagram illustrating the trajectory of the first transport platform 12 when the first transport platform 12 oscillates in the transport direction and in the vertical direction. FIG. 11 is a diagram illustrating the phenomenon of relative slipping of the product W. It should be noted that in FIGS. 2 to 7 and 10, arrows indicate the vertical direction of the rotary feeder 100. In FIG. 8, arrows indicate the axial direction and the vertical direction of the input shaft 110. In FIG. 11, arrows indicate the transport direction and the vertical direction of the first transport platform 12.

As shown in FIGS. 2 and 3, the rotary feeder 100 includes an input shaft 110, an output section 120, a housing 130, a first cam mechanism 140, and a second cam mechanism 150.

The housing 130 is a substantially box-shaped casing containing the first cam mechanism 140 and the second cam mechanism 150, which are explained later. The housing 130 is arranged below the first transport platform 12. Moreover, a frustum-shaped pedestal section 132 is arranged at the bottom inside the housing 130, as shown in FIG. 3 for example. The housing 130 further includes a columnar support shaft 134 that stands erect on the center portion of the pedestal section 132. As shown in FIG. 6 for example, the upper end of the support shaft 134 protrudes out of the housing 130 through the ceiling wall of the housing 130.

The input shaft 110 is supported rotatably by the housing 130 through a pair of bearings 131. As shown in FIG. 5, the input shaft 110 is arranged close to the turret 122, which is explained later. Moreover, one axial end of the input shaft 110 protrudes out of the housing 130, as shown in FIG. 2 for example. This protruding portion is coupled to the drive motor 300 through a shaft coupling 302, which is explained later. When the drive motor 300 rotates, the input shaft 110 rotates around its center axis.

The output section 120 is supported by the support shaft 134 provided to the housing 130, rotatably around the center axis of the support shaft 134, and reciprocably in the axial direction (that is, the perpendicular direction) of the support shaft 134. Moreover, as shown for example in FIG. 6, this output section includes a hollow cylindrical turret 122, which is supported by the support shaft 134 by fitting the support shaft 134 inside it, and a disk-shaped first transport platform attachment plate 124 fastened to the upper end portion of the turret 122.

The turret 122 is rotatable around the center axis of the support shaft 134 relative to the support shaft 134 and can be reciprocated back and forth in the axial direction of the support shaft 134. As shown in FIG. 6, for example, the turret 122 includes a small diameter section 122a and a large diameter section 122b, which have different outer diameters. The small diameter section 122a is adjacent to the upper end of the large diameter section 122b in the axial direction of the turret 122 (that is, in the axial direction of the support shaft 134). Moreover, the upper end of the small diameter section 122a of the turret 122 protrudes out of the housing 130 through the ceiling wall of the housing 130. It should be noted that a step 122c with a ring-shaped surface, which is perpendicular to the axis of the turret 122, is formed at the border between the small diameter section 122a and the large diameter section 122b of the turret 122, and a swing arm 146, which is a structural component of the later-described first cam mechanism 140, is fastened to this step 122c. Moreover, a lift arm 154, which is a structural component of the later-described second cam mechanism 35, is fastened to the circumferential surface of the large diameter section 122b of the turret 122.

The first transport platform attachment plate 124 supports the first transport platform 12, which is fastened to and supported on the first transport platform attachment plate 124. That is to say, as shown in FIG. 3 for example, the first transport platform 12 is bolted to the first transport platform attachment plate 124 with the bottom wall of the first transport platform 12 abutting against the ceiling wall of the first transport platform attachment plate 124. Moreover, the first transport platform attachment plate 124 is bolted to the upper surface of the small diameter section 122a of the turret 122. Thus, the turret 122, the first transport platform attachment plate 124 and the first transport platform 12 swivel integrally around the support shaft 134, or reciprocate back and forth in the axial direction of the support shaft 134. Here, the swiveling direction when the turret 122, the first transport platform attachment plate 124, and the first transport platform 12 swivel integrally coincides with the circumferential direction of the first transport platform 12, that is, the transport direction of the first transport platform 12. Moreover, the axial direction of the support shaft 134 coincides with the vertical direction. Consequently, the output section 120 is supported by the housing 130 (or more precisely, by the support shaft 134 of the housing 130), through the support shaft 134, in such a manner than it can oscillate integrally with the first transport platform 12 in the transport direction and the vertical direction of the first transport platform 12.

The first cam mechanism 140 lets the first transport platform 12 and the output section 120 oscillate in the transport direction of the products W on the first transport platform 12. As shown in FIGS. 2 and 5, the first cam mechanism 140 includes a first cam 142 that rotates as the input shaft 110 rotates, a pair of first cam followers 144 that engage the first cam 142, and a swing arm 146 that swings owing to the cooperation of the first cam 142 and the pair of first cam followers 144.

The first cam 142 is a cylindrical rib cam, and is supported at the center in the axial direction of the input shaft 110. When the input shaft 110 rotates, the first cam 142 rotates integrally with the input shaft 110. Moreover, rib-shaped cam faces 142a and 142b are formed to extend along the entire circumference of the end faces in the axial direction of the first cam 142. The cam faces 142a and 142b are curved with respect to the axial direction of the input shaft 110, the cam face 142a that is formed at one end face in the axial direction has the same curved shape as the cam face 142b that is formed at the other end face in the axial direction. The shape of these cam faces 142a and 142b represents the cam profile of the first cam 142.

The pair of first cam followers 144 abuts against the cam faces 142a and 142b, sandwiching the first cam 142 between them. The swing arm 146, which is a substantially rectangular shaped member, serves as a follower of the first cam 142, and is provided with the pair of first cam followers 144 at its one end in the longitudinal direction. Moreover, one end in the longitudinal direction faces the first cam 142 in the vertical direction with a predetermined gap therebetween, and at this end in the longitudinal direction, the pair of first cam followers 144 is supported such that they can rotate around an axis extending in the vertical direction. It should be noted that the gap between the first cam followers 144 is adjusted such that each of the circumferential surfaces of the pair of first cam followers 144 is in constant contact with the cam faces 142a and 142b of the first cam 142 in a rollable manner. Moreover, the other end in the longitudinal direction of the swing arm 146 includes a fitting hole for fitting the small diameter section 122a of the turret 122 at the center of the other end in the longitudinal direction. The other longitudinal end of the swing arm 146 is bolted to the step 122c of the turret 122 with the small diameter section 122a being fitted into this fitting hole.

With the first cam mechanism 140 configured in this manner, when the input shaft 110 rotates, the first cam 142 rotates integrally with the input shaft 110, and the pair of first cam followers 144 roll while maintaining a state in which they contact the cam faces 142a and 142b, as shown in FIGS. 8A and 8B. In this situation, the swing arm 146 swings in a direction parallel to the axial direction of the input shaft 110, in response to the shape of the curved surfaces of the cam faces 142a and 142b. Moreover, when the swinging of the swing arm 146 is transmitted to the turret 122 to which the swing arm 146 is fastened, the turret 122 swivels around the support shaft 134 integrally with the swing arm 146 (that is to say, the reciprocal movement in the axial direction of the swing arm 146 is converted into a swiveling movement of the turret 122). Then, by swiveling the turret 122 around the support shaft 134 integrally with the first transport platform attachment plate 124, the first transport platform 12 fastened to the first transport platform attachment plate 124 swivels around the support shaft 134 as well. Here, the swiveling direction of the first transport platform 12 coincides with the circumferential direction of the first transport platform 12, that is, the transport direction of the product W on the first transport platform 12. Consequently, the first cam mechanism 140 causes the output section 120 and the first transport platform 12 to oscillate (reciprocate) integrally in the transport direction (in other words, the first cam mechanism 140 generates an oscillation in the transport direction). It should be noted that the swiveling range of the swiveling movement of the turret 122 is sufficiently small, so that this swiveling movement (in other words, the oscillation of the first transport platform 12 in the transport direction) can be regarded as a linear reciprocal movement in the axial direction of the input shaft 110. Therefore, the oscillation in the transport direction with the first cam mechanism 140 provided to the rotary feeder 100 is explained hereafter as an oscillation in the axial direction of the input shaft 110. However, the direction of the oscillation due to the first cam mechanism 140 is not limited to this transport direction. For example, the direction of this oscillation may also have a component other than the transport direction (for example, a component in the vertical direction or a component in a direction that intersects the transport direction and the vertical direction).

The second cam mechanism 150 causes the first transport platform 12 and the output section 120 to oscillate in the vertical direction. As shown in FIG. 4 for example, this second cam mechanism 150 includes a pair of second cams 152 that rotate as the input shaft 110 rotates, and a pair of lift arms 154 that engage the second cams 152.

The pair of second cams 152 are substantially triangular plate cams having a cam face 152a formed on their outer circumferential surface, and the pair of second cams 152 are supported at positions further to the outer side than the position at which the first cam 142 is supported on the input shaft 110. When the input shaft 110 rotates, the pair of second cams 152 rotate integrally with the input shaft 110. Moreover, the cam faces 152a have circumferential surfaces that are flat with respect to the axial direction of the input shaft 110, and the shape of these cam faces 152a represents the cam profile of the second cams 152.

As shown in FIGS. 3 and 4, one longitudinal end of each of the pair of lift arms 154 is a plate member that has the shape of a sideways facing “U”. The inner surfaces of the portion having the shape of a sideways facing “U” of the lift arms 154 are made to be in constant contact with the cam faces 152a of the second cams 152 so as to engage each of the second cams 152. That is to say, each of the lift arms 154 are provided with second cam followers 154a at the inner surface of the portion having the shape of a sideways facing “U” at the one longitudinal end. The other longitudinal end of the pair of lift arms 154 is bolted to the outer circumferential surface of the large diameter section 122b of the turret 122, such that the two lift arms 154 are parallel to each other. It should be noted that the second cam followers 154a (that is, the upper and the lower face of the inner faces of the portion having the shape of a sideways facing “U”) are surfaces that are flat with respect to the axial direction of the input shaft 110, so that they can be in constant contact with the cam faces 152a of the second cam 152.

As shown in FIGS. 8A and 8B, with the second cam mechanism 150 configured in an above manner, when the input shaft 110 rotates, the pair of second cams 152 rotate integrally with the input shaft 110. Moreover, the pair of lift arms 154 are moved up and down in the vertical direction in response to the shape of the cam faces of the second cams 152, while the second cam followers 154a are maintained in a state of contact with the cam faces 152a provided to each of the second cams 152 that are in a rotating state. Moreover, when this vertical movement of the pair of lift arms 154 is transmitted to the turret 122 to which the lift arms 154 are fixed, the turret 122 moves up and down in the axial direction (that is, the vertical direction) of the support shaft 134, integrally with the pair of lift arms 154. And by reciprocating the turret 122 in the vertical direction integrally with the first transport platform attachment plate 124, the first transport platform 12 fastened to the first transport platform attachment plate 124 moves up and down in the vertical direction as well. Consequently, the second cam mechanism 150 oscillates (moves up and down) in the vertical direction, integral with the output section 120 and the first transport platform 12. That is to say, the second cam mechanism 150 generates an oscillation in the vertical direction, but the direction of the oscillation brought about by the second cam mechanism 150 is not limited to the vertical direction. For example, the direction of this oscillation may also have a component other than the vertical direction (for example, a component in the axial direction of the input shaft 110).

Now, when the turret 122 swivels around the center axis of the support shaft 134 owing to the driving of the first cam mechanism 140, the pair of lift arms 154 advance straight forward relative to the second cams 152 in the axial direction of the input shaft 110, while a state of contact is maintained between the second cam followers 154a and the cam faces 152a of the second cams 152 (see FIG. 8B) . This is because the cam faces 152a of the second cams 152 and the second cam followers 154a both have a flat surface with respect to the axial direction of the input shaft 110. Therefore, the swiveling movement of the output section 120 brought about by the first cam mechanism 140 (that is, the oscillation in the transport direction of the output section 120) does not impede the vertical movement of the output section 120 brought about by the second cam mechanism 150.

On the other hand, when the turret 122 moves vertically in the axial direction of the support shaft 134 (the vertical direction) owing to the driving of the second cam mechanism 150, the swing arm 146 moves in the vertical direction relative to the first cam 142, while a state of contact is maintained between the circumferential faces of the pair of first cam followers 144 and the cam faces 142a and 142b of the first cam 142 (see FIG. 8B). Therefore, the vertical movement of the output section 120 brought about by the second cam mechanism 150 does not impede the swiveling movement of the output section 120 brought about by the first cam mechanism 140.

Consequently, in the present embodiment, the output section 120 and the first transport platform 12 can oscillate simultaneously in two directions, namely the transport direction and the vertical direction. In other words, the output section 120 and the first transport platform 12 oscillate in a compound direction of the transport direction and the vertical direction (hereafter referred to as simply “compound direction”).

Moreover, in the present embodiment, one end portion in the longitudinal direction of the lift arm 154 is provided with the shape of a sideways facing “U”, but there is no limitation to this. For example, as shown in FIG. 7, it is also possible to use a lift arm whose one end portion in the longitudinal direction is substantially L-shaped (hereafter referred to as “other lift arm 155”). If this different lift arm 155 is used, a biasing member 156, such as a spring, is inserted between the upper end of the other end portion in the longitudinal direction of the different lift arm 155 and the ceiling wall of the housing 130. With the biasing force created by this biasing member 156, the second cam follower 155a (that is, the face of the other lift arm 155 that opposes the second cam 152) formed at the one end portion in the longitudinal direction of the different lift arm 155 is constantly pressed against the cam face 152a of the second cam 152. As a result, like the lift arm 154, the different lift arm 155 performs an up-down movement in the vertical direction.

The following is an explanation of an operation example of the rotary feeder 100 configured as described above.

When the input shaft 110 rotates along with the startup of the drive motor 300, the first cam 142 and the pair of second cams 152 rotate integrally with the input shaft 110, so that the first cam mechanism 140 and the second cam mechanism 150 are driven. Then, owing to the cooperation between the first cam mechanism 140 and the second cam mechanism 150, the first transport platform 12 oscillates in the compound direction, integrally with the output section 120. More specifically, by oscillating in the compound direction integrally with the output section 120, the first transport platform 12 reciprocates back and forth between point A (the position of the first transport platform 12 shown in a broken line in FIG. 10) and point B (the position of the first transport platform 12 shown in a solid line in FIG. 10). It should be noted that point B is at a further downstream side with respect to the transport direction than point A.

Moreover, as shown in FIG. 10, the width of the oscillation in the transport direction which is imparted by the first cam mechanism 140 is marked as W1, and the width of the oscillation in the transport direction which is imparted by the second cam mechanism 150 is marked as W2. Here, since the driving of the first cam mechanism 140 is synchronized with the driving of the second cam mechanism 150, when the first transport platform 12 moves a distance of W1 to the downstream side in the transport direction from point A, it reaches a position at which it is removed by a distance of W2 upward in the vertical direction from point A. In other words, the position Ax of point A in the transport direction and the position Bx of point B in the transport direction are separated from each other by a distance of W1, whereas the position Ay of point A in the vertical direction and the position By of point B in the vertical direction are separated from each other by a distance of W2.

Further, as shown in FIG. 9, in the present embodiment, the rotary feeder 100 oscillates a plurality of times (three times in the present embodiment) in both the transport direction and the vertical direction while the input shaft 110 rotates once, and the cycle of the oscillations in the transport direction is the same as the cycle of the oscillations in the vertical direction. Here, “cycle of oscillations” means the rotation angle of the input shaft 110 when having completed a single reciprocation in the transport direction or the vertical direction. Consequently, the cycle of the oscillations in the compound direction is also the same as the cycle of the oscillations in the transport direction and the cycle of the oscillations in the vertical direction. In other words, while the input shaft 110 rotates once, the number of oscillations in the compound direction that is imparted by the rotary feeder 100 (that is, the number of reciprocations between point A and point B) is three.

Since the first transport platform 12 reciprocates between point A and point B, the phenomenon of relative slipping of the products W placed on the first transport platform 12 occurs in the transport direction. The mechanism by which this phenomenon of relative slipping is generated is already known, and this is caused by the fact that there is a difference between the force of inertia and the friction force acting on products W when the first transport platform 12 moves from point A to point B and when the first transport platform 12 moves from point B to point A.

More specifically, in the present embodiment, the time that is required for the first transport platform 12 to move from point A to point B is longer than the time that is required for the first transport platform 12 to move from point B to point A, as shown in FIG. 9. That is to say, whereas the acceleration when moving forwards in the transport direction is small, the acceleration when moving backwards in the transport direction is large. Thus, as shown in FIG. 11A, when the first transport platform 12 moves from point A to point B, the inertial force acting on a product W such that it is moved to the upstream side in the transport direction becomes small, and relative slipping between the product W and the first transport platform 12 is suppressed. Conversely, as shown in FIG. 11B, when the first transport platform 12 moves from point B to point A, the inertial force acting on the product W such that it is moved to the downstream side in the transport direction becomes large. As a result, relative slipping of the product W is induced, as shown in FIG. 11C.

Moreover, when moving from point A to point B, the rising acceleration in the vertical direction of the first transport platform 12 is increased. In this case, as shown in FIG. 11A, the friction force acting on the product W increases, so that relative slipping is suppressed even more. On the other hand, when moving from point B to point A, the falling acceleration in the vertical direction of the first transport platform 12 increases. In this case, as shown in FIG. 11B, the friction force acting on the product W is reduced, so that the relative slipping of the product W is enhanced.

Owing to this phenomenon of relative slipping, the product W moves toward the downstream side in the transport direction on the first transport platform 12. It should be noted that for the oscillation imparted by the rotary feeder 100, the width W1 and W2 of the oscillations in the transport direction and the vertical direction, as well as the number of oscillations during a single rotation of the input shaft 110 is determined by the shapes (that is, the cam profiles) of the cam faces 142a and 142b of the first cam 142 and the cam faces 152a of the second cams 152. That is to say, each of the cam profiles of the first cam 142 and the second cam 152 are adjusted such that the product W slips relatively to the first transport platform 12 towards the downstream side in the transport direction.

Regarding the Linear Feeder 200

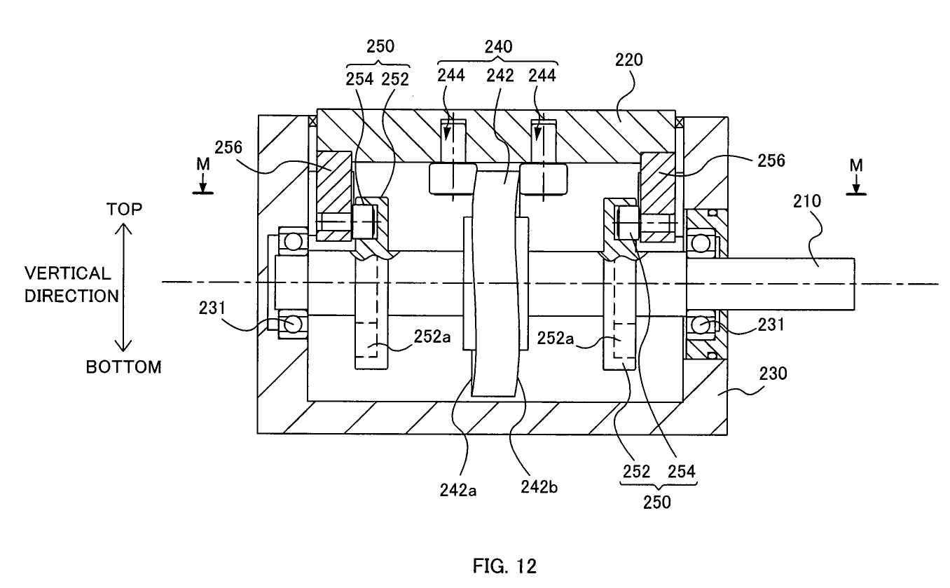

Referring to FIGS. 12 to 16, an explanation of a configuration example and an operation example of the linear feeder 200 is to follow.

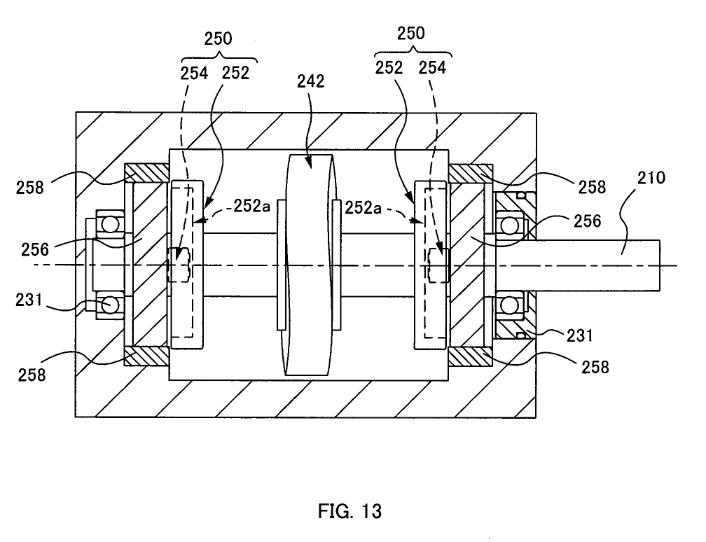

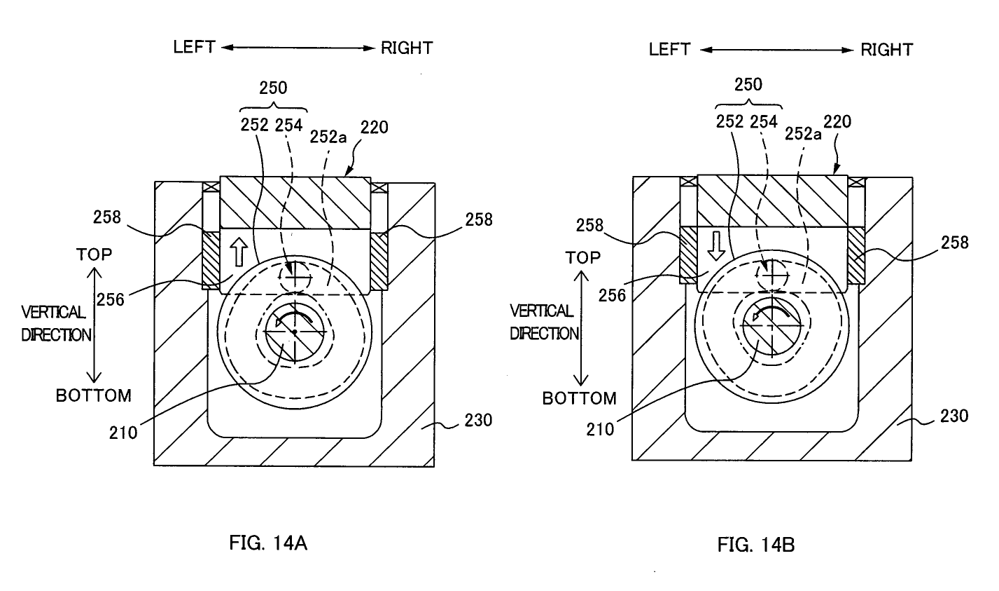

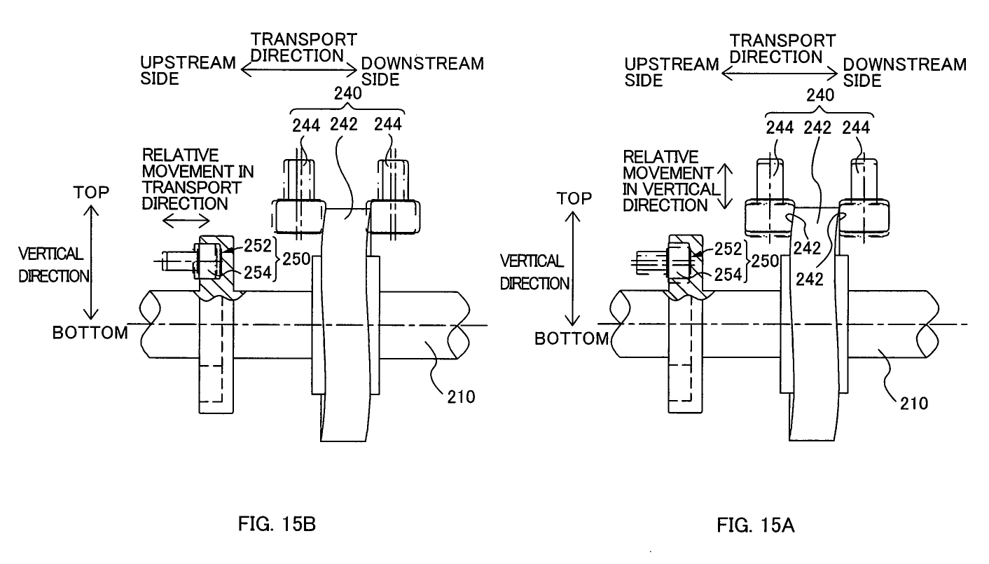

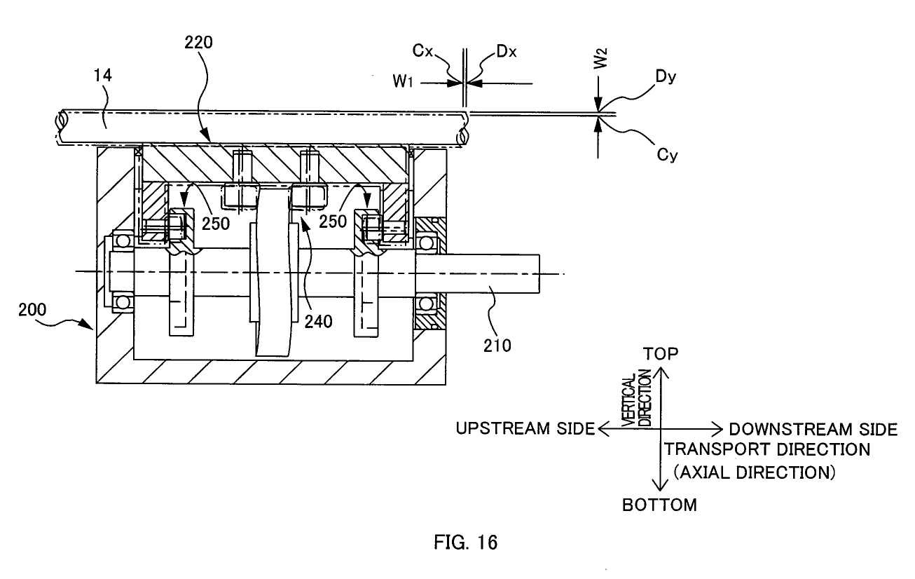

FIGS. 12 and 13 are diagrams showing the internal structure of the linear feeder 200. FIG. 12 shows a cross-sectional view along L-L in FIG. 1 and FIG. 13 shows a cross-sectional view along M-M in FIG. 12. It should be noted that in FIGS. 12 and 13, cut surfaces are hatched, and FIG. 12 shows a partially different sectional plane than that through L-L for illustrative reasons. FIG. 14 is a diagram illustrating the reciprocal movement in the vertical direction of the lifting platform 256. FIG. 14A is a diagram showing the state when the lifting platform 256 has reached the upper dead center and FIG. 14B is a diagram showing the state when the lifting platform 256 has reached the lower dead center. FIG. 15 is a diagram illustrating the relation between the operation of the first cam mechanism 240 and the operation of the second cam mechanism 250. In FIG. 15, FIG. 15A is a diagram illustrating that the first cam mechanism 240 does not impede the oscillation in the vertical direction of the output section 220, and FIG. 15B is a diagram illustrating that the second cam mechanism 250 does not impede the oscillation in the transport direction of the output section 220. FIG. 16 is a diagram illustrating the trajectory of the second transport platform 14 when the second transport platform 14 oscillates in the transport direction and in the vertical direction. It should be noted that in FIGS. 12 and 15, arrows indicate the vertical direction of the linear feeder 200. In FIG. 14, arrows indicate the vertical direction as well as a direction that is perpendicular to the axial direction and the vertical direction of the input shaft 210 (hereafter referred to as “horizontal direction” for the sake of convenience). In FIG. 16, arrows indicate the vertical direction as well as the transport direction of the linear feeder 200. Structural components of the linear feeder 200 that have the same configuration as structural components of the above-described rotary feeder 100 are omittede.

As shown in FIGS. 12 and 13, the linear feeder 200 includes an input shaft 210, an output section 220, a housing 230, a first cam mechanism 240 and a second cam mechanism 250, just like the rotary feeder 100.

The housing 230 is arranged below the second transport platform 14, and like the housing 130 of the rotary feeder 100, it is a substantially box-shaped casing containing the first cam mechanism 240 and the second cam mechanism 250 therein, which are explained hereafter. Moreover, a substantially rectangular opening is provided in the ceiling wall of the housing 230.

The input shaft 210 has a similar configuration to the input shaft 110 of the rotary feeder 100.

The output section 220 is arranged at a position that blocks the opening provided in the ceiling wall of the housing 230, and is a rectangular plate member that is smaller than the opening. This output section 220 is supported reciprocably in the axial direction of the input shaft 210 and in the vertical direction at the upper end portion of the housing 130. Moreover, the output section 220 firmly supports the second transport platform 14, with the ceiling wall of the output section 220 abutting against the lower wall of the second transport platform 14. That is to say, in the linear feeder 200, the output section 220 fulfills the same function as the first transport platform attachment plate 124 of the rotary feeder 100.

The first cam mechanism 240 oscillates the second transport platform 14 and the output section 220 in the transport direction. As shown in FIGS. 12 and 13, the first cam mechanism 240 includes a first cam 242 that rotates as the input shaft 210 rotates, and a pair of first cam followers 244 that mutually engage the first cam 242.

The first cam 242 has a similar configuration as the first cam 142 of the rotary feeder 100, is supported at the axial center portion of the input shaft 210, and can rotate integrally with the input shaft 210.

Also the pair of first cam followers 244 has a similar configuration as the first cam followers 144 of the rotary feeder 100 and are supported directly at the bottom of the output section 220.

With such a first cam mechanism 240, when the input shaft 210 rotates, the first cam 242 rotates integrally with the input shaft 210, and the pair of first cam followers 244 roll while staying in contact with the cam faces 242a and 242b. In this situation, the output section 220 reciprocates back and forth integrally with the second transport platform 14 in the axial direction of the input shaft 210, in response to the shape of the curved surfaces of the cam faces 242a and 242b. Here, the second transport platform 14 is fastened to the output section 220 in such a manner that the transport direction of the product W on the second transport platform 14 is parallel to the axial direction of the input shaft 210. Therefore, the first cam mechanism 240 lets the output section 220 and the second transport platform 14 oscillate (reciprocate) integrally in the transport direction (in other words, the first cam mechanism 240 causes an oscillation in the transport direction). It should be noted that in the following explanations, the oscillation in the transport direction brought about by the first cam mechanism 240 of the linear feeder 200 is explained as an oscillation in the axial direction of the input shaft 210. However, the direction of the oscillations brought about by the first cam mechanism 240 is not limited to the transport direction. For example, the direction of the oscillations may also have a component other than the transport direction (for example, a component in the vertical direction or the like).

The second cam mechanism 250 is for letting the second transport platform 14 and the output section 220 oscillate in the vertical direction. As shown in FIGS. 12 and 13, the second cam mechanism 250 includes a pair of second cams 252 that rotate as the input shaft 210 rotates, second cam followers 254 that engage with each of the second cams 252, a pair of lifting platforms 256 provided with the second cam followers 254 and moving up and down in the vertical direction, and guide members 258 guiding the lifting platforms 256 up and down in the vertical direction.

The pair of second cams 252 are tubular groove cams having a ring-shaped groove 252a formed at the surface on the side facing the lifting platform 256 (hereafter referred to as “opposing surface”), and are supported at positions that are further outward than the position at which the first cam 242 of the input shaft 210 is supported. When the input shaft 210 is rotated, the pair of second cams 252 is rotated integrally with the input shaft 210. Moreover, the ring-shaped grooves 252a are formed on the opposing surfaces of each of the second cams 252, such that they enclose the input shaft 210, and the inner circumferential surfaces of the ring-shaped grooves 252a form cam faces. That is to say, the inner circumferential surface of the ring-shape grooves 252a represents the cam profile of the second cam 252. It should be noted that the inner circumferential surface of the ring-shaped grooves 252a serves as a flat circumferential surface with respect to the axial direction of the input shaft 210.

The second cam followers 254 have the same configuration as the first cam followers 244. Moreover, the second cam followers 254 are supported rotatably at the lower end portion of the lifting platforms 256, with the rotation axis of the second cam followers 254 coinciding with the axial direction of the input shaft 210. Moreover, the second cam followers 254 engage the ring-shaped grooves 252a, with the outer circumferential surface of the second cam followers 254 being in a state of constant contact with the inner circumferential surface (that is, the cam face) of the ring-shaped grooves 252a.

The pair of lifting platforms 256 are respectively rectangular solid-shaped members that are followers of each of the second cams 252 and are attached to the lower end portion of the output section 220. As shown in FIGS. 12 and 13, the lifting platforms 256 are provided respectively at the two end portions in the longitudinal direction of the housing 230 (that is, in the direction of the housing 230 that coincides with the transport direction). Moreover, as shown in FIG. 13, the two end faces in the horizontal direction of the lifting platforms 256 form flat surfaces with respect to the axial direction and the vertical direction.

As shown in FIGS. 13 and 14, the guide members 258 are rectangular solid-shaped members that are arranged between the end face in the horizontal direction of the lifting platforms 256 and the inner walls of the housing 230. The faces of the guide members 258 that oppose the end faces of each of the lifting platforms 256 are flat faces with respect to the vertical direction and the axial direction of the input shaft 210. The lifting platforms 256 move up and down along the faces of the guide members 258 that oppose the end faces of the lifting platforms 256. That is to say, the guide members 258 cause the lifting platforms 256 to move in a two-dimensional plane given by the vertical direction and the axial direction of the input shaft 210. In other words, the movement of the lifting platforms 256 in the horizontal direction is restricted by the guide members 258. It should be noted that a gap is provided between the lifting platforms 256 and the guide members 258, and an oil film for lubricating the movement of the lifting platforms 256 is formed in this gap.

With the second cam mechanism 250 configured in this way, when the input shaft 210 rotates, the pair of second cams 252 rotates integrally with the input shaft 210, and as the second cams 252 rotate, the second cam followers 254 roll along the inner circumferential surface of the ring-shaped groove 252a of the second cams 252. Moreover, the second cam followers 254 move up and down in the vertical direction, in response to the shape of the ring-shaped groove 252a. As shown in FIGS. 14A and 14B, the pair of lifting platforms 256 provided with the second cam followers 254 each move up and down in the vertical direction, while their movement in the horizontal direction is restricted by the guide members 258. Thus, as a result of the output section 220, to which the pair of lifting platforms 256 is attached, moving up and down, the second transport platform 14 that is fastened to the output section 220 also moves up and down in the vertical direction. That is to say, the second cam mechanism 250 causes the output section 220 and the second transport platform 14 to oscillate integrally in the vertical direction (i.e. move up and down). In other words, the second cam mechanism 250 causes an oscillation in the vertical direction, but the direction of the oscillation brought about by the second cam mechanism 250 is not limited to the vertical direction. For example, the direction of the oscillation may also have a component other than the vertical direction (for example, a component in the transport direction or a component in the horizontal direction).

Now, due to the driving of the first cam mechanism 240, also the second cam followers 254 that are provided to the lifting platforms 256 are also moved in the transport direction when the output section 220 reciprocates back and forth in the transport direction. That is to say, the second cam followers 254 advance straight forward in the transport direction relative to the second cams 252 (see FIG. 15A) while the second cam followers 254 stay engaged with the ring-shaped grooves 252a (in other words, the second cam followers 254 maintain a state of contact with the inner circumferential faces of the ring-shaped grooves 252a, that is, the cam faces). Accordingly, the reciprocating movement of the output section 220 in the transport direction brought about by the first cam mechanism 240 does not impede the vertical operation of the output section 220 brought about by the second cam mechanism 250.

On the other hand, when the output section 220 moves up and down in the vertical direction owing to the driving of the second cam mechanism 250, the pair of first cam followers 244 moves relatively to the first cam 242 in the vertical direction while the pair of first cam followers 244 maintains a state of contact with the cam faces 242a and 242b of the first cam 242 (see FIG. 15B). Accordingly, the vertical movement of the output section 220 brought about by the second cam mechanism 250 does not impede the reciprocating movement of the output section 220 in the transport direction brought about by the first cam mechanism 240.

Consequently, in the present embodiment, the output section 220 and the second transport platform 14 can oscillate simultaneously in two directions, namely the transport direction and the vertical direction. In other words, the output section 220 and the second transport platform 14 can oscillate in a compound direction of the transport direction and the vertical direction (hereafter referred to as simply “compound direction”).

An explanation of an operation example of the linear feeder 200 configured as above will follow.

At the linear feeder 200, as in the rotary feeder 100, when the drive motor 300 is started, the input shaft 210 rotates so that the first cam mechanism 240 and the second cam mechanism 250 are driven. Then, owing to the cooperation of the first cam mechanism 240 and the second cam mechanism 250, the second transport platform 14 oscillates in the compound direction, integrally with the output section 220. To explain this in more detail, by oscillating in the compound direction integrally with the output section 220, the second transport platform 14 reciprocates back and forth between point C (the position of the second transport platform 14 shown in a broken line in FIG. 16) and point D (the position of the second transport platform 14 shown in a solid line in FIG. 16). It should be noted that point D is at a further downstream side with respect to the transport direction than point C.

As shown in FIG. 16, the width of the oscillation in the transport direction that is imparted by the first cam mechanism 240 is marked as W1, and the width of the oscillation in the transport direction that is imparted by the second cam mechanism 250 is marked as W2. That is to say, the widths of the oscillations imparted by the linear feeder 200 in the transport direction and the vertical direction are the same as the widths of the oscillations imparted by the rotary feeder 100.

Moreover, since the driving of the first cam mechanism 240 is synchronized with the driving of the second cam mechanism 250, when the second transport platform 14 moves just a distance of W1 to the downstream side in the transport direction from point C, it reaches a position at which it is removed just by a distance of W2 upward in the vertical direction from point C. In other words, the position Cx of point C in the transport direction and the position Dx of point D in the transport direction are separated from each other just by a distance of W1, whereas the position Cy of point C in the vertical direction and the position Dy of point D in the vertical direction are separated from each other just by a distance of W2.

Furthermore, a timing chart of the oscillation imparted by the linear feeder 200 (not shown) is substantially the same as that of the oscillation imparted by the rotary feeder 100. That is to say, also in the linear feeder 200, the cycle of the oscillation in the transport direction is the same as the cycle of the oscillation in the vertical direction. Moreover, the number of oscillations in the compound direction that are imparted by the linear feeder 200 during a single rotation of the input shaft 210 of the linear feeder 200 (that is, the number of reciprocations between point C and point D) is the same as the number of oscillations in the compound direction that are imparted by the rotary feeder 100 during a single rotation of the input shaft 110 of the rotary feeder 100, namely three in the present embodiment.

Since the second transport platform 14 reciprocates between point C and point D, the phenomenon of relative slipping in the transport direction of the products W placed on the second transport platform 14 occurs, by which the products W are moved downstream in the transport direction on the second transport platform 14. The principle of this phenomenon of relative slipping has already been explained above. It should be noted that also for the oscillations imparted by the linear feeder 200, the width W1 and W2 of the oscillations in the transport direction and the vertical direction, as well as the number of oscillations during a single rotation of the input shaft 210 is determined by the shapes (that is, the cam profiles) of the cam faces 242a and 242b of the first cam 242 and the ring-shaped grooves 252a of the second cam 252.

Furthermore, as mentioned above, the width of the oscillations imparted by the linear feeder 200 in both the transport direction and the vertical direction is the same as the width of the oscillations imparted by the rotary feeder 100. That is to say, in the present embodiment, the cam profiles of the first cams 142 and 242 of each of the rotary feeder 100 and the linear feeder 200 are adjusted such that their amplitudes in the transport direction are the same for the rotary feeder 100 and the linear feeder 200. Similarly, the cam profiles of the second cams 152 and 252 of each of the rotary feeder 100 and the linear feeder 200 are also adjusted to have the same amplitude in the vertical direction. Here, “amplitude” means a value of half the width of the oscillations (in other words, the reciprocation distance of the first transport platform 12 and the second transport platform 14 in each direction of the transport direction and the vertical direction).

The Drive Motor 300

The drive motor 300 is a motor for driving both the rotary feeder 100 and the linear feeder 200 (more specifically, for rotatively driving the input shaft 110 of the rotary feeder 100 and the input shaft 210 of the linear feeder 200). That is to say, in the present embodiment, the rotary feeder 100 and the linear feeder 200 utilize the drive motor 300 as a common driving source. Moreover, the input shaft 110 of the rotary feeder 100 and the input shaft 210 of the linear feeder 200 are coupled to the drive shaft of the drive motor 300 via a shaft coupling 302 or a belt transmission 304. More specifically, the input shaft 110 of the rotary feeder 100 is directly coupled to the drive shaft of the drive motor 300 via the shaft coupling 302. And the input shaft 110 of the rotary feeder 100 is provided with a pulley 304a, whereas a pulley 304a forming a pair with the pulley 304a is provided on the input shaft 210 of the linear feeder 200. Moreover, a belt is suspended over this pair of pulleys 304a (in other words, a belt transmission 304 is provided in order to transmit the driving force from the drive motor 300 to the linear feeder 200).

With this configuration, it is possible to transmit the drive force from a single drive motor 300 to both the rotary feeder 100 and the linear feeder 200. It should be noted that in the present embodiment, each of the pulleys 304a have the same diameter. Therefore, the input shafts 110 and 210 of the rotary feeder 100 and the linear feeder 200 have the same number of revolutions per unit time. Moreover, as explained above, also the number of oscillations in the compound direction that is imparted while the input shafts 110 and 210 rotate once is the same for the rotary feeder 100 and the linear feeder 200. Consequently, the number of oscillations in the compound direction imparted by the rotary feeder 100 and the linear feeder 200 (the number of oscillations per unit time) is the same for the rotary feeder 100 and the linear feeder 200.

However, the configuration for ensuring that the number of oscillations in the compound direction is the same for the rotary feeder 100 and the linear feeder 200 is not limited to the above-described configuration. For example, if the number of oscillations in the compound direction that is imparted while the input shafts 110 and 210 rotate once is different for the rotary feeder 100 and the linear feeder 200, the ratio of diameters of the pair of pulleys 304a (that is, the gear reduction ratio) may be adjusted. To give a specific example, this is explained for the case that, while the input shafts 110 and 210 rotate once, the number of oscillations in the compound direction imparted by the rotary feeder 100 is three and the number of oscillations in the compound direction imparted by the linear feeder 200 is four. In this case, if the diameter of the pulley 304a provided on the side of the input shaft 110 of the rotary feeder 100 is designed to ¾ the diameter of the pulley 304a provided on the side of the input shaft 210 of the linear feeder 200, the number of oscillations in the compound direction imparted by each of the rotary feeder 100 and the linear feeder 200 will be the same.

(1) Advantageous Effects of the Product Transport Apparatus According to the Present Embodiment

As explained above, in order to transport a product, the product transport apparatus 1 according to the present embodiment includes a transport section 10 that oscillates in a transport direction and a vertical direction, a rotary feeder 100 and a linear feeder 200 serving as oscillation imparting sections including a first cam mechanism for letting the transport section 10 oscillate in the transport direction and a second cam mechanism for letting the transport section 10 oscillate in a the vertical direction, and a single drive motor 300 that drives the rotary feeder 100 as well as the linear feeder 200. With a product transport apparatus 1 configured in an above manner, the operation of imparting an oscillation with the rotary feeder 100 can be easily synchronized with the operation of imparting an oscillation with the linear feeder 200. In the following, the advantageous effects of the product transport apparatus 1 according to the present embodiment are explained.

Conventionally, various product transport apparatuses have been proposed in which products W are placed on an oscillating transport section and that transport the products W in the transport direction using the phenomenon of relative slipping with respect to the transport section of the products W. Among those product transport apparatuses, there are some that are provided with a plurality of oscillation imparting sections for imparting an oscillation on the transport section, as explained in the Related Art section.

Now, generally known as oscillation imparting sections are such as electromagnetic oscillation imparting sections that impart oscillations using an electromagnet and cam-type oscillation imparting sections that impart oscillations using a cam mechanism.

Here, in the product transport apparatus comprising a plurality of electromagnetic oscillation imparting sections, the driving frequencies of the electromagnets with which the oscillation imparting sections are provided have to be adjusted such that the transport sections are suitably oscillated. However, this adjustment of the driving frequencies is troublesome and it is difficult to match the timing at which each of the oscillation imparting sections impart the oscillations. Therefore, if the driving frequencies are to be readjusted for the purpose of changing for example the transport speed of the product transport apparatus, a large amount of time and effort becomes necessary.

On the other hand, with a product transport apparatus including a plurality of cam-type oscillation imparting sections, an oscillation corresponding to the shape of the cams (that is, the cam profiles) provided in each of the oscillation imparting sections is imparted, so that it is not necessary to perform an operation such as adjusting the driving frequencies of the electromagnetic oscillation imparting sections. Moreover, it is possible to change the transport speed of the product transport apparatus through a relatively easy manipulation (for example, adjusting the number of rotations per unit time of the input shaft). It should be noted, however, that even with cam-type oscillating imparting sections, if there is provided a plurality of oscillation imparting sections, it is necessary to synchronize the oscillation imparting operations of each of the oscillation imparting sections.

Here, for the oscillations imparted by each of the plurality of oscillation imparting sections, if the number of oscillations is adjusted individually for each of the oscillation imparting sections, there is the possibility of shifts in the timing at which oscillations are imparted by each of the oscillation imparting sections. As a result, since the oscillations imparted by the plurality of oscillation imparting sections are transmitted to the transport section 10 in a disorderly manner, there is the risk that the product W placed on the transport section 10 is not properly transported. In particular, if the transport section includes a plurality of transport platforms that are lined up in the transport direction, and a gap S is formed between adjacent transport platforms (see for example FIG. 1), then the above problem becomes more conspicuous. Explaining this in more detail, if the oscillation numbers for the oscillations imparted by the oscillation imparting sections are adjusted individually, then the gap S has a relatively long width, on assumption that there are timing shifts in the oscillations imparted by the oscillation imparting sections. With such a gap S, it is possible to avoid a collision between the transport platforms if there are shifts in the operation of imparting the oscillations with each of the oscillation imparting sections, but due to the oscillations of the transport platforms (in particular the oscillations in the transport direction), the width of the gap S may become too broad. As a result, the products W may not be able to pass over this gap S, the products W may fall through the gap S, and depending on the circumstances there may be even the risk that the product W becomes stuck in the gap and the transport of the products W comes to a halt.

By contrast, with the product transport apparatus 1 according to the present embodiment, a single drive motor 300 is provided in order to drive the rotary feeder 100 and the linear feeder 200. That is to say, the input shaft 110 of the rotary feeder 100 and the input shaft 210 of the linear feeder 200 are rotated with a common driving source, and the operation of imparting oscillations on the rotary feeder 100 is more easily synchronized with the operation of imparting oscillations on the linear feeder 200. Moreover, with the present embodiment, the number of oscillations in the compound direction imparted by the rotary feeder 100 is the same as the number of oscillations in the compound direction imparted by the linear feeder 200, so that the timing of the oscillation imparting operation can be matched precisely.

As a result, if the oscillation numbers of oscillations imparted by the rotary feeder 100 and by the linear feeder 200 are to be adjusted in order to adjust the transport speed of the products W, it is possible to adjust each of the oscillations numbers simultaneously by adjusting the rotation speed of the drive motor 300. As a result, since the oscillation imparting operation is accurately synchronized between the rotary feeder 100 and the linear feeder 200, there are no shifts in the timing with which each of the oscillation imparting sections impart the oscillations and also the adjustment of the transport speed becomes easier.

Moreover, even if a gap S between the transport platforms is formed, there is no need to consider shifts between the oscillation imparting operations of each of the oscillation imparting sections, so that the width of the gap S is reduced, the products W will not fall into the gap S, and a suitable transport of the products W can be realized. Furthermore, if the amplitude of the oscillations imparted by each of the rotary feeder 100 and the linear feeder 200 is the same in the transport direction and the vertical direction, then it also becomes possible to minimize the width of the gap S.

Thus, it becomes possible to easily synchronize the oscillation imparting operation of the rotary feeder 100 with the oscillation imparting operation of the linear feeder 200, and as a result, the product transport apparatus 1 transports the products W in a more suitable manner.

(1) Alternative Configurations of the Product Transport Apparatus

In the above-described embodiment, a product transport apparatus 1 including a transport section 10 with a first transport platform 12 forming a spiral-shaped transport path and a second transport platform 14 forming a linear transport path was explained. With such a product transport apparatus 1, products W moving on the first transport platform 12 are passed on to the second transport platform 14 and are transported to the end in the transport direction of the second transport platform 14 in a state in which they are lined up linearly. In particular, the alignment condition of the products W is more favorable when they move on the second transport platform 14, than when they move on the first transport platform 12, so that a product transport apparatus 1 having such a transport section 10 is capable of providing suitably lined-up products W.

It should be noted, however, that the configuration of the product transport apparatus is not limited to the above-described embodiment (hereafter referred to as “the main example”), but other configuration examples are also possible. In the present section, other configuration examples of the product transport apparatus (that is, the first to the fifth modified examples) are explained. It should be noted that in these modified examples, the oscillation imparting sections (that is, the rotary feeder 100 and the linear feeder 200) have substantially the same configuration as the oscillation imparting sections of the main example, and perform the same oscillation imparting operation, so that further explanations thereof are omitted. As for the oscillations in the compound direction imparted by the oscillation imparting sections, the number of oscillations, amplitudes in the transport direction and the vertical direction are the same among the oscillation imparting sections.

### First Modified Example

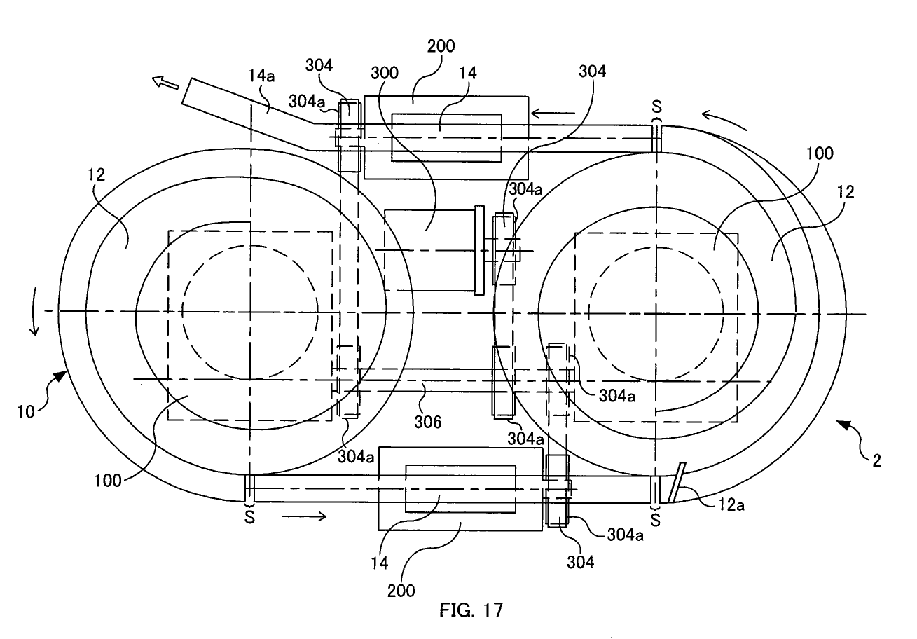

First, a configuration example of a product transport apparatus 2 according to a first modified example is explained with reference to FIG. 17. FIG. 17 is a schematic top view of the product transport apparatus 2 according to the first modified example.

As in the main example, the product transport apparatus 2 according to the first modified example includes a transport section 10 having a plurality of transport platforms lined up in the transport direction. More specifically, the transport section 10 according to this first modified example includes two bowl-shaped first transport platforms 12 and two linear second transport platforms 14. As shown in FIG. 17, these transport platforms are lined up to form an oval transport path (also referred to as “oval path”) in the transport direction. It should be noted that in the following, in order to keep the explanations simple, of the two first transport platforms 12, the one that is further on the upstream side in the transport path is referred to as the “upstream-side first transport platform 12”, whereas the one that is further on the downstream side in the transport path is referred to as the “downstream-side first transport platform 12”. Similarly, of the two second transport platforms 14, the one that is further on the upstream side in the transport path is referred to as the “upstream-side second transport platform 14”, whereas the one that is further on the downstream side in the transport path is referred to as the “downstream-side second transport platform 14”. As in the main example, gaps S are provided between the first transport platforms 12 and the second transport platforms 14. Furthermore, as shown in FIG. 17, the downstream-side second transport platform 14 is provided with a product retrieval section 14a for retrieving the products W from the transport section 10 at the end in transport direction of the second transport platform 14. This product retrieval section 14a forms a transport path that is bent away from the transport direction of the second transport platform 14. Moreover, a guide wall 12a for guiding the products W to the bottom of the downstream-side first transport platform 12 is provided within the transport path formed by the downstream-side first transport platform 12, as shown in FIG. 17.

A rotary feeder 100 and a linear feeder 200 serving as oscillation imparting sections are arranged below the transport platforms. More specifically, a rotary feeder 100 is arranged below each of the first transport platforms 12 and a linear feeder 200 is arranged below each of the second transport platforms 14. And as in the main example, a single drive motor 300 for driving the plurality of oscillation imparting sections (that is, the two rotary feeders 100 and the two linear feeders 200) are provided, and the driving force from this drive motor 300 is transmitted to each of the oscillation imparting sections through a belt transmission 304. Moreover, in this modified example, as shown in FIG. 17, the two rotary feeders 100 are provided with a common shaft 306 as a common input shaft. That is to say, the first cam mechanism 140 and the second cam mechanism 150 provided in each of the two rotary feeders 100 are supported by the two axial ends of the common shaft 306. It should be noted that three pulleys 304a are supported by the common shaft 306, the pulleys 304a with which the drive motor 300 is provided and the pulleys 304a with which the input shafts 210 of the two linear feeders 200 form pairs, and belts are suspended between these pairs of pulleys 304a.

With the product transport apparatus 2 according to the first modified example configured in this manner, by starting the drive motor 300, the products W stored at the bottom of the upstream-side first transport platform 12 are transported along the spiral-shaped transport path formed by the upstream-side first transport platform 12. Then, the products W that have reached the end of the spiral-shaped transport path are passed to the upstream-side second transport platform 14, and moved along the linear transport path formed by the upstream-side second transport platform 14. Then, the products W that have reached the end of this linear transport path are passed on to the downstream-side first transport platform 12, and subsequently, they collide with the guide wall 12a and are forced to fall to the bottom of the downstream-side first transport platform 12. Here, products W with a flat shape, such as tablets, are flipped over when falling to the bottom of the downstream-side first transport platform 12. Then, the products W that have been flipped over are moved along the spiral-shaped transport path formed by the downstream-side first transport platform 12, and when they reach the end of the spiral-shaped transport path, they are passed to the downstream-side second transport platform 14. Products W that move along the linear transport path formed by the downstream-side second transport platform 14 and reach the end of the product retrieval section 14a are retrieved at the product retrieval section 14a and passed on to the next operation step.

As explained above, the product transport apparatus 2 according to the first modified example has a transport distance that is longer than that of the product transport apparatus 1 of the main example. Moreover, it becomes possible to keep the products W on the transport section 10 for an additional time corresponding to an amount by which the transport path has been prolonged. As a result, it is also possible to arrange various kinds of processes, such as a process of handling or a process of inspecting the products W, during the transport of the products W. It should be noted that since the transport path is oval, the set-up space of the transport section 10 can be made more compact than if the linear transport path is simply extended in the transport direction.

Moreover, if the products W are inspected during the transport of the products W, it becomes possible to inspect them from both sides, namely the top side and the bottom side, because the product W can be flipped over during the transport. Moreover, in this modified example, a guide wall 12a is provided in the transport path formed by the downstream-side first transport platform 12, and the products W are flipped over when falling to the bottom of the downstream-side first transport platform 12. However, there is no limitation to this, and it is also possible to provide a product flipping mechanism (not shown) within the transport path and flip over the products W with the product flipping mechanism without letting them fall to the bottom of the downstream-side first transport platform 12. In this case, it is possible to flip over the products W more accurately. Moreover, the transport order of the products W when inspecting the top side of the products W matches the transport order when inspecting the bottom side. Such a configuration in which the products W are inspected while the transport orders of the products W before and after the flipping over remain the same is particularly advantageous in an inspection operation for validation in a factory manufacturing pharmaceuticals or the like.

### Second Modified Example

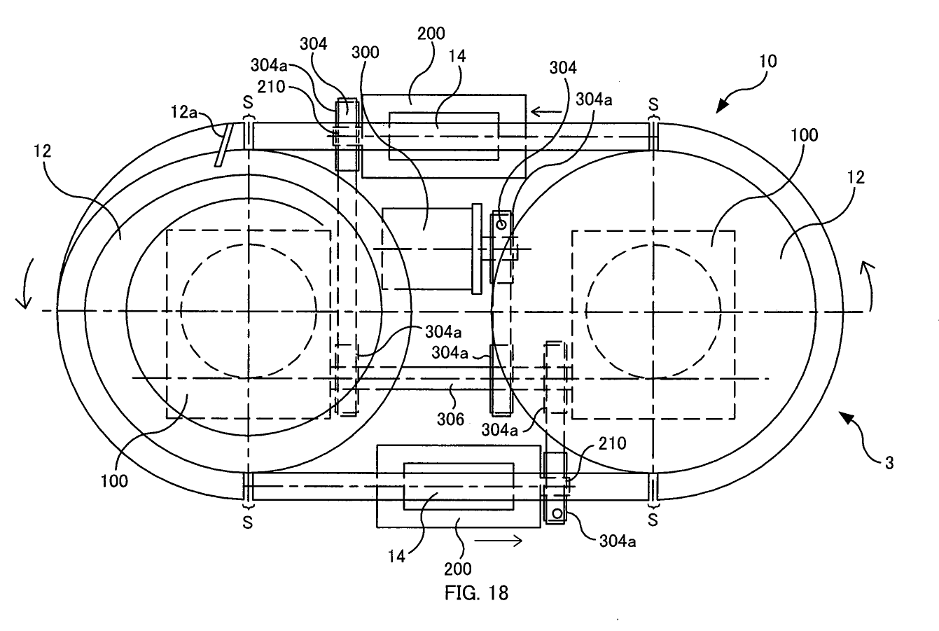

In the first modified example, a product retrieval section 14a is provided at the end of the transport path, but it is also possible that, for example, no such product retrieval section 14a is provided, and a circulating transport path is formed as shown in FIG. 18 (hereinafter referred to as “second modified example”). FIG. 18 is a schematic top view of a product transport apparatus 3 according to a second modified example. An explanation of a product transport apparatus 3 according to this second modified example will follow.

With a product transport apparatus 3 according to the second modified example 3, the products W stored at the bottom of the upstream-side first transport platform 12 are transported from this bottom and revolve around the circulating transport path. Moreover, products W that have returned to the upstream-side first transport platform 12 collide with the guide wall 12a that is provided in the transport path formed by the upstream-side first transport platform 12, are dropped to the bottom of the upstream-side first transport platform 12, and are again transported on the circulating transport path. It should be noted that at the downstream-side first transport platform 12, the products W do not drop to the bottom of the first transport platform 12, but are transported along the outer circumference of that downstream-side first transport platform 12 (in other words, the downstream-side first transport platform 12 forms an arc-shaped transport path).

With the product transport apparatus 3 according to this second modified example, a circulating transport of the products W can be realized, and it becomes easier to implement a repeated inspection operation of products W of the same lot. More specifically, in the product transport apparatus 2 of the first modified example, in order to implement a repeated inspection of the products W of the same lot, the products W first need to be retrieved from the product retrieval section 14a, and then those products W need to be supplied again onto the transport section 10 (more precisely, the bottom of the upstream-side first transport platform 12). By contrast, with the product transport apparatus 3 according to the second modified example, the products W circulate within the transport path, so that it is possible to omit the steps of retrieving the products W and again supplying them onto the transport section 10. Therefore, it becomes easier to implement repeated inspection operations.

### Third Modified Example

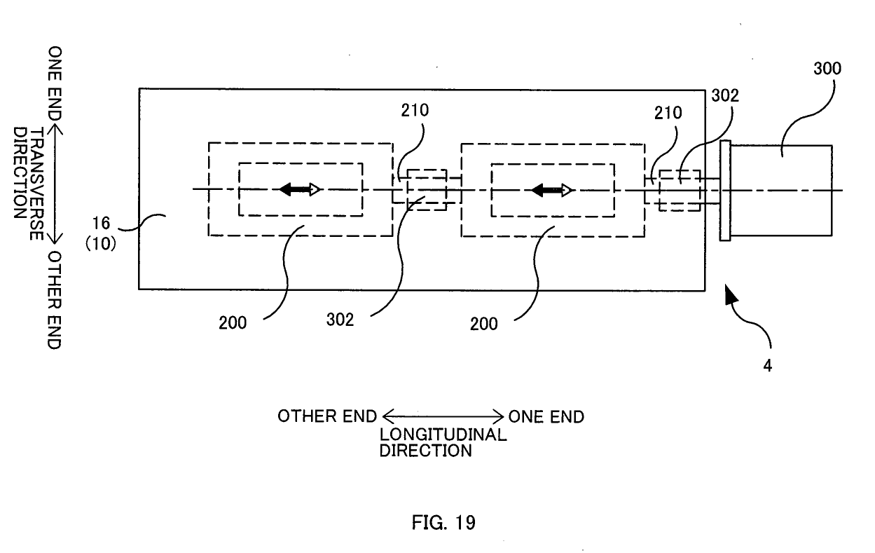

In the main example, the first modified example, and the second modified example, the transport section 10 includes a plurality of transport platforms, and this plurality of transport platforms is lined up in the transport direction. However, there is no limitation to this, and it is also possible that only a single transport platform is provided as the transport section 10. As such a single transport platform, a rectangular transport platform whose longitudinal direction matches the transport direction may be used (hereinafter referred to as the “third modified example”). Referring to FIG. 19, an explanation of a product transport apparatus 4 according to this third modified example will be given. FIG. 19 is a schematic top view of a product transport apparatus 4 according to the third modified example. In FIG. 19, the arrows denote the longitudinal direction and the transverse direction of a third transport platform 16.

In the product transport apparatus 4 according to the third modified example, the transport section 10 is a third transport platform 16, which is a rectangular transport platform whose longitudinal direction matches the transport direction, as explained above. Below this third transport platform 16, two linear feeders 200 are provided as a plurality of oscillation imparting sections. These two linear feeders 200 are lined up linearly in the longitudinal direction of the third transport platform 16 (that is, the transport direction of the products W on the third transport platform 16). More specifically, the input shafts 210 with which each of the two linear feeders 200 are provided and the rotation shaft of the drive motor 300 are arranged such that they lie on the same axis, extending in the longitudinal direction of the third transport platform 16. It should be noted that for the sake of simplicity, in the following explanations, of the two linear feeders 200, the linear feeder 200 at one end side in the longitudinal direction of the third transport platform 16 is referred to as the “linear feeder 200 on one end side”, whereas the linear feeder 200 at the other end side in the longitudinal direction of the third transport platform 16 is referred to as the “linear feeder 200 on the other end side”.

Also in this modified example, as in the main example, the two linear feeders 200 are driven by a single drive motor 300. Moreover, in the linear feeder 200 on one end side, the input shaft 210 is provided in a state so that it passes through the housing 230. As shown in FIG. 19, one end portion in the axial direction of the input shaft 210 of the linear feeder 200 on one end side is coupled to the drive motor 300 through a shaft coupling 302, whereas the other axial end portion is coupled to the input shaft 210 of the linear feeder 200 on the other end side through a shaft coupling 302.

With a product transport apparatus 4 according to the third modified example configured in an above manner, when the drive motor 300 is started, the third transport platform 16 oscillates in the longitudinal direction and the vertical direction of the third transport platform 16 (more precisely, in a compound direction of the longitudinal direction and the vertical direction) owing to the cooperation of the two linear feeders 200. Thus, the products W placed on the third transport platform 16 are transported along the longitudinal direction of the third transport platform 16 to the other end side in the longitudinal direction.

Here, the transport section 10 includes a plurality of transport platforms, and if a gap S is formed between the transport platforms, the width of this gap S can be reduced by causing each of the plurality of oscillation imparting sections be driven with a single drive motor 300, as described above. That is to say, if there is a gap S between the transport platforms, a configuration driving the plurality of oscillation imparting sections with a single drive motor 300 is advantageous.

On the other hand, with the third modified example, the transport section 10 is a single third transport platform 16, so that needless to say, transport irregularities may occur that are caused by deflection of the third transport platform 16 in the longitudinal direction and the like, even without the formation of a gap S. That is to say, when an even oscillation state cannot be attained in the various sections of the third transport platform 16, irregularities occur in the product transport speed in the various sections, and there is a risk that the products W cannot be suitably transported. Here, if the two linear feeders 200 are lined up linearly in the longitudinal direction of the third transport platform 16, such transport irregularities are suppressed, but when there is a shift in the oscillation imparting operations of the two linear feeders 200, there is the risk of rattling of the third transport platform 16. By contrast, with the third modified example, since each of the two linear feeders 200 is driven by a single drive motor 300, each of the oscillation imparting operations of the two linear feeders 200 are easily synchronized, so that rattling of the third transport platform 16 can be easily suppressed. As a result, it becomes possible to realize an ideal transport of the products W. That is to say, the configuration of the present invention is also advantageous when the transport section 10 is a rectangular third transport platform 16 whose longitudinal direction matches the transport direction.

### Fourth Modified Example

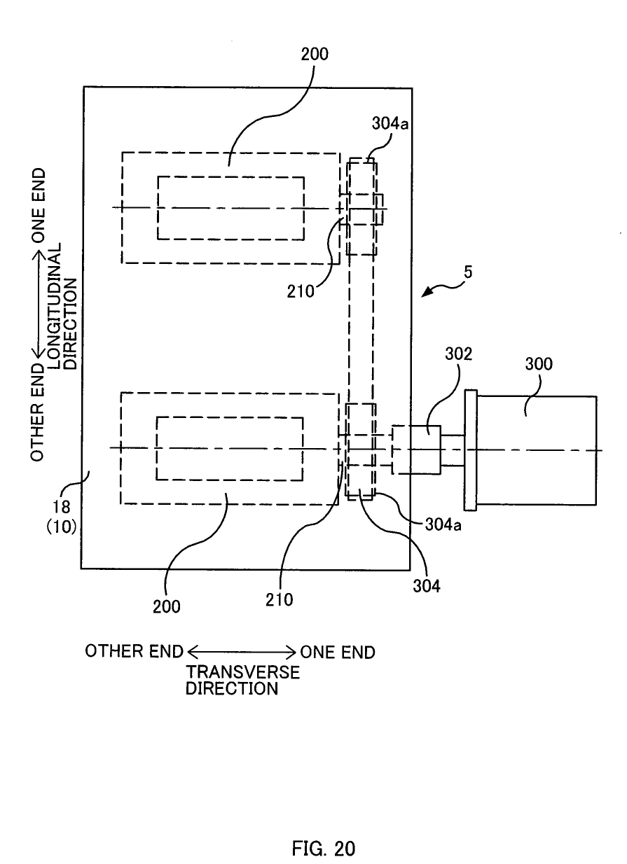

The third modified example was explained as an example in which the transport section 10 is a third transport platform 16 whose longitudinal direction matches the transport direction. However, the transport section 10 is not limited to the shape of the third modified example. For example, it is also possible that the transport section 10 is a rectangular transport platform whose transverse direction matches the transport direction (hereinafter referred to as the “fourth modified example”). Referring to FIG. 20, an explanation of such a product transport apparatus 5 according to the fourth modified example will follow. FIG. 20 is a schematic top view of this product transport apparatus 5 according to the fourth modified example. In FIG. 20, the arrows denote the longitudinal direction and the transverse direction of the fourth transport platform 18.

In the product transport apparatus 5 according to the fourth modified example, the transport section 10 is a fourth transport platform 18, which is a rectangular transport platform whose transverse direction matches the transport direction, as explained above. Below this fourth transport platform 18, two linear feeders 200 are provided, as in the third modified example. These two linear feeders 200 are lined up linearly in the longitudinal direction of the fourth transport platform 18. More specifically, the two linear feeders 200 are lined up at substantially the same position in the transverse direction of the fourth transport platform 18. It should be noted that for the sake of simplicity, in the following explanations, of the two linear feeders 200, the linear feeder 200 at the one end side in the longitudinal direction of the fourth transport platform 18 is referred to as the “linear feeder 200 on the one end side”, whereas the linear feeder 200 at the other end side in the longitudinal direction of the fourth transport platform 18 is referred to as the “linear feeder 200 on the other end side”.

Also in this modified example, as in the main example, the two linear feeders 200 are driven by a single drive motor 300. Moreover, the input shaft 210 of the linear feeder 200 on the one end side is coupled to the drive motor 300 by a shaft coupling 302. The input shaft 210 of the linear feeder 200 on the one end side and the input shaft 210 of the linear feeder 200 on the other end side both support the pulleys 304a, and a belt is suspended between the pulleys 304a.

With a product transport apparatus 5 according to the fourth modified example configured in an above manner, when the drive motor 300 is started, the fourth transport platform 18 oscillates in the transverse direction and the vertical direction of the fourth transport platform 18 (more precisely, in a compound direction of the transverse direction and the vertical direction) owing to the cooperation of the two linear feeders 200. Moreover, the products W placed on the fourth transport platform 18 are transported in the transverse direction of the fourth transport platform 18 to the other end side in the transverse direction. Thus, the fourth transport platform 18 has a broad structure with respect to the transport direction, so that the product transport apparatus 5 according to the fourth modified example transports the products W in a state in which they are lined up in the longitudinal direction of the fourth transport platform 18, so that a large amount of products W can be transported at the same time.

Moreover, by lining up two linear feeders 200 linearly in the longitudinal direction of the fourth transport platform 18, transport irregularities and rattling of the fourth transport platform 18 are suppressed, as in the third modified example. Consequently, the configuration of the present invention is also advantageous when the transport section 10 is a rectangular fourth transport platform 18 whose transverse direction matches the transport direction.

### Fifth Modified Example

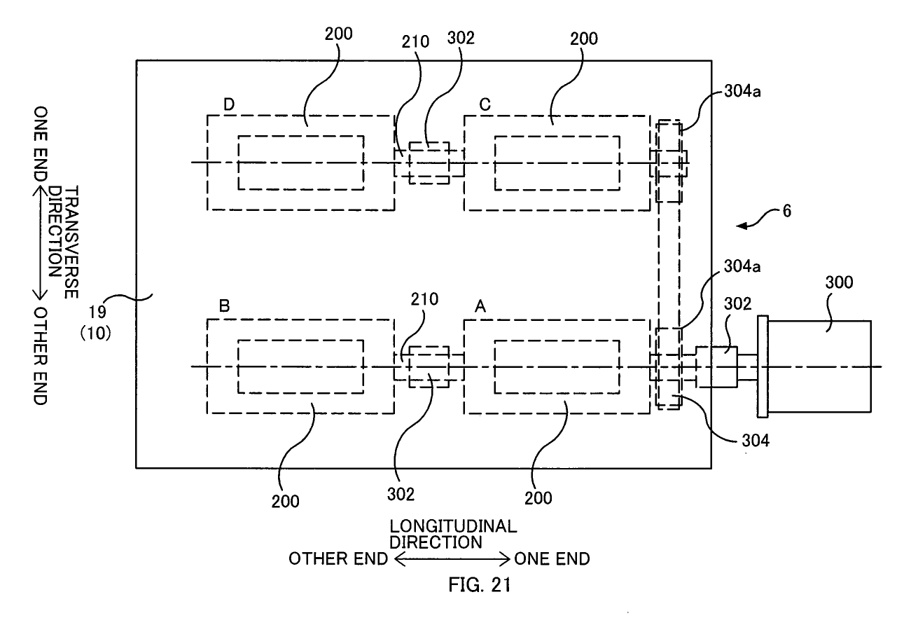

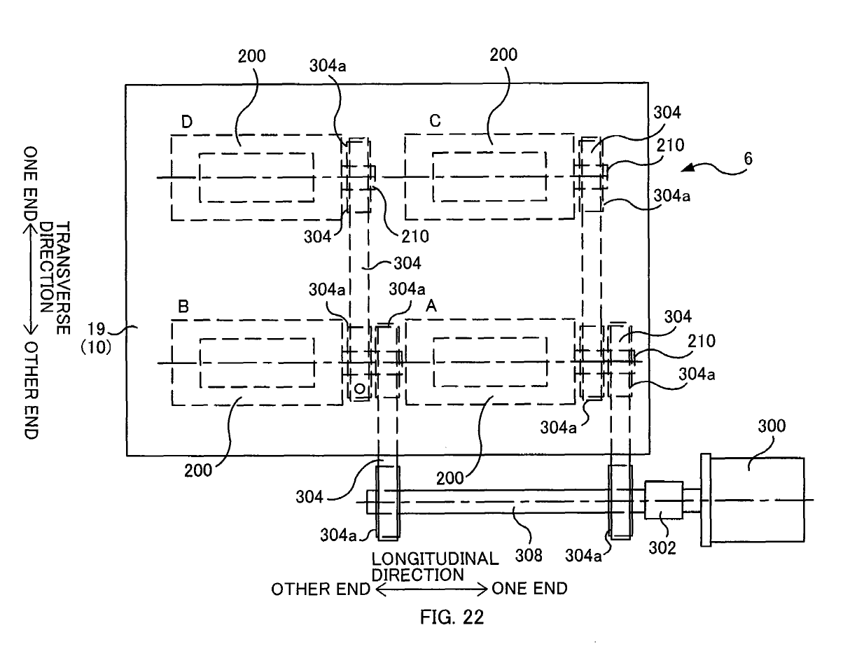

In the fourth modified example, a case was explained in which the transport section 10 is a fourth transport platform 18 that is broad with respect to the transport direction, and whose transverse direction matches the transport direction. However, it is also possible that the transport section 10 is a transport platform that is broad with respect to the transport direction and whose longitudinal direction matches the transport direction (hereafter referred to as the “fifth modified example”). In the following, a product transport apparatus 6 according to the fifth modified example is explained with reference to FIGS. 21 and 22. FIG. 21 is a schematic top view of a product transport apparatus 6 according to the fifth modified example. FIG. 22 is a view of the modified example relating to the transmission mechanism of the driving force from the drive motor 300 in the product transport apparatus 6 according to the fifth modified example. In FIGS. 21 and 22, the arrows denote the longitudinal direction and the transverse direction of the fifth transport platform 19.

In the product transport apparatus 6 according to the fifth modified example, the transport section 10 is a fifth transport platform 19 which is a rectangular transport platform that is wide with respect to the transport direction and whose longitudinal direction matches the transport direction. In the fifth modified example, four linear feeders 200 are arranged below the fifth transport platform 19. As shown in FIG. 21, of the four linear feeders 200, two are arranged on the one end side and the remaining on the other end side in the transverse direction of the fifth transport platform 19. Furthermore, each of the two linear feeders 200 are lined up linearly in the longitudinal direction of the fifth transport platform 19. It should be noted that in order to keep the explanations simple, in the following explanations the positions of the four linear feeders 200 are marked with the letters A to D in FIG. 21, and the linear feeders 200 are specified by the letters assigned to those positions (for example, the linear feeder 200 arranged at the position with the letter A is referred to as “linear feeder 200 at position A”).

In this modified example, the linear feeder 200 at position A and the linear feeder 200 at position C are each arranged in a state in which the input shaft 210 passes through the housing 230. Moreover, the one end portion in the axial direction of the input shaft 210 of the linear feeder 200 at position A is coupled to the drive motor 300 by an axial coupling 302. That is to say, the input shaft 210 of the linear feeder 200 at position A and the rotation shaft of the drive motor 300 are lined up coaxially in the longitudinal direction of the fifth transport platform 19. Moreover, the linear feeder 200 at position A and the linear feeder 200 at position C are coupled by a belt that is suspended between pulleys 304, which are supported at the one end portion in the axial direction of the input shafts 210 and which are provided to each of the linear feeders. Moreover, the other end portion in the axial direction of the input shaft 210 of the linear feeder 200 at position A is coupled to the input shaft 210 of the linear feeder 200 at position B through a shaft coupling 302. Similarly, also the other axial end portion of the input shaft 210 of the linear feeder 200 at position C is coupled to the input shaft 210 of the linear feeder 200 at position D through a shaft coupling 302. Thus, as in the main and other examples, in this modified example, four linear feeders 200 are driven by a single drive motor 300 as well.

With a product transport apparatus 6 according to the fifth modified example configured in the above manner, owing to the cooperation of the four linear feeders 200, the fifth transport platform 19 oscillates in the longitudinal direction and the vertical direction of the fifth transport platform 19 (more precisely, in a compound direction of the longitudinal direction and the vertical direction). Thus, the products W that are placed on the fifth transport platform 19 are transported in the longitudinal direction of the fifth transport platform 19 to the other end side in longitudinal direction.

Moreover, with the product transport apparatus 6 according to the fifth modified example, it is possible to transport a large amount of products W at once, while restricting the deflection of the fifth transport platform 19 in the longitudinal direction and the transverse direction. And as in the third modified example and the fourth modified example, transport irregularities and rattling of the fifth transport platform 19 are suppressed as well. That is to say, the effect of the present invention is also advantageous when the transport section 10 is a rectangular fifth transport platform 19 which is broad with respect to the transport direction and whose longitudinal direction matches the transport direction.

It should be noted that the configuration for transmitting the driving force from the drive motor 300 to each of the linear feeders 200 is not limited to the configuration shown in FIG. 21 and may also have the configuration shown in FIG. 22, for example. More specifically, the drive shaft 308 coupled to the rotation shaft of the drive motor 300 by a shaft coupling 302 and each of the input shafts 210 of the linear feeder 200 at position A and the linear feeder 200 at position B are coupled via a belt transmission 304. Moreover, the input shafts 210 of each of the linear feeder 200 at position A and the linear feeder 200 at position C are coupled by a belt transmission 304 and also the input shafts 210 of the linear feeder 200 at position B and the linear feeder 200 at position D are coupled by a belt transmission 304. With such a configuration, when the drive motor 300 is driven, the drive shaft 308 and the pulleys 304a fastened to the drive shaft 308 rotate integrally, so that the drive force is transmitted from the drive motor 300 via the belt transmission 304 to the input shapts 210 of each of the four linear feeders 200.

### (1) Other Embodiments

In the foregoing, a product transport apparatus according to the present invention was explained based on the first embodiment, but the above-described first embodiment of the present invention is merely for the purpose of a clear understanding of the present invention and is not to be interpreted as limiting the present invention. The invention can of course be altered and improved without departing from the gist thereof and includes functional equivalents.

The first embodiment was explained for the case that various types of transport platforms, such as the first transport platform 12 and the second transport platform 14, are fastened to the output sections 120 and 220 of each of the rotary feeder 100 and the linear feeder 200. That is to say, the transport platforms oscillate integral with the output sections 120 and 220, but there is no limitation to this. For example, it is also possible that even though the transport platforms are placed on the output sections 120 and 220, they are not fastened to the output sections 120 and 220. However, if the oscillations of the oscillation imparting sections are transmitted to the transport platforms through the output sections 120 and 220, then the oscillations are properly transmitted if the transport platforms are fastened to the output sections 120 and 220. With regard to this aspect, the first embodiment is preferable.

In the first embodiment, the first cams 142 and 242 and the second cams 152 and 252 of each of the rotary feeder 100 and the linear feeder 200 are supported by the input shafts 110 and 210, and when the input shafts 110 and 210 rotate, they rotate integrally, but there is no limitation to this. For example, it is also possible to arrange the rotation shaft supporting the first cams 142 and 242 and rotating intergrally with these first cams 142 and 242 and the rotation shaft supporting the second cams 152 and 252 and rotating integrally with these second cams 152 and 252 as different shafts. However, if the first cams 142 and 242 and the second cams 152 and 252 in each of the feeders are all supported by the input shafts 110 and 210, then the rotation of the first cams 142 and 242 can be easily synchronized with the rotation of the second cams 152 and 252. Therefore, each of the rotary feeder 100 and the linear feeder 200 tend to impart such oscillations that the phases of the transport platforms in the transport direction and in the vertical direction change as shown in FIG. 9. That is to say, it becomes easier to impart on the transport platforms oscillations that enhance the phenomenon of relative slipping of the products W, and as a result, the products W can be transported more properly. With regard to this aspect, the first embodiment is preferable.

Moreover, the first embodiment was explained for the case that a plurality of oscillation imparting sections, such as the rotary feeder 100 or the linear feeder 200, are provided, and the first cams 142 and 242 of each of the oscillations imparting sections are provided with such cam profiles that the amplitudes of the oscillations imparted by each of those oscillation imparting sections in the transport direction are the same among the oscillation imparting sections. Furthermore, the second cams 152 and 252 of each of the oscillation imparting sections are provided with such cam profiles that the amplitudes of the oscillations imparted by each of those oscillation imparting sections in the vertical direction are the same among the oscillation imparting sections. However, there is no limitation to this, and it is also possible that the amplitudes of the oscillations imparted by each of the oscillation imparting sections in one direction of either the transport direction or the vertical direction are not the same among the oscillation imparting sections. Moreover, it is also possible that the amplitudes of the oscillations imparted by each of the oscillation imparting sections are different among the oscillation imparting sections with respect to both the transport direction and the vertical direction.

As explained above, the transport speed of the products W depends on the amplitudes of the oscillations imparted by each of the oscillation imparting sections in the transport direction and the vertical direction. Therefore, if the amplitudes of the oscillations imparted by each of a plurality of oscillation imparting sections with respect to the transport direction and the vertical direction are the same among the oscillation imparting sections, then it becomes possible to suppress transport irregularities, because a uniform transport speed is attained in the various sections of the transport section 10.

Moreover, if the transport section 10 includes a plurality of transport platforms (for example, the first transport platform 12 and the second transport platform 14) and a gap S is formed between the transport platforms, then, as explained above, the width of this gap S is minimized if the amplitudes are the same among the oscillation imparting sections. That is to say, if the amplitudes differ among the oscillation imparting sections, it is necessary to give consideration to the difference in amplitudes among the oscillation imparting sections when setting the width of the gap S, whereas if the amplitudes are the same among the oscillation imparting sections, then it is possible to reduce the necessary width of the gap S to a minimum, without considering amplitude differences.

In particular if the amplitude in the vertical direction is the same among the oscillation imparting sections, then the phases in the vertical direction of the various components of the transport section 10 are easy to match. Therefore, suitable transport of the products W becomes possible without undulations (formation of a level difference in the transport path when there are shifts in the phase in the vertical direction of the various components of the transport section 10) in the transport path formed by the transport section 10. With regard to this aspect, the above first embodiment is preferable.

### 2. Second Embodiment

(2) Product Transport Apparatus

An explanation of a configuration example and an operation example of a product transport apparatus 1001 according to this embodiment will follow. It should be noted that in the following explanations, “product W” is a general term for objects that are transported by the product transport apparatus 1001, such as machine components or medical pills or the like.

Configuration Example of Product Transport Apparatus

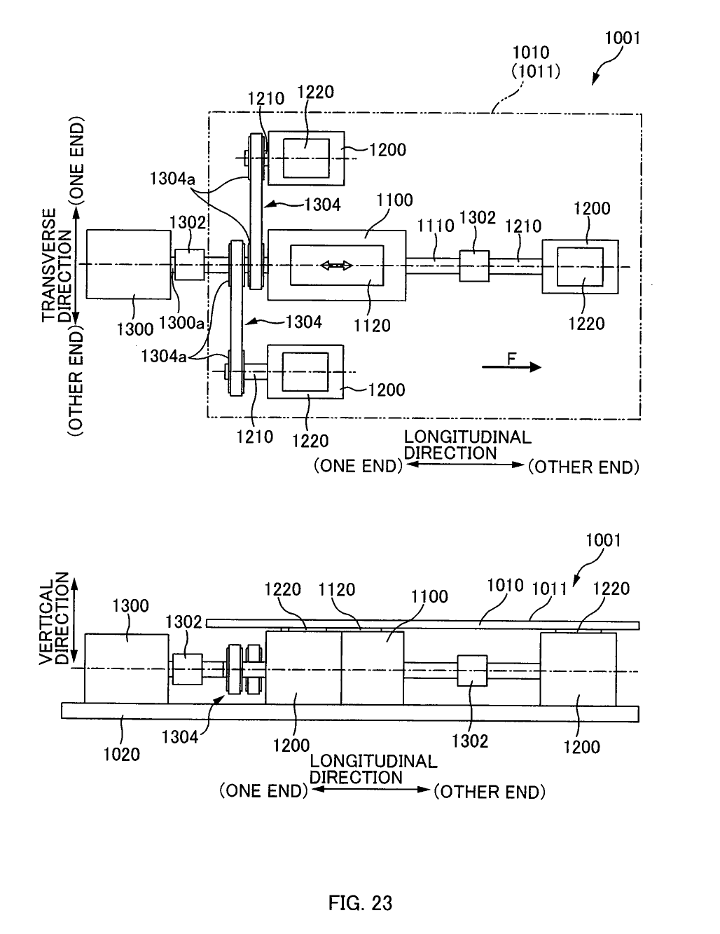

First, a configuration example of a product transport apparatus 1001 according to the present embodiment is explained with reference to FIG. 23. FIG. 23 is a schematic view of the unit layout of this product transport apparatus 1001, and shows the unit layout viewed from the top (upper diagram) and the unit layout viewed from the side (lower diagram) Moreover, in the upper diagram in FIG. 23, the arrows denote the longitudinal direction and the transverse direction of a placement surface 1011, and in the lower diagram in FIG. 23, the arrows denote the longitudinal direction and the vertical direction of the placement surface 1011.

The product transport apparatus 1001 according to this embodiment is an apparatus that transports products in a straight line in a predetermined transport direction (the direction labeled by the letter “F” in the upper diagram of FIG. 23). As shown in FIG. 23, the product transport apparatus 1001 includes an oscillation plate 1010, one first oscillation imparting unit 1100, three second oscillation imparting units 1200, and a drive motor 1300. Moreover, the first oscillation imparting unit 1100, the second oscillation imparting units 1200, and the drive motor 1300 are fastened to abase member 1020, as shown in the lower diagram of FIG. 23. The following is an explanation of the various structural elements of this product transport apparatus 1001.

The Oscillation Plate 1010

The oscillation plate 1010 is explained with reference to the above-noted FIG. 23. As shown in the upper diagram of FIG. 23, this oscillation plate 1010 is a rectangular steel plate whose longitudinal direction matches the transport direction of the products W (hereafter referred to as simply “transport direction”). This oscillation plate 1010 is provided on its upper surface with a flat placement surface 1011 for placing the products W. This placement surface 1011 is, of course, rectangular and its longitudinal direction extends in the transport direction. It should be noted that in the present embodiment, the length of the placement surface 1011 in the transverse direction (that is, the width of the oscillation plate 1010) is comparatively long, so that a large amount of products W can be placed on the placement surface 1011. Therefore, it is possible to transport a large amount of products W at the same time with the product transport apparatus 1001 of the present embodiment.

On the other hand, the lower surface of the oscillation plate 1010 is fastened to and supported by a first output section 1120 of a later-described first oscillation imparting unit 1100 and a second output section 1220 of a second oscillation imparting unit 1200. Moreover, the oscillation plate 1010 is supported by the first output section 1120 and the second output section 1220 such that it can oscillate in the transport direction and the vertical direction. Here, the vertical direction is the direction perpendicular to the placement surface 1011. Furthermore, the oscillation plate 1010 is supported such that the placement surface 1011 substantially lies in the horizontal plane. That is to say, the longitudinal direction and the transverse direction of the placement surface 1011 substantially coincide with the horizontal direction. Moreover, also the transport direction substantially corresponds with the horizontal direction. On the other hand, the vertical direction is a direction that intersects the horizontal plane.

First Oscillation Imparting Unit 1100

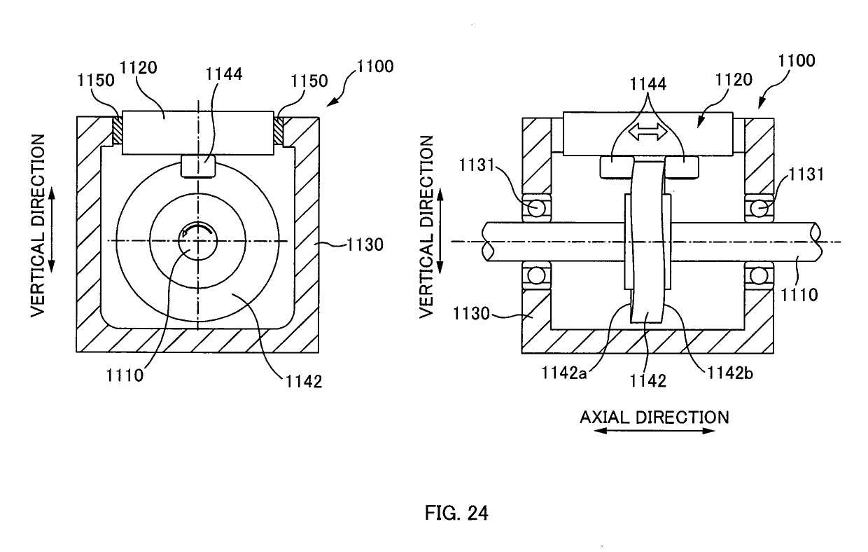

The following is an explanation of a configuration example and an operation example of the first oscillation imparting unit 1100, with reference to the above-noted FIG. 23 and FIG. 24. FIG. 24 is a diagram showing the internal structure of the first oscillation imparting unit 1100. In FIG. 24, the left diagram is a schematic cross-sectional view of the center in the length direction of the first oscillation imparting unit 1100 (the direction along the transport direction), whereas the right diagram is a schematic cross-sectional view of the center in the width direction of the first oscillation imparting unit 1100 (the direction that intersects the transport direction and that is along the transverse direction of the transport surface 1011). In the left diagram in FIG. 24, the arrows denote the vertical direction and in the right diagram in FIG. 24, the arrows denote the vertical direction and the axial direction of the input shaft 1110.

As shown in the lower diagram in FIG. 23, the first oscillation imparting unit 1100 is arranged below the oscillation plate 1010, and it is provided with a cam mechanism (that is, the later-described first cam mechanism 1140) inside. Moreover, through this cam mechanism, the first oscillation imparting unit 1100 imparts an oscillation in the transport direction to the oscillation plate 1010 from below the oscillation plate 1010. It should be noted that in the product transport apparatus 1001 of the present embodiment, only one first oscillation imparting unit 1100 is arranged in the center with respect to the transverse direction of the oscillation plate 1010 at one end portion in longitudinal direction of the oscillation plate 1010.

As shown in FIG. 24, the first oscillation imparting unit 1100 includes an input shaft 1110, a first output section 1120, a housing 1130, a first cam mechanism 1140 and guide members 1150.

The housing 1130 is a substantially box-shaped casing containing the first cam mechanism 1140 and the like inside, and is fastened onto a base member 1020. Moreover, a substantially rectangular opening is provided in the ceiling wall of the housing 1130.

The input shaft 1110 is a shaft that rotates around its center axis, in order to drive the first cam mechanism 1140. In the present embodiment, the input shaft 1110 passes through the side walls of the housing 1130 and is supported rotatably by the housing 1130 through bearings 1131, as shown in the right diagram in FIG. 24. Moreover, the axial direction of the input shaft 1110 coincides with the length direction of the first oscillation imparting unit 1100 (that is, the transport direction). As shown in FIG. 23, the one axial end of the input shaft 1110 is coupled to a rotation shaft 1300a of the drive motor 1300 through a shaft coupling 1302. Consequently, when the drive motor 1300 is started and the rotation shaft 1300a rotates, the driving force from the drive motor 1300 is transmitted through the shaft coupling 1302 to the input shaft 1110, rotating the input shaft 1110. Furthermore, one axial end portion of the input shaft 1110 is provided with pulleys 1304a for transmitting the drive force from the drive motor 1300 to other oscillation imparting units (that is, the second oscillation imparting units 1200). Moreover, as shown in FIG. 23, the other axial end portion of the input shaft 1110 is coupled via a shaft coupling 1302 to the input shaft 1210 of one second oscillation imparting unit 1200.

The first output section 1120 is a rectangular plate member, which is placed at a position closing the aperture provided in the ceiling wall of the housing 1130 and is smaller than that aperture. This first output section 1120 is supported within the housing 1130 such that it can reciprocate back and forth in the axial direction of the input shaft 1110 (that is, in the transport direction, as indicated by arrows in the right diagram of FIG. 24). Moreover, the first output section 1120 is fastened to and supports the oscillation plate 1010 with its upper surface in a state in which the upper surface of the first output section 1120 is positioned above the upper end surface of the housing 1130. Thus, by reciprocating the first output section 1120 back and forth in the axial direction of the input shaft 1110, the oscillation plate 1010 oscillates in the transport direction integrally with the first output section 1120. As shown in the left diagram in FIG. 24, both end portions in the width direction of the first output section 1120 (that is, the width direction of the first oscillation imparting unit 1100) are adjacent to the rectangular solid-shaped guide members 1150. More specifically, the guide members 1150 fill the gaps between the two end faces in width direction of the first output section 1120 and the inner walls of the housing 1130. Of the various surfaces of the guide members 1150, the surfaces facing the end faces in the width direction of the first output section 1120 (referred to below as “opposing surfaces”) are flat surfaces with respect to the axial direction and the vertical direction of the input shaft 1110. Moreover, the first output section 1120 reciprocates back and forth along the opposing surfaces. That is to say, the first output section 1120 moves in the axial direction while its movement in the direction that intersects the axial direction of the input shaft 1110 (that is, the transverse direction of the placement surface 1011) is restricted by the guide members 1150. It should be noted that a film of lubrication oil is formed between the first output section 1120 and the guide members 1150, and the first output section 1120 can reciprocate smoothly back and forth in the axial direction.

The first cam mechanism 1140 is for letting the first output section 1120 reciprocate back and forth in the axial direction of the input shaft 1110. In other words, the first cam mechanism 1140 is for letting the oscillation plate 1010 oscillate in the transport direction via the first output section 1120. As shown in FIG. 24, the first cam mechanism 1140 includes a first cam 1142 that rotates as the input shaft 1110 rotates, and a pair of cam followers 1144 that engage the first cam 1142.

The first cam 1142 is a cylindrical rib cam, and is supported at the center in axial direction of the input shaft 1110 below the first output section 1120. When the input shaft 1110 rotates, the first cam 1142 rotates integtrally with the input shaft 1110. Moreover, rib-shaped cam faces 1142a and 1142b are formed to extend along the entire circumference of both end faces in axial direction of the first cam 1142. As shown in the right diagram in FIG. 24, the cam faces 1142a and 1142b are curved with respect to the axial direction of the input shaft 1110, the cam face 1142a that is formed at one end surface in the axial direction having the same curved shape as the cam face 1142b that is formed at the other end surface in the axial direction. The shapes of these cam faces 1142a and 1142b form the cam profile of the first cam 1142.

The pair of first cam followers 1144 is a pair of rotation rollers, each being supported rotatably around a center axis extending in the vertical direction at the bottom of the first output section 1120. The pair of first cam followers 1144 abut against the cam faces 1142a and 1142b, sandwiching the first cam 1142 between them. The circumferential surface of each of the first cam followers 1144 is in constant contact with the cam faces 1142a and 1142b and the spacing between the first cam followers 1144 is adjusted such that the first cam followers 1144 can roll on the cam faces 1142a and 1142b.

To explain the operation example of the first oscillation imparting unit 1100 with this configuration, first, the first cam 1142 rotates integrally with the input shaft 1110 as the input shaft 1110 rotates. The pair of first cam followers 1144 rolls on the cam faces 1142a and 1142b of the rotating first cam 1142 while maintaining a state of contact with the cam faces 1142a and 1142b. In this situation, as noted above, since the cam faces 1142a and 1142b are curved in the axial direction of the input shaft 1110, the rolling pair of first cam followers 1144 reciprocates back and forth in the axial direction as the contact position between the circumferential surface of each of the first cam followers 1144 and the cam faces 1142a and 1142b changes. Thus, the first output section 1120 supporting the pair of first cam followers 1144 reciprocates in the axial direction while the movement in the width direction of the first output section 1120 is restricted by the guide members 1150. As a result, the oscillation plate 1010 fastened to the first output section 1120 oscillates in the direction in which it extends in the axial direction, that is, in the transport direction, integrally with the first output section 1120.

Through this operation, the first oscillation imparting unit 1100 imparts an oscillation in the transport direction on the oscillation plate 1010. It should be noted that the movement distance in the axial direction of the first output section 1120 (in other words, the movement stroke in the axial direction of the pair of first cam followers 1144) corresponds to the amplitude of the oscillations in the transport direction that is imparted by the first oscillation imparting unit 1100.

The Second Oscillation Imparting Unit

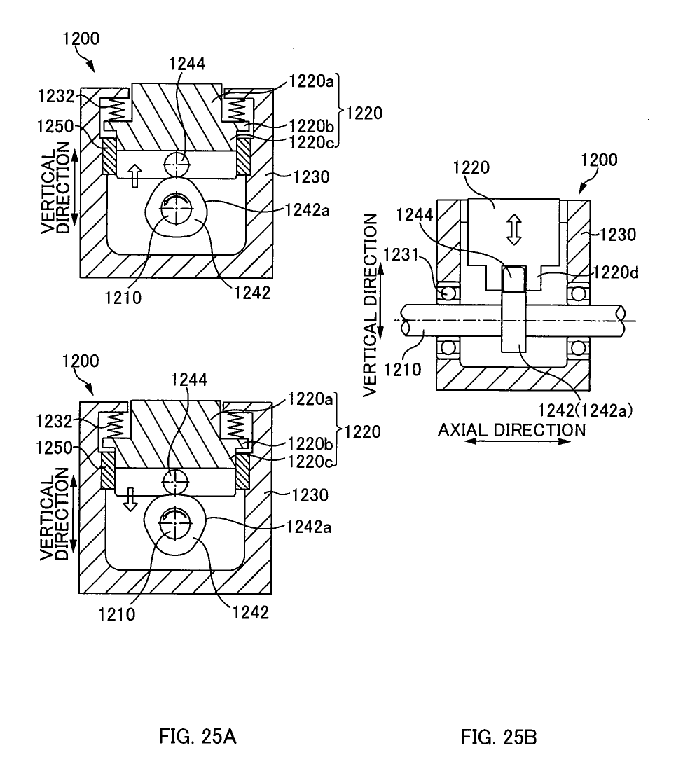

Referring to the above-mentioned FIG. 23 and FIG. 25, an explanation of a configuration example and an operation example of the second oscillation imparting unit 1200 will follow. In FIG. 25, diagrams show the internal structure of the second oscillation imparting unit 1200, namely schematic cross-sectional views (FIG. 25A) of the middle in the length direction (direction extending along the transport direction) of the second oscillation imparting unit 1200, and a schematic cross-sectional view (FIG. 25B) of the middle in the width direction (direction intersecting the transport direction and extending along the transverse direction of the placement surface 1011) of the second oscillation imparting unit 1200. FIG. 25A shows a diagram of the situation when the second output section 1220 moving up and down in the vertical direction has reached the upper dead center (upper diagram), and of the situation when it has reached the lower dead center (lower diagram). In FIG. 25A, arrows indicate the vertical direction, and in FIG. 25B, arrows indicate the vertical direction and the axial direction of the input shaft 1210.

Similar to the first oscillation imparting unit 1100, the second oscillation imparting unit 1200 is also arranged below the oscillation plate 1010, and is provided with a cam mechanism (that is, the later-described second cam mechanism 1240) inside. Furthermore, through this cam mechanism, the second oscillation imparting unit 1200 imparts an oscillation in the vertical direction from below the oscillation plate 1010 to the oscillation plate 1010. It should be noted that as shown in the upper diagram of FIG. 23, the product transport apparatus 1001 of the present embodiment is provided with three second oscillation imparting units 1200. And as shown in FIG. 23, in the present embodiment, the second oscillation imparting units 1200 impart an oscillation in the vertical direction on the end portion of the oscillation plate 1010 in at least one direction of the longitudinal direction and the transverse direction of the placement surface 1011. More specifically, second oscillation imparting units 1200 are arranged at the position at one end portion in the longitudinal direction and at one end portion in the transverse direction of the placement surface 1011, at the position at one end portion in the longitudinal direction and at the other end portion in the transverse direction of the placement surface 1011, and at the position at the other end portion in the longitudinal direction and at the middle in the transverse direction of the placement surface 1011. That is to say, the second oscillation imparting units 1200 are arranged at positions that corresponds to either a longitudinal direction end portion or a transverse direction end portion of the placement surface 1011 or at a position corresponding to both. The second oscillation imparting units 1200 impart an oscillation in the vertical direction on the oscillation plate 1010 at each of those positions.

Among the three second oscillation imparting units 1200, there is a second oscillation imparting unit 1200 that imparts an oscillation to the oscillation plate 1010 at a position that is different from those of the other second oscillation imparting units 1200 in the longitudinal direction of the placement surface 1011 (in other words, the positions of each of the second oscillation imparting units 1200 are not aligned with respect to the longitudinal direction). Moreover, among the three oscillation imparting units 1200, there are second oscillation imparting units 1200 that impart an oscillation to the oscillation plate 1010 at positions that are different from those of the other second oscillation imparting unit 1200 in the transverse direction of the placement surface 1011 (in other words, the positions of the second oscillation imparting units 1200 are not aligned with respect to the transverse direction).

As shown in FIG. 25, each second oscillation imparting unit 1200 includes an input shaft 1210, a second output section 1220, a housing 1230, a second cam mechanism 1240, and guide members 1250. Moreover, the configuration of these structural components of the various second oscillation imparting units 1200 is the same for all of the second oscillation imparting units 1200.

The housing 1230 is a substantially box-shaped casing containing the later-described second cam mechanism 1240 and the like inside, and is fastened onto the base member 1020. Moreover, a substantially rectangular opening is provided in the ceiling wall of the housing 1230, as in the housing 1130 of the first oscillation imparting unit 1100.

The input shaft 1210 is a shaft that rotates around its center axis, in order to drive the second cam mechanism 1240. Like the input shaft 1110 of the first oscillation imparting unit 1100, the input shaft 1210 passes through the side walls of the housing 1230 and is supported rotatably by the housing 1230 through bearings 1231. The axial direction of the input shaft 1210 coincides with the length direction of the second oscillation imparting unit 1200, that is, the transport direction. In the present embodiment, when the drive motor 1300 is started and the input shaft 1110 of the first oscillation imparting unit 1100 rotates, the input shaft 1210 of the second oscillation imparting unit 1200 rotates by being linked to the input shaft 1110 of the first oscillation imparting unit 1100. More specifically, as shown in the upper diagram in FIG. 23, the input shafts 1210 of two of the three second oscillation imparting units 1200 are provided with pulleys 1304a. These pulleys 1304a form pairs with pulleys 1304a that are provided on the input shaft 1110 of the first oscillation imparting unit 1100. Moreover, the input shafts 1210 of these two second oscillation imparting units 1200 receive a driving force from belt transmissions 1304 that are constituted by the pairs of pulleys 1304a and belts that are suspended between these pulleys 1304a. On the other hand, the input shaft 1210 of the remaining one of the three second oscillation imparting units 1200 is coupled via a shaft coupling 1302 to the input shaft 1110 of the first oscillation imparting unit 1100. Thus, the rotation of the input shaft 1110 of the first oscillation imparting unit 1100 is transmitted by the shaft coupling 1302 and the belt transmission 1304 to the input shafts 1210 of each of the second oscillation imparting units 1200.

The second output section 1220 is a member that is placed at a position closing the aperture provided in the ceiling wall of the housing 1130. As shown in FIG. 25A, this second output section 1220 includes an upper step section 1220a having a width that is smaller in the width direction of the second oscillation imparting unit 1200 than that of the aperture, a middle step section 1220b arranged next to the upper step section 1220a that is wider than the upper step section 1220a and the aperture, and a lower step section 1220c that is arranged next to the middle step section 1220b and that is narrower than the middle step section 1220b but wider than the upper step section 1220a. It should be noted that the upper step section 1220a, the middle step section 1220b, and the lower step section 1220c are all substantially rectangular solids and their length in the length direction of the second oscillation imparting unit 1200 is smaller than that of the aperture. Furthermore, the bottom face of the lower step section 1220c includes a support section 1220d for rotatively supporting the later-described second cam follower 1244.

The second output section 1220 is supported such that it can move up and down in the vertical direction (that is, the direction indicated by the arrows in FIG. 25B) within the housing 1230. The second output section 1220 is fastened to and supports the oscillation plate 1010 with its upper side in a state in which the upper side of the second output section 1220 is above the upper end side of the housing 1230. Thus, reciprocating the second output section 1220 back and forth in the vertical direction, the oscillation plate 1010 oscillates in the vertical direction integrally with the second output section 1220. As shown in FIG. 25A, rectangular solid-shaped guide members 1250 are provided at both end sides in the width direction of the second output section 1220 (that is, the width direction of the second oscillation imparting unit 1200). More specifically, the guide members 1250 fill the gaps between the two end faces in the width direction of the second output section 1220 (more precisely, the lower step section 1220c of the second output section 1220) and the inner wall surfaces of the housing 1130. Of the various surfaces of the guide members 1250, the surfaces facing the end faces in the width direction of the second output section 1220 (hereafter referred to as “opposing surfaces”) are flat surfaces with respect to the axial direction and the vertical direction of the input shaft 1210. Moreover, the second output section 1220 moves up and down in the vertical direction along the opposing surfaces. That is to say, the second output section 1220 moves in the vertical direction while its movement in the direction intersecting the axial direction of the input shaft 1210 (that is, the transverse direction of the placement surface 1011) is restricted by the guide members 1250. It should be noted that a film of lubrication oil is formed between the second output section 1220 and the guide members 1250, and the second output section 1220 can move smoothly up and down in the vertical direction.

As shown in FIG. 25A, one end of spring members 1232 are fastened to the step formed between the upper step section 1220a and the middle step section 1220b, and the second output section 1220 is biased downward by these spring members 1232. The other end of the spring members 1232 is fastened to the face of the inner wall of the housing 1230 that opposes the step.

The second cam mechanism 1240 is for letting the second output section 1220 move up and down in the vertical direction. In other words, the second cam mechanism 1240 is for letting the oscillation plate 1010 oscillate in the vertical direction via the second output section 1220. As shown in FIG. 25, the second cam mechanism 1240 includes a second cam 1242 that rotates as the input shaft 1210 rotates, and a second cam follower 1244 that follows the second cam 1242.

The second cam 1242 is a substantially triangular plate cam having a cam face 1242a formed on its outer circumferential surface, and is supported at an axial direction middle section of the input shaft 1210. When the input shaft 1210 is rotated, the second cam 1242 rotates integrally with the input shaft 1210. Moreover, the cam face 1242a of the second cam 1242 has a circumferential surface that is flat with respect to the axial direction of the input shaft 1210, and the shape of this cam face 1242a forms the cam profile of the second cam 1242. As noted above, the configuration of the structural components of each of the second oscillation imparting units 1200 is the same for all of the second oscillation imparting units 1200, so that also the cam profiles of the second cams 1242 are the same for all of the second oscillation imparting units 1200.

The second cam follower 1244 is a rotation roller that is supported rotatively by a support section 1220d of the aforementioned second output section 1220. Its center axis coincides with the axial direction of the input shaft 1210. The biasing force of the spring members 1232 extends through the second output section 1220 to the second cam follower 1244. Therefore, the second cam follower 1244 is urged downward, and is pushed against the second cam 1242 in a state in which it is rotatable around its center axis. That is to say, the circumferential surface of the second cam follower 1244 is in constant contact with the cam face 1242a, and when the second cam 1242 rotates, the second cam follower 1244 follows the second cam 1242 and rolls on the cam face 1242a.

Turning to the operation example of the second oscillation imparting unit 1200 with the above configuration, first, the input shaft 1210 of the second oscillation imparting unit 1200 rotates in cooperation with the rotation of the input shaft 1110 of the first oscillation imparting unit 1100, and also the second cam 1242 rotates integrally with the input shaft 1210. Then, the second cam follower 1244 rolls on the cam face 1242a of the second cam 1242, in a state in which it is pushed by the spring force of the spring member 1232 rotatively against the second cam 1242. In this situation, as mentioned above, since the second cam 1242 has a substantially triangular shape, the second cam follower 1244 in the rolling state moves up and down in the vertical direction, as the position where the circumferential surface of the second cam follower 1244 contacts the cam face 1242a changes. Accordingly, also the second output section 1220 supporting the second cam follower 1244 moves up and down in the vertical direction, while its movement in the width direction of the second output section 1220 is restricted by the guide members 1250. As a result, the oscillation plate 1010 that is fastened to the second output section 1220 also oscillates in the vertical direction.

With the above operation, the second oscillation imparting unit 1200 imparts an oscillation in the vertical direction on the oscillation plate 1010. It should be noted that in FIG. 25A, the spacing between the position (upper dead center) of the second output section 1220 shown in the upper diagram and the position (lower dead center) shown in the lower diagram (in other words, the movement stroke in the vertical direction of the second cam follower 1244) corresponds to the amplitude of the oscillation in the vertical direction imparted by the second oscillation imparting unit 1200. Moreover, the cam profile of the second cam 1242 of each of the second oscillation imparting units 1200 is the same for all second oscillation imparting units 1200, so that also the amplitude of the oscillations in the vertical direction imparted by the second oscillation imparting unit 1200 is the same for all oscillation imparting units 1200.

Drive Motor 1300

The drive motor 1300 is a motor for driving the first oscillation imparting unit 1100 as well as the second oscillation imparting units 1200 (more specifically, it is a motor that rotates the input shaft 1110 of the first oscillation imparting unit 1100 and the input shafts 1210 of each of the second oscillation imparting units 1200). That is to say, in the present embodiment, one first oscillation imparting unit 1100 and three second oscillation imparting units 1200 use the drive motor 1300 as a common driving source.

As noted above, the rotation shaft 1300a of the drive motor 1300 is coupled to the input shaft 1110 of the first oscillation imparting unit 1100 through a shaft coupling 1302. The rotation of the input shaft 1110 of the first oscillation imparting unit 1100 is transmitted via the shaft coupling 1302 and the belt transmissions 1304 to the input shafts 1210 of each of the second oscillation imparting unit 1200. That is to say, in the present embodiment, the driving force from the drive motor 1300 is transmitted by the shaft coupling 1302 and the belt transmissions 1304 to the first oscillation imparting unit 1100 and each of the second oscillation imparting units 1200. Also, each of the pulleys 1304a on each of the input shafts 1110 and 1210 have the same diameters, so that the rotation speed of the input shafts 1110 and 1210 (that is the number of rotations per unit time) is the same. And as noted above, the cam profiles of the second cams 1242 of each of the three second oscillation imparting units 1200 is the same for all second oscillation imparting units 1200, so that also the number of oscillations in the vertical direction that is imparted by the second oscillation imparting units 1200 while the input shaft 1210 rotates once is the same for all second oscillation imparting units 1200. Furthermore, in the present embodiment, each of the cam profiles of the first cam 1142 and the second cam 1242 are adjusted such that the number of oscillations in the transport direction that is imparted by the first oscillation imparting unit 1100 while the input shaft 1110 rotates once is the same as the number of oscillations in the vertical direction that is imparted by each of the second oscillation imparting units 1200 while the input shaft 1210 rotates once. As a result, the number of oscillations in the vertical direction that is imparted from the first oscillation imparting unit 1100 will be the same as the number of oscillations in the vertical direction that is imparted from the second oscillation imparting units 1200. If the number of oscillations is the same for each direction, and the timing at which each of the oscillations are imparted is adjusted such that each of the the oscillations are synchronized, then the oscillation plate 1010 oscillates in the transport direction and the vertical direction such that the products W placed on the placement surface 1011 are transported straight forward in the transport direction. This is because the first oscillation imparting unit 1100 and each of the second oscillation imparting units 1200 are driven by the same drive motor 1300 and the number of oscillations is the same for each direction, so that when the timing at which the oscillations are imparted is adjusted once, thereafter each the oscillations are imparted to the oscillation plate 1010 maintaining a synchronized state. In other words, the drive motor 1300 of the present embodiment can drive the first oscillation imparting unit 1100 and each of the second oscillation imparting units 1200 in synchronization.

It should be noted that in the present embodiment, the number of oscillations in the transport direction that are imparted by the first oscillation imparting unit 1100 while the input shaft 1110 rotates once is the same as the number of oscillations in the vertical direction that are imparted by each of the second oscillation imparting units 1200 while the input shaft 1210 rotates once, but there is no limitation to this. It is also possible that the number of oscillations imparted while the input shafts 1110 and 1210 rotate once is different for the two kinds of oscillation imparting units. In this case, by adjusting the ratio of the diameters of the pairs of pulleys 1304a (that is, the gear reduction ratio), the number of oscillations in the transport direction imparted by the first oscillation imparting unit 1100 can be made the same as the number of oscillations in the vertical direction imparted by each of the second oscillation imparting units 1200. To give a specific example, this is explained for the case that the number of oscillations in the transport direction that are imparted while the input shaft 1110 of the first oscillation imparting unit 1100 rotates once is three and the number of oscillations in the vertical direction that are imparted while the input shaft 1210 of each of the second oscillation imparting units 1200 rotates once is four. In this case, the diameter of the pulleys 1304a provided on the side of the input shaft 1110 of the first oscillation imparting unit 1100 should be designed to be ¾ the diameter of the pulleys 1304a provided on the side of the input shafts 1210 of the two second oscillation imparting units 1200 (the second oscillation imparting units 1200 arranged at the one end side in the longitudinal direction of the placement surface 11 in the upper diagram in FIG. 23). Thus the number of oscillations in the transport direction can be made the same as the number of oscillations in the vertical direction.

Operation Example of Product Transport Apparatus

An explanation of an operation example of the product transport apparatus 1001 configured as described above will follow.

First, when the drive motor 1300 is started with the products W placed at a predetermined position on the placement surface 1011 of the oscillation plate 1010, the input shaft 1110 of the first oscillation imparting unit 1100 and the input shafts 1210 of the second oscillation imparting units 1200 rotate with the same rotation speed. As the input shafts 1110 and 1210 rotate, the first output section 1120 in the first oscillation imparting unit 1100 reciprocates back and forth in the transport direction brought about by the driving of the first cam mechanism 1140, and the second output sections 1220 in the second oscillation imparting units 1200 move up and down in the vertical direction due to the driving of the second cam mechanism 1240. As a result, an oscillation in the transport direction and an oscillation in the vertical direction are both imparted on the oscillation plate 1010 fastened to and supported by the first output section 1120 and the second output sections 1220. In this situation, the oscillation numbers and the amplitudes of the oscillations in the vertical direction that are imparted by each of the three second oscillation imparting units 1200 are the same for all second oscillation imparting units 1200. Moreover, the oscillation number of the oscillations in the transport direction that are imparted by the first oscillation imparting unit 1100 is the same as the oscillation number of the oscillations in the vertical direction that are imparted by each of the second oscillation imparting units 1200. Therefore, as noted above, when the timing at which each of the oscillations are imparted is adjusted once, the subsequent oscillations are imparted in a synchronized state to the oscillation plate 1010. As a result, the oscillation plate 1010 oscillates in the transport direction and the vertical direction (more precisely, it performs an elliptical motion in a plane that is defined by the transport direction and the vertical direction). Moreover, the products W on the placement surface 1011 of the oscillation plate 1010 undergo relative slipping with respect to the oscillation plate 1010 owing to this oscillation of the oscillation plate 1010 (that is, the elliptical motion of the oscillation plate 1010), and the products W are transported linearly in the transport direction due to this phenomenon of relative slipping.

(2) Advantageous Effects of the Product Transport Apparatus According to the Present Embodiment

As described above, the product transport apparatus 1001 according to the present embodiment includes an oscillation plate 1010 that oscillates in the transport direction and in the vertical direction in order to linearly transport a product W, at least one first oscillation imparting unit 1100 that imparts an oscillation in the transport direction on the oscillation plate 1010 through a first cam mechanism 1140, and at least three second oscillation imparting units 1200 that impart an oscillation in the vertical direction on the oscillation plate 1010 through a second cam mechanism 1240. With such a product transport apparatus, oscillation irregularities in the oscillation plate 1010 are prevented and it becomes possible to properly transport the product. An explanation of the advantageous effects of the product transport apparatus 1001 of the present embodiment will follow.

Conventionally, product transport apparatuses are known that have an oscillation plate that oscillates in the transport direction and the vertical direction in order to linearly transport the products W, and that transport the products W by using the phenomenon of relative slipping of the products W with respect to the oscillation plate 1010. Moreover, product transport apparatuses are known that include a flat plate having a wide placement surface as the oscillation plate. With such a product transport apparatus, it is possible to place a large amount of the products W on the placement surface of the oscillation plate, so that it becomes possible to transport a large amount of the products W at the same time. That is to say, the larger the surface area of placement surface is made, the more the product transport capability of the product transport apparatus improves (the amount of products W transported per unit time).

However, the larger the surface area of placement surface is made, the more difficult it becomes to achieve a suitable oscillation of the oscillation plate. More specifically, the oscillations imparted on the oscillation plate tend to attenuate while being transmitted to the various portions of the oscillation plate. Particularly the oscillations in the vertical direction attenuate easily, and they tend to be transmitted inproperly the further the position from the position where the oscillations in the vertical direction are imparted. Therefore, if only one oscillation device (for example, an oscillating feeder such as a linear feeder) imparting oscillations in the vertical direction and the transport direction on the oscillation plate is used in the product transport apparatus, a sufficient surface area where this device contacts the oscillation plate in order to impart oscillations (hereinafter referred to as “contact area”) cannot be ensured with respect to the surface area of the placement surface, so that there is the risk that the oscillations are not properly transmitted to portions of the oscillation plate that are further away from the position of contact with the oscillation device. As a result, the phenomenon that there are portions where the oscillations are properly transmitted and portions where the oscillations are inproperly transmitted occurs within the oscillation plate, that is, so-called oscillation irregularities occur, and it was difficult to linearly transport the products W properly.

By contrast, the product transport apparatus 1001 according to the present embodiment is provided with at least three (in the present embodiment exactly three) second oscillation imparting units 1200 that impart easily attenuating vertical direction oscillations, and the oscillations in the vertical direction are properly transmitted over a wide area of the oscillation plate 1010. Thus, even when an oscillation plate 1010 having a broad placement surface 1011 is provided, oscillation irregularities are prevented and the products W can be linearly transported properly.

(2) Modified example of the Product Transport Apparatus

In the above explanations, a product transport apparatus was explained that includes one first oscillation imparting unit 1100 and three second oscillation imparting units 1200 (hereafter referred to as “main example”), but the numbers of the first oscillation imparting units 1100 and the second oscillation imparting units 1200 are not limited to these numbers.

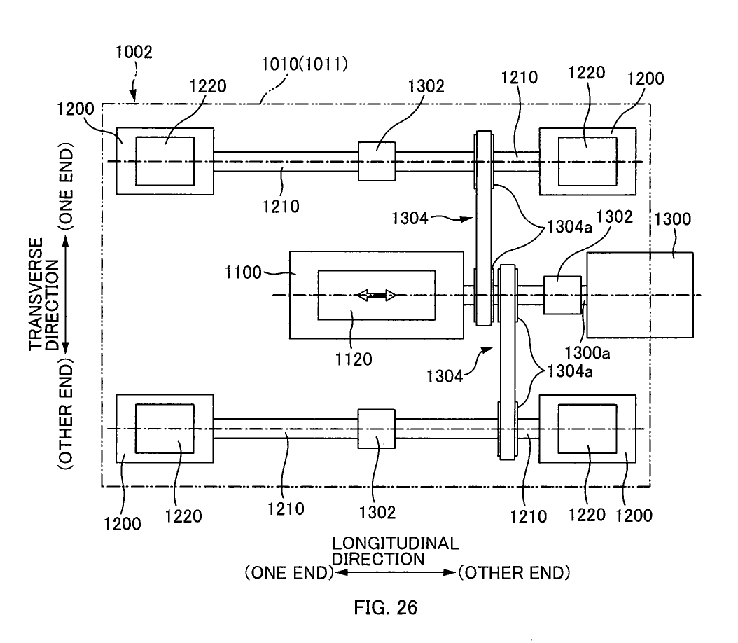

More specifically, it is sufficient if at least three second oscillation imparting units 1200 are provided and it is also possible to provide four second oscillation imparting units 1200 (hereafter referred to as “first modified example”), as shown in FIG. 26. FIG. 26 is a diagram schematically showing the layout of a product transport apparatus 1002 according to the first modified example as seen from above. In FIG. 26, the arrows indicate the longitudinal direction and the transverse direction of the placement surface 1011 of the oscillation plate 1010. The following is an explanation of the configuration of the product transport apparatus 1002 according to the first modified example. It should be noted that portions of the product transport apparatus 1002 of this first modified example whose configuration is the same as that of the main example are not explained any further.

In this modified example, each of the second oscillation imparting units 1200 are arranged at the corner sections of the oscillation plate 1010, as shown in FIG. 26. In other words, a second output section 1220 of each second oscillation imparting unit 1200 is fastened to and supports each corner section of the oscillation plate 1010. It should be noted that also in this modified example, the cam profiles of the second cams 1242 of each of the four second oscillation imparting units 1200 are the same for all second oscillation imparting units 1200. Therefore, the amplitude and the oscillation number of the oscillations in the vertical direction that are imparted by each of the second oscillation imparting units 1200 are the same for all second oscillation imparting units 1200. Moreover, the oscillation number of the oscillations in the vertical direction that are imparted by the first oscillation imparting unit 1100 is the same as the oscillation number of the oscillations in the vertical direction that are imparted by each of the second oscillation imparting units 1200. Therefore, also in the first modified example, when the timing at which each of the oscillations are imparted is adjusted once, thereafter each of the oscillations are imparted in a synchronized state to the oscillation plate 1010. In other words, the drive motor 1300 of the present embodiment too can drive the first oscillation imparting unit 1100 and each of the second oscillation imparting units 1200 in synchronization.

The more the number of second oscillation imparting units 1200 is increased as above, the more the effect of preventing oscillation irregularities in the oscillation plate 1010 can be improved. Furthermore, when the number of second oscillation imparting units 1200 is increased, the number of locations where the oscillation plate 1010 is supported by the second oscillation imparting units 1200 is increased as well, so that it becomes possible to more effectively suppress the oscillation 1010 from deflecting under its own weight. With regard to this aspect, the product transport apparatus 1002 according to the first modified example is preferable. However, as the number of second oscillation imparting units 1200 increases, the manufacturing costs of the product transport apparatus increase as well, so that considering the costs, the product transport apparatus 1001 according to the main example is preferable.

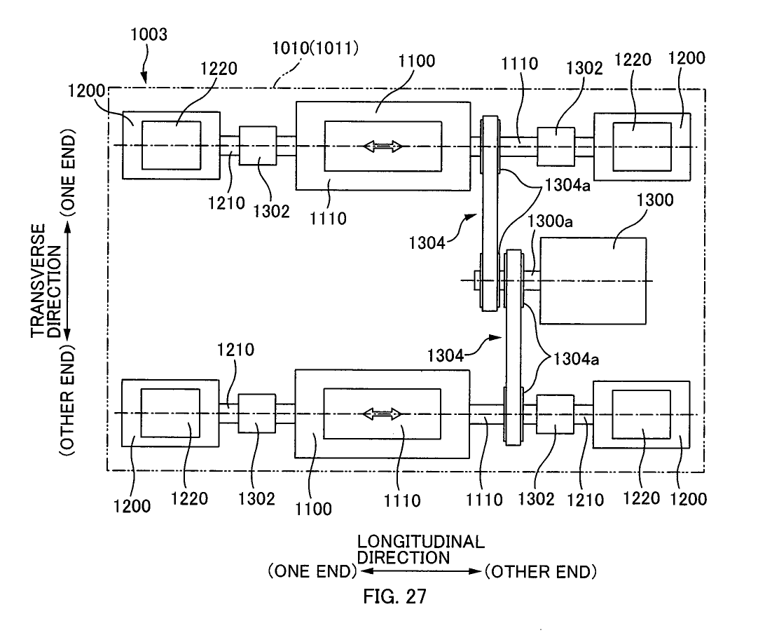

On the other hand, it is sufficient if at least one first oscillation imparting unit 1100 is provided, and it is also possible to provide two first oscillation imparting units 1100 (hereafter referred to as “second modified example”), as shown in FIG. 27, for example. FIG. 27 is a diagram schematically showing a unit layout of a product transport apparatus 1003 according to the second modified example from above. In FIG. 27, the arrows indicate the longitudinal direction and the transverse direction of the placement surface 1011 of the oscillation plate 1010. The following is an explanation of the configuration of the product transport apparatus 1003 according to the second modified example. It should be noted that, as in the first modified example, portions of the product transport apparatus 1003 of this second modified example whose configuration is the same as that of the main example are not explained any further.

In this modified example, each of the first oscillation imparting units 1100 are arranged at the longitudinal center portion of the oscillation plate 1010, at positions at the transverse end portions thereof, as shown in FIG. 27. It should be noted that like in the first modified example, four second oscillation imparting units 1200 are provided, and each of these second oscillation imparting units 1200 are arranged at the corner sections of the oscillation plate 1010. Moreover, the unit components of the first oscillation imparting units 1100 (such as the first cam mechanism 1140, for example) are the same among all first oscillation imparting units 1100. Therefore, the cam profiles of the first cams 1142 of each of the first oscillation imparting units 1100 are the same for all first oscillation imparting units 1100 as well. Therefore, also amplitude and the oscillation number of the oscillations in transport direction that are imparted by the first oscillation imparting units 1100 are the same for all first oscillation imparting units 1100. Moreover, the oscillation number of the oscillations in the vertical direction that are imparted by each of the first oscillation imparting units 1100 is the same as the oscillation number of the oscillations in the vertical direction that are imparted by each of the second oscillation imparting units 1200. Therefore, also in the second modified example, when the timing at which each of the oscillations are imparted is adjusted once, thereafter each of the oscillations are imparted in a synchronized state to the oscillation plate 1010. In other words, the drive motor 1300 of this modified example can also drive the first oscillation imparting units 1100 and each of the second oscillation imparting units 1200 in synchronization.

Thus, also if the number of first oscillation imparting units 1100 is increased, the number of locations where the oscillation plate 1010 is supported by the first oscillation imparting units 1100 increases as well, so that it becomes possible to effectively suppress the occurrence of a deflection of the oscillation plate 1010. Moreover, as the number of first oscillation imparting units 1100 is increased, also the effect of preventing oscillation irregularities in the oscillation plate 1010 is improved (however, there may be a case where oscillations in the transport direction hardly attenuate and therefore one oscillation imparting unit 1100 is sufficient). With regard to this aspect, the product transport apparatus 1003 according to the second modified example is preferable. On the other hand, when the number of first oscillation imparting units 1100 increases, as in the first modified example, the manufacturing cost of the product transport apparatus increases as well, so that considering the costs, the product transport apparatus 1001 according to the main example is preferable.

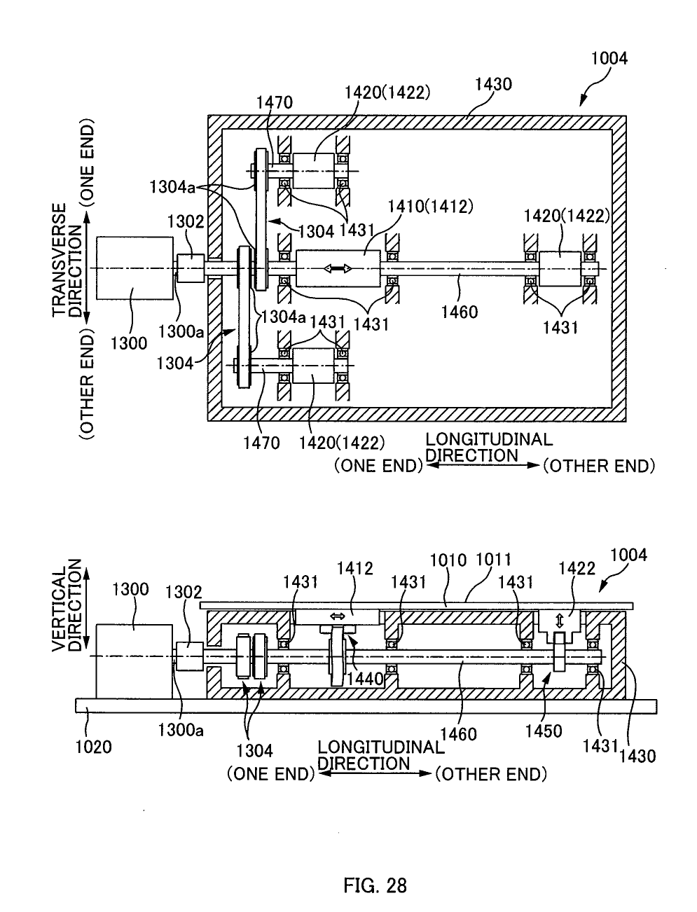

Moreover, the main example was explained for the case that the housings 1130 and 1230 are provided separately for the first oscillation imparting unit 1100 and the second oscillation imparting units 1200. However, there is no limitation to this, and it is also possible that the first oscillation imparting unit and the second oscillation imparting units share the same housing (hereafter referred to as “third modified example”), as shown in FIG. 28. FIG. 28 shows schematic cross-sectional diagrams of the unit layout of a product transport apparatus 1004 according to the third modified example, and shows the unit layout in a cross-sectional view taken from the top surface (upper diagram) and the layout in a cross-sectional view taken from the side surface (lower diagram). Moreover, in the upper diagram in FIG. 28, the arrows denote the longitudinal direction and the transverse direction of a placement surface 1011, and in the lower diagram in FIG. 28, the arrows denote the longitudinal direction and the vertical direction of the placement surface 1011. The following is an explanation of the configuration of the product transport apparatus 1004 according to this third modified example. It should be noted that portions of the product transport apparatus 1004 of this third modified example whose configuration is the same as that of the main example are not explained any further.

As shown in FIG. 28, in this modified example, the first oscillation imparting unit and the second oscillation imparting units (hereafter referred to as the first oscillation imparting unit 1410 of the third modified example and the second oscillation imparting units 1420 of the third modified example) are not arranged in separate housings, but are arranged in a single housing (hereafter referred to as housing 1430 of the third modified example). That is to say, the first cam mechanism 1440 and the second cam mechanisms 1450 are both contained within the housing 1430 of the third modified example. Moreover, in this third modified example, a common shaft 1460 is provided as a common input shaft for the first cam mechanism 1440 and the second cam mechanism 1450 of one of the second oscillation imparting units 1420 of the third modified example (the second oscillation imparting unit 1420 of the third modified example that is placed at the other end portion in the longitudinal direction of the placement surface 1011 in the upper diagram of FIG. 28), as shown in FIG. 28. This common shaft 1460 is coupled via a shaft coupling 1302 to the rotation shaft 1300a of the drive motor 1300. The other two second oscillation imparting units 1420 of the third modified example are each provided with a separate input shaft 1470, and the rotation of the common shaft 1460 is transmitted to these input shafts 1470 through belt transmissions 1304. It should be noted that the common shaft 1460 and the input shafts 1470 are supported by the housing 1430 of the third modified example through bearings 1431. Furthermore, apertures are provided at portions of the housing 1430 of the third modified example that are positioned above the first cam mechanism 1440 and the second cam mechanisms 1450. A first output section 1412 of the first oscillation imparting unit 1410 of the third modified example and second output sections 1422 of the second oscillation imparting units 1420 of the third modified example are provided, shutting these apertures.

Thus, a configuration that is advantageous with regard to costs is achieved when a common housing instead of a separate housing for each of the oscillation imparting units is provided. With regard to this aspect, the product transport apparatus 1004 of this third modified example is preferable. However, if separate housings are provided, it is easy to adjust the arrangement of the first oscillation imparting unit and the second oscillation imparting units. With regard to this aspect, the product transport apparatus 1001 of the main example is preferable.

### (2) Other Embodiments

In the foregoing, the product transport apparatus according to the present invention was explained by way of the above-described second embodiment, but the above-described second embodiment of the invention is merely for the purpose of a clear understanding of the present invention and is not to be interpreted as limiting the present invention. The invention can of course be altered and improved without departing from the gist thereof and includes functional equivalents.

Furthermore, in the second embodiment above, the oscillation plate 1010 is supported such that the placement surface 1011 of the oscillation plate 1010 substantially lies in the horizontal plane, but for example, it may also be supported such that the placement surface 1011 has an inclined surface. In this case, the oscillation plate 1010 is oscillated in the transport direction (the inclination direction of the placement surface 1011) and the direction that intersects the inclined placement surface 1011.

In the second embodiment above, the products W on the placement surface 1011 of the oscillation plate 1010 were transported linearly in the transport direction by the oscillation plate 1010 oscillating. The direction in which the products W are transported may always be constant. Alternatively, it is also possible to provide a regulation member (not shown) for regulating the transport direction of the products W on the placement surface 1011, such that when the products W that are transported linearly on the placement surface 1011 hit the regulation member, the products W are transported in a direction regulated by the regulation member. That is to say, it is also possible to change the direction in which the products W are transported through collision with the regulation member.

In the second embodiment, the transport direction of the products W was set to the longitudinal direction of the placement surface 1011, but there is no limitation to this, and it is also possible to set it to the transverse direction of the placement surface 1011. Furthermore, the transport direction may also be set to neither the longitudinal direction nor the transverse direction of the placement surface 1011 and may also be set to the diagonal direction of the placement surface 1011, for example. However, if the transport direction is the longitudinal direction or the transverse direction of the placement surface, then a product transport apparatus with greater versatility is realized. More specifically, if the transport direction is the diagonal direction, then the end positions reached by the products W moving over the placement surface 1011 are spread out wide, so that a wider collection space for collecting the products W that have been transported needs to be ensured. By contrast, if the transport direction is in the longitudinal direction (or the transverse direction) of the placement surface 1011, then the positions reached by the products W moving over the placement surface 1011 are limited to the longitudinal end portions (or transverse end portions) of the placement surface 1011, so that compared to the case when the transport direction is the diagonal direction, it is not necessary to ensure a wide collection space. With regard to this aspect, the above-described embodiment is more preferable.

Moreover, in the second embodiment, among the at least three second oscillation imparting units 1200, a second oscillation imparting unit 1200 was provided that imparts oscillations on the oscillation plate 1010 at a position in the longitudinal direction of the placement surface 1011 that is different from that of the other second oscillation imparting units 1200. Furthermore, among the at least three second oscillation imparting units 1200, a second oscillation imparting unit 1200 was provided that imparts oscillations on the oscillation plate 1010 at a position in the transverse direction of the placement surface 1011, which is different from that of the other second oscillation imparting units 1200. However, there is no limitation to this, and for example, it is also possible to arrange all second oscillation imparting units 1200 at the same position in the longitudinal direction or the transverse direction of the placement surface 1011. However, with the second embodiment, the transmission range of the oscillations imparted by the at least three second oscillation imparting units 1200 (that is, the oscillations in the vertical direction) is broadened, so that as a result, also the effect of preventing oscillation irregularities of the oscillation plate is improved. Thus, it becomes possible to linearly transport the products W more properly. With regard to this aspect, the second embodiment is preferable.

Moreover, in the second embodiment, each of the at least three or more second oscillation imparting units 1200 imparts oscillations on the end portion of the oscillation plate 1010 in at least one of the longitudinal direction and the transverse directions of the placement surface 1011, but there is no limitation to this. For example, it is also possible that among the at least three second oscillation imparting units 1200, there is a second oscillation imparting unit 1200 imparting oscillations on the oscillation plate 1010 at a position at the longitudinal center portion and the transverse center portion of the placement surface 1011. However, with the above-described second embodiment, the transmission range of the oscillations imparted by the at least three second oscillation imparting units 1200 is broadened, and the effect of preventing oscillation irregularities of the oscillation plate 1010 is increased, so that as a result, it becomes possible to linearly transport the products W even more properly. With regard to this aspect, the above-described second embodiment is preferable.

Moreover, in the second embodiment, only a single drive motor 1300 for driving the first oscillation imparting unit 1100 and the second oscillation imparting units 1200 was provided, but there is no limitation to this. For example, it is also possible to provide a drive motor for each of the oscillation imparting units, with each of these drive motors being servo-controlled. However, with the second embodiment, it is easier to drive the first oscillation imparting unit 1100 and the second oscillation imparting units 1200 in a synchronized state. Moreover, for example, to adjust the transport speed of the products W on the placement surface 1011 (hereafter referred to as “product transport speed”), it is sufficient to adjust the rotation speed of the rotation shaft 1300a of the drive motor 1300, and it is easy to adjust this product transport speed. Moreover, shifts in the timing by which the oscillations are applied occur less, and the adverse influence on the transport of the products such as rattling of the oscillation plate 1010 due to applying timing shifts are prevented. As a result, it becomes possible to linearly transport the products W even more properly, so that with regard to this aspect, the second embodiment is preferable.

Also, the oscillation plate 1010 is fastened to and supported by the first output section 1120 and the second output sections 1220, the first cam mechanism 1140 oscillates the first output section 1120 and the oscillation plate 1010 integrally in the transport direction, and the second cam mechanisms 1240 oscillate the second output sections 1220 and the oscillation plate 1010 integrally in the vertical direction. However, there is no limitation to this, and it is also possible that the oscillation plate 1010 is not fastened to the first output section 1120 and the second output sections 1220, but placed on the upper surface of the first output section 1120 and the upper side of the second output sections 1220. However, in the second embodiment, the oscillation plate 1010 is fastened to the first output section 1120 and the second output section 1220, so that the first cam mechanism 1140 and the second cam mechanism 1240 can suitably oscillate the oscillation plate 1010 through the first output section 1120 and the second output sections 1220. With regard to this aspect, the second embodiment is preferable.

Moreover, in the second embodiment, the cam profile of the first cams 1142 of each of the at least one first oscillation imparting unit 1100 was set to be the same for all first oscillation imparting units 1100. Furthermore, also the cam profile of the second cams 1242 of each of the at least three second oscillation imparting units 1200 was set to be the same for all second oscillation imparting units 1200. However, there is no limitation to this, and it is also possible, for example, that the cam profiles of the first cams 1142 are different among the first oscillation imparting units 1100. Similarly, it is also possible that the cam profiles of the second cams 1242 are different among the second oscillation imparting units 1200. However, with the second embodiment, it is possible to linearly transport the products W more properly. More specifically, the product transport speed at each section of the oscillation plate 1010 (more precisely, the placement surface 1011) depends on the amplitude of the oscillations of the oscillation plate 1010 at each section. Here, if the cam profiles of the first cams 1142 are the same for all of the first oscillation imparting units 1100, then also the amplitudes of the oscillations in the transport direction that are imparted by each of the first oscillation imparting units 1100 are the same for all first oscillation imparting units 1100. Similarly, if the cam profiles of the second cams 1242 are the same for all of the second oscillation imparting units 1200, then also the amplitudes of the oscillations in the vertical direction that are imparted by each of the second oscillation imparting units 1200 are the same for all second oscillation imparting units 1200. As a result, the product transport speed at the various sections of the oscillation plate 1010 becomes uniform, and transport irregularities due to differences in the product transport speed (the phenomenon that the products W on the placement surface 1011 cannot be transported locally in the transport direction) are curbed. Furthermore, also rattling of the oscillation plate 1010 that occurs due to differences in the amplitude of the oscillations in the various directions is curbed. As a result, with regard to the fact that it becomes possible to linearly transport the products W more properly, the second embodiment is preferable.

In the second embodiment, a case was explained in which the number of oscillations in the transport direction imparted by each of the at least one first oscillation imparting units 1100 is the same for all of these first oscillation imparting units 1100, and also the number of oscillations in the vertical direction imparted by each of the at least three second oscillation imparting units 1200 is the same for all of these second oscillation imparting units 1200. Furthermore, the number of oscillations in the transport direction and the number of oscillations in the vertical direction were set to the same number, but there is no limitation to this. For example, the number of oscillations in the transport direction and the number of oscillations in the vertical direction may be different. Moreover, the number of oscillations in the transport direction may be different among the first oscillation imparting units 1100. And the number of oscillations in the vertical direction may be different among the second oscillation imparting units 1200.

However, with the second embodiment, it becomes possible to linearly transport the products W more properly. More specifically, the product transport speed at each of the sections described above depends on the number of oscillations of the oscillation plate 1010 at each of those sections. Therefore, if the oscillation numbers of each of the oscillations imparted by the various sections are the same, then the uniformity of the product transport speed is improved and also transport irregularities are prevented, so that as a result, the products W can be linearly transported even more properly. Furthermore, as noted above, if the numbers of oscillations in the various directions are the same, then, when the timing by which each of these oscillations are applied is adjusted such that the oscillations are synchronized, the oscillation plate 1010 oscillates properly in the transport direction and the vertical direction, such that the products W placed on the placement surface 1011 are linearly transported in the transport direction. With regard to this aspect, the second embodiment is preferable.

### 3. Third Embodiment

(3) Configuration Example of Product Transport Apparatus

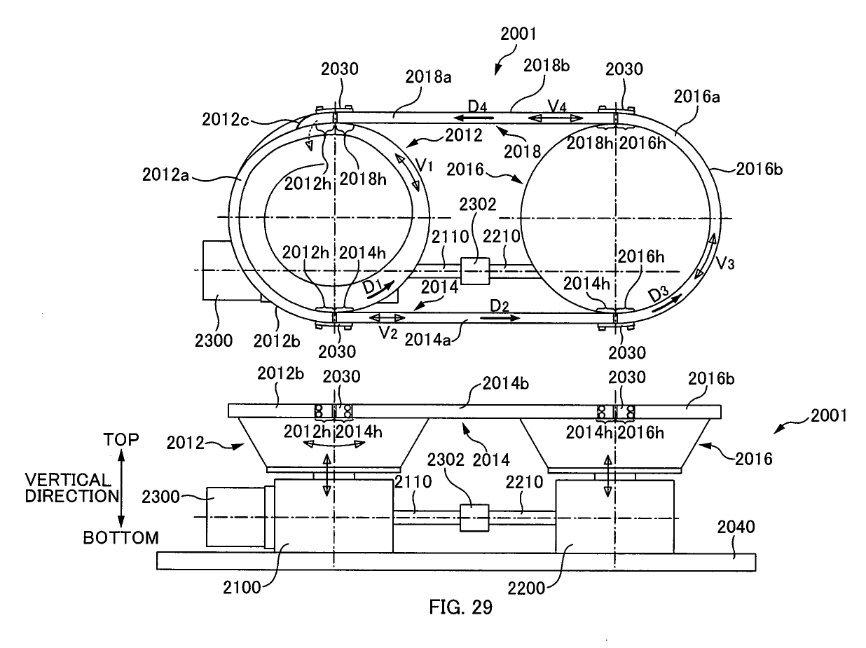

First, an overview of a product transport apparatus 2001 according to the present embodiment is explained with reference to FIG. 29. FIG. 29 shows schematic diagrams of the product transport apparatus 2001 according to the present embodiment, and schematically shows a top view (upper diagram) of the product transport apparatus 2001 and a side view (lower diagram) of the product transport apparatus 2001. In the lower diagram in FIG. 29, the arrows denote the vertical direction.

The product transport apparatus 2001 of the present embodiment includes an oval transport path (also referred to as “oval track”), as shown in FIG. 29, and is an apparatus for transporting products along this oval track. This oval path is formed by a plurality of transport platforms (more specifically, a first transport platform 2012, a second transport platform 2014, a third transport platform 2016, and a fourth transport platform 2018, which are described later). To transport the products, the transport platforms oscillate in the vertical direction and the transport direction of the products on those transport platforms. Moreover, in order to impart oscillations to a specific one of the plurality of transport platforms, the product transport apparatus 2001 of the present embodiment is provided with a first oscillation imparting unit 2100 serving as a “first cam-type oscillation imparting mechanism” and a second oscillation imparting unit 2200 serving as a “second cam-type oscillation imparting mechanism”. These oscillation imparting units are each fastened to a base member 2040 and are each provided inside with a cam mechanism for oscillating the specific transport platform. Moreover, a drive motor 2300 is provided that drives the first oscillation imparting unit 2100 and the second oscillation imparting unit 2200. Furthermore, steel belts 2030 are provided, which are examples of an “oscillation transmitting member” that transmits an oscillation from the transport platforms to which the oscillation has been imparted by the first oscillation imparting unit 2100 or the second oscillation imparting unit 2200 to a transport platform neighboring this transport platform.

With such a product transport apparatus 2001, the products move on each of the transport platforms, such that they are transported along the oval path. Moreover, the products that have moved to the end portion in the transport direction of each of those transport platforms are passed on among the transport platforms to the transport platform on the downstream side, and move on this downstream-side transport platform. Furthermore, in the present embodiment, the oval track forms a closed path, and the products can be subjected to a circulating transport. The following is a more detailed explanation of the various structural elements of this product transport apparatus 2001.

Regarding the Plurality of Transport Platforms

The product transport apparatus 2001 of the present embodiment includes four transport platforms, namely the first transport platform 2012, the second transport platform 2014, the third transport platform 2016, and the fourth transport platform 2018, and these four transport platforms are lined up forming the oval track. Moreover, of these four transport platforms, the first transport platform 2012 and the third transport platform 2016 are bowl-shaped transport platforms that oscillate in a revolving transport direction and the vertical direction, and that transport the products in a revolving transport direction. On the other hand, the second transport platform 2014 and the fourth transport platform 2018 are straight rail-shaped transport platforms that oscillate in a linear transport direction and the vertical direction, and transport the products in the linear transport direction. Moreover, the first transport platform 2012 is provided with a product accepting section (not shown), and the products inserted into this product accepting section are moved in order on each of the first transport platform 2012, the second transport platform 2014, the third transport platform 2016, and the fourth transport platform 2018. As shown in FIG. 29, the transport platforms are provided with placement surfaces 2012a, 2014a, 2016a, and 2018a for placing the products, and with lateral walls 2012b, 2014b, 2016b, and 2018b that are arranged so to intersect the placement surfaces at the end portion in the width direction of the placement surfaces 2012a, 2014a, 2016a, and 2018a. It should be noted that the lateral walls 2012b, 2014b, 2016b, and 2018b extend from the beginning to the end in the transport direction of each of the transport platforms, in order to restrict the transport direction of the products placed on the placement surfaces 2012a, 2014a, 2016a, and 2018a of each of the transport platforms. Furthermore, each of the transport platforms are provided with product transfer sections 2012h, 2014h, 2016h, and 2018h for passing the products from one transport platform to the neighboring transport platform. It should be noted that gaps are formed between each of these product transfer sections, and the products are passed among the product transfer sections by crossing these gaps. The following is a detailed explanation of the configuration of each individual transport platforms.

First Transport Platform

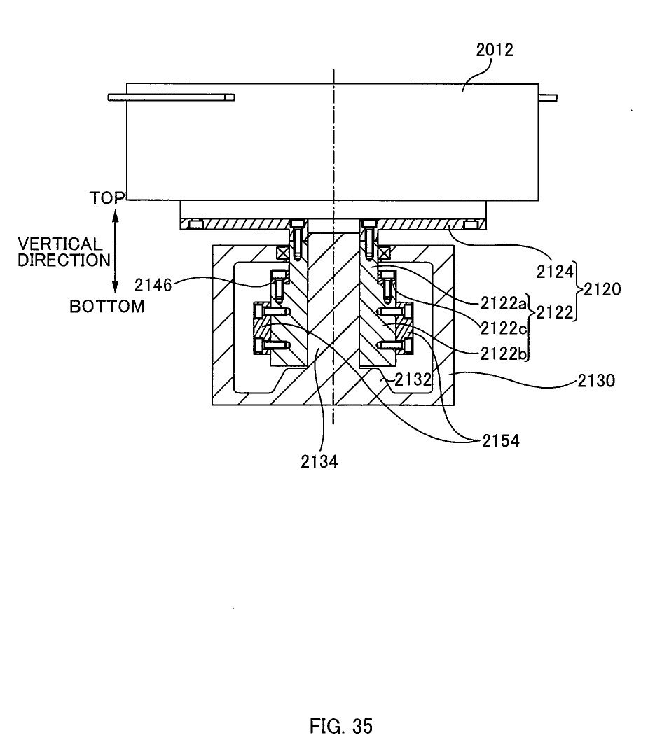

The first transport platform 2012 oscillates in the vertical direction and in the revolving transport direction (more precisely, directions including the revolving transport direction and its opposite direction, marked as V1 in FIG. 29), in order to transport the products on the placement surface 2012a in the revolving transport direction (the direction marked as D1 in FIG. 29). This first transport platform 2012 is fastened to and supported in an oscillatable manner by a first transport platform fixing plate 2124 that is provided on a later-described first oscillation imparting unit 2100 (see FIG. 35). Moreover, the placement surface 2012a of the first transport platform 2012 is a spiral-shaped surface, and the above-noted product accepting section is arranged at a portion that is at the lowest position of the placement surface 2012a (that is, the bottom of the first transport platform 2012). Consequently, when the products have been introduced to the product accepting section, they move on the placement surface 2012a, ascending the spiral-shaped placement surface 2012a when the first transport platform 2012 oscillates in the revolving transport direction and the vertical direction.

Moreover, the products that have reached the end portion in the revolving transport direction of the first transport platform 2012 are passed from the product transfer section 2012h at the end portion to the product transfer section 2014h provided at the beginning portion in the linear transport direction of the second transport platform 2014. As further shown in the upper diagram of FIG. 29, a product transfer section 2012h is also provided at the portion of the first transport platform 2012 that is next to the product transfer section 2018h at the end portion in the linear transport direction of the fourth transport platform 2018. A product returning section 2012c for returning the products to the product accepting section is arranged at the tip of this product transfer section 2012h. Consequently, after the products that have moved on the oval track have been passed from the product transfer section 2018h of the fourth transport platform 2018 (more precisely, the product transfer section 2018h at the end in the linear transport direction) to the product transfer section 2012h of the first transport platform, the movement direction is blocked by the product returning section 2012c (in other words, the products move in the direction indicated by the broken arrows in the upper diagram of FIG. 29). Then, the products fall down to the product accepting section and again move on the oval track.

Second Transport Platform

The second transport platform 2014 oscillates in the vertical direction and in the linear transport direction (more precisely, directions including the linear transport direction and its opposite direction, marked as V2 in FIG. 29), in order to transport the products on the placement surface 2014a in the linear transport direction (the direction marked as D2 in FIG. 29). As shown in FIG. 29, this second transport platform 2014 is placed such that it abuts against the outer circumference of the first transport platform 2012 and the third transport platform 2016. Moreover, the end portions of the second transport platform 2014 in the linear transport direction (that is, the product transfer sections 2014h) are coupled by steel belts 2030 to the first transport platform 2012 and the third transport platform 2016. Therefore, the second transport platform 2014 is supported so that it can oscillate with the first transport platform 2012 and the third transport platform 2016. Moreover, the placement surface 2014a of the second transport platform 2014 is a plane that lies in the horizontal direction, so that products that are passed from the first transport platform 2012 to the second transport platform 2014 are moved in a substantially horizontal direction from the beginning portion to the end portion in the linear transport direction of the second transport platform 2014.

Third Transport Platform

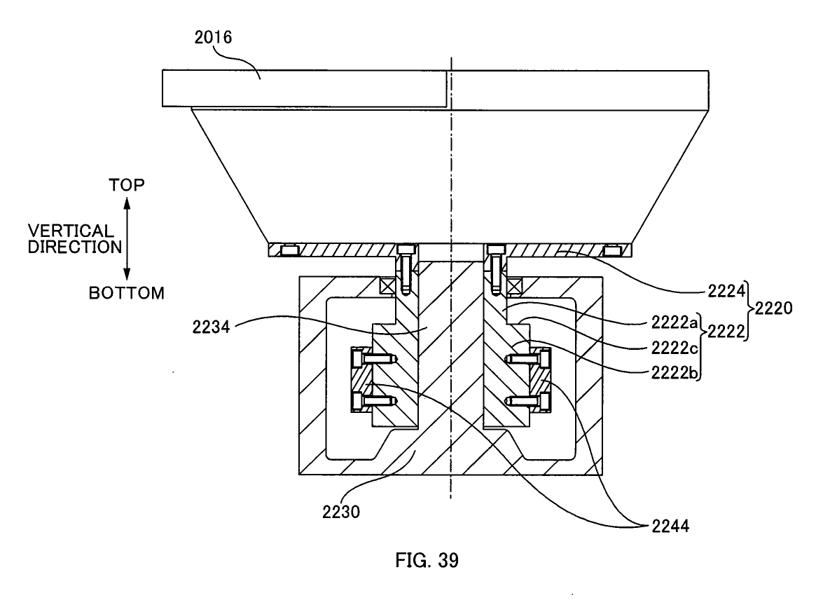

The third transport platform 2016 oscillates in the vertical direction and in the revolving transport direction (more precisely, directions including the revolving transport direction and its opposite direction, marked as V3 in FIG. 29), in order to transport the products on the placement surface 2016a in the revolving transport direction (the direction marked as D3 in FIG. 29). This third transport platform 2016 is fastened to and supported so that it can oscillate with a third transport platform fixing plate 2224 that is provided on a second oscillation imparting unit 2200 (see FIG. 39). As shown in the upper diagram in FIG. 29, the placement surface 2016a of the third transport platform 2016 is in a plane curved into an arc-shape along the outer circumference of the third transport platform 2016 (in other words, the transport path formed by the third transport platform 2016 is curved), and lies in the horizontal plane. Therefore, products passed from the second transport platform 2014 to the third transport platform 2016 are moved substantially in the horizontal direction from the beginning portion to the end portion in the revolving transport direction of the third transport platform 2016.

Fourth Transport Platform

The fourth transport platform 2018 oscillates in the vertical direction and in the linear transport direction (more precisely, directions including the linear transport direction and its opposite direction, marked as V4 in FIG. 29), in order to transport the products on the placement surface 2018a in the linear transport direction (the direction marked as D4 in FIG. 29). Like the second transport platform 2014, the fourth transport platform 2018 is placed such that it abuts against the outer circumference of the first transport platform 2012 and the third transport platform 2016. Moreover, the end portions of the fourth transport platform 2018 in the linear transport direction (that is, the product transfer sections 2018h) are coupled by steel belts 2030 to the first transport platform 2012 and the third transport platform 2016. Therefore, the fourth transport platform 2018 is also supported so that it can oscillate with the first transport platform 2012 and the third transport platform 2016. Like the placement surface 2014a of the second transport platform 2014, the placement surface 2018a of the fourth transport platform 2018 is a plane that lies in the horizontal direction, so that products that are passed from the third transport platform 2016 to the fourth transport platform 2018 are moved in a substantially horizontal direction from the beginning portion to the end portion in the linear transport direction of the fourth transport platform 2018.

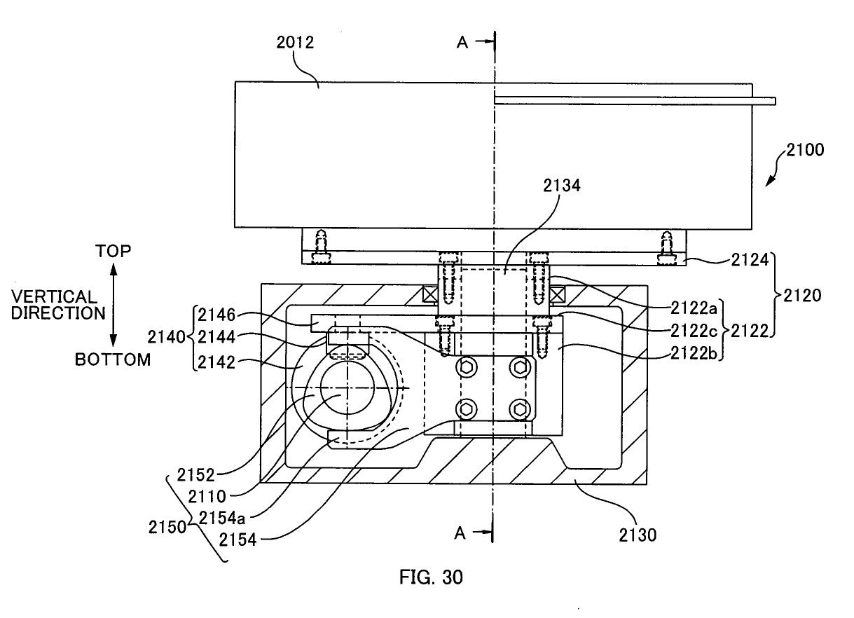

Configuration Example of the First Oscillation Imparting Unit 2100 The following is an explanation of a configuration example of the first oscillation imparting unit 2100 with reference to FIGS. 30 to 35.

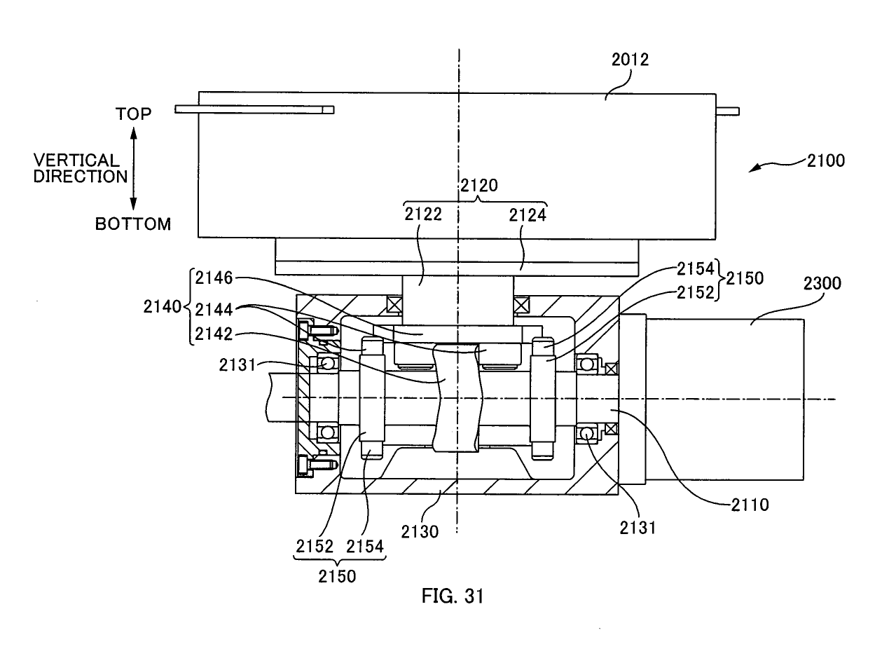

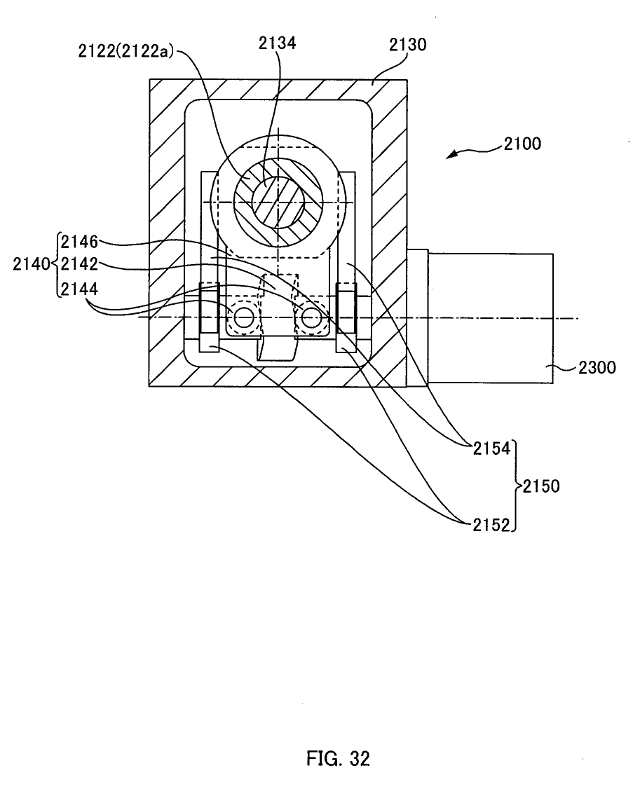

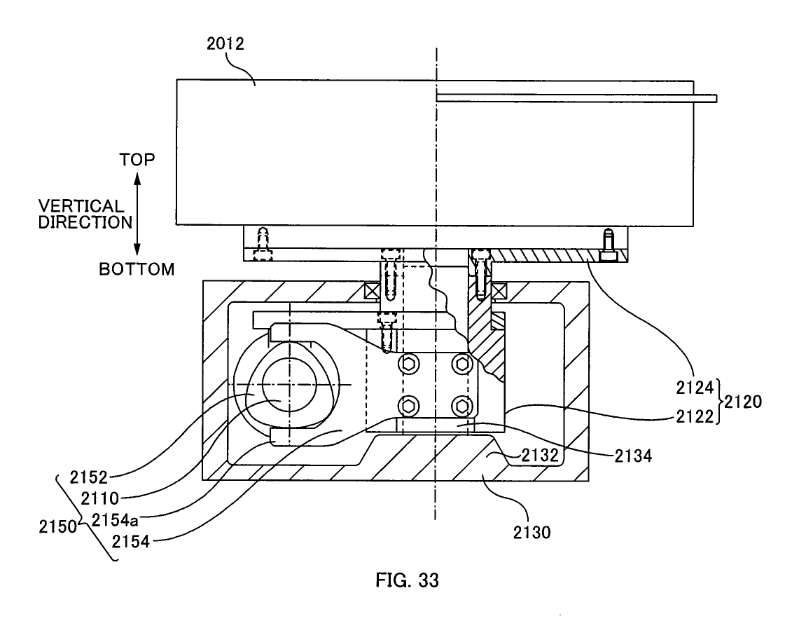

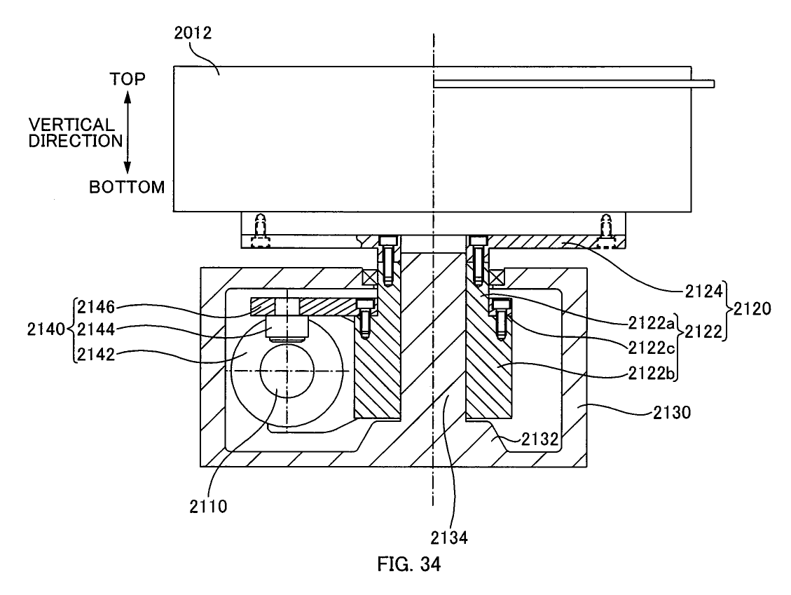

FIGS. 30 to 35 show schematic cross-sectional views of the internal structure of the first oscillation imparting unit 2100. FIGS. 30 to 32 are cross-sectional views showing the main structural components of the first oscillation imparting unit 2100. FIG. 30 is a cross-sectional view of a section that intersects the axial direction of the input shaft 2110. FIG. 31 is a cross-sectional view along A-A in FIG. 30. FIG. 32 is a cross-sectional view of a section that intersects the vertical direction. FIGS. 33 and 34 are cross-sectional views of sections that intersect the axial direction of the input shaft 2110. FIG. 33 is a diagram illustrating the first cam mechanism 2150, and FIG. 34 is a diagram illustrating the second cam mechanism 2140. FIG. 35 is a diagram illustrating the output section 2120. In FIGS. 30, 31, and 33 to 35, arrows indicate the vertical direction of the first oscillation imparting unit 2100.

The first oscillation imparting unit 2100 is arranged below the first oscillation imparting unit 2012, and is a mechanism that imparts oscillations in the revolving transport direction and the vertical direction (oscillations in the directions indicated by the arrows in the lower diagram in FIG. 29) on the first transport platform 2012. As shown by FIGS. 30 and 31, the first oscillation imparting unit 2100 is provided with a housing 2130, an input shaft 2110, an output section 2120, a first cam mechanism 2150, and a second cam mechanism 2140, and as shown in the lower diagram in FIG. 29, the first oscillation imparting unit 2100 is fixed onto a base member 2040. That is to say, the first oscillation imparting unit 2100 imparts oscillations generated by the two cam mechanisms from below the first transport platform 2012 onto this first transport platform 2012. The following is an explanation of the various structural components of the first oscillation imparting unit 2100.

Housing

The housing 2130 is a substantially box-shaped casing for containing therein the first cam mechanism 2150 and the second cam mechanism 2140, which are explained later. The housing 2130 is arranged below the first transport platform 2012. Moreover, a frustum-shaped pedestal section 2132 is arranged on the bottom inside the housing 2130, as shown in FIG. 33. On the center of the pedestal section 2132, a columnar support shaft 2134 extending in the vertical direction is provided. This support shaft 2134 engages a hollow cylindrical turret 2122 , which is explained later, in a way that the support shaft 2134 supports this turret 2122 fitted to it, and the upper end portion of the support shaft 2134 protrudes out of the housing 2130 through the ceiling wall of the housing 2130.

Input Shaft

The input shaft 2110 is supported rotatably by the housing 2130 through bearings 2131 and drives the first cam mechanism 2150 and the second cam mechanism 2140, which are explained later.

The axial direction of the input shaft 2110 coincides with the horizontal direction, and as shown in FIG. 31, one end portion in the axial direction is directly coupled to a drive motor 2300 (which is explained later) that is fastened to the housing 2130. On the other hand, the other axial end portion protrudes out of the housing 2130 and is coupled to an input shaft 2210 of the second oscillation imparting unit 2200 through a shaft coupling 2302, as shown in FIG. 29.

Output Section

The output section 2120 swivels around the support shaft 2134 and reciprocates along the axial direction of the support shaft 2134, in order to let the first oscillation imparting unit 2100 impart oscillations to the first transport platform 2012. As shown in FIG. 35, this output section 2120 includes a hollow cylindrical turret 2122 and a disk-shaped first transport platform attachment plate 2124.

The turret 2122 is supported by the support shaft 2134 in a state in which it can swivel relatively around the support shaft 2134 and can be reciprocated back and forth with respect to the support shaft in the axial direction of the support shaft 2134 (that is, it can move up and down in the vertical direction). As shown in FIG. 35, this turret 2122 includes a small diameter section 2122a and a large diameter section 2122b, which are coaxial hollow cylinders and have different diameters. When the turret 2122 is supported by the support shaft 2134, the small diameter section 2122a is positioned above the large diameter section 2122b. Moreover, the upper end portion of the small diameter section 2122a protrudes out of the housing 2130 through the ceiling wall of the housing 2130. It should be noted that a step 2122c with a ring-shaped surface is formed at the border between the small diameter section 2122a and the large diameter section 2122b. As shown in FIG. 35, a later-described swing arm 2146, is fastened to this step 2122c. Moreover, a lift arm 2154, which is described later, is fastened to the circumferential surface of the large diameter section 2122b.

The first transport platform 2012 is fastened to the upper surface of the first transport platform attachment plate 2124. That is to say, as shown in FIG. 35, the first transport platform 2012 is bolted to the first transport platform attachment plate 2124 abutting against the first transport platform attachment plate 2124. Moreover, the center of the first transport platform attachment plate 2124 is provided with a fitting section for fitting the upper end portion of the support shaft 2134, and as shown in FIG. 35, the upper end portion of the support shaft 2134 is fitted into this fitting section, which is joined with and bolted to the upper end portion of the small diameter section 2122a. As a result, the turret 2122 and the first transport platform attachment plate 2124 (that is, the output section 2120) swivel integrally with the first transport platform 2012 around the support shaft 2134, and reciprocate in the axial direction of the support shaft 2134. Here, the swiveling direction of the turret 2122 and the first transport platform attachment plate 2124 coincides with the revolving transport direction of the first transport platform 2012 (that is, the above-noted direction V1). Consequently, the output section 2120 swivels around the support shaft 2134 and reciprocates in the axial direction of the support shaft 2134, so that oscillations in the revolving transport direction and the vertical direction are imparted on the first transport platform 2012.

First Cam Mechanism

The first cam mechanism 2150 lets the output section 2120 reciprocate back and forth in the axial direction of the support shaft 2134. In other words, the first cam mechanism 2150 imparts oscillations in the vertical direction on the first transport platform 2012. As shown in FIGS. 31 and 33, this first cam mechanism 2150 includes a pair of first cams 2152 and a pair of lift arms 2154.

The two first cams 2152 are substantially triangular plate cams and are cams that are provided to impart oscillations in the vertical direction with the first oscillation imparting unit 2100. Each of the first cams 2152 are supported by the input shaft 2110, at positions further to the outside than the position of the later-described second cam 2142, as shown in FIG. 31. When the input shaft 2110 is rotated, each of the first cams 2152 rotate integrally with the input shaft 2110. Moreover, cam faces are formed on the outer circumferential faces of each of the first cams 2152, and the shape of these cam faces corresponds to the cam profile of the first cams 2152. The two lift arms 2154 are followers of the two first cams 2152, and as shown in FIGS. 32 and 33, the lift arms 2154 are members extending in a direction that intersects the axial direction of the input shaft 2110 and to the axial direction of the support shaft 2134. As shown in FIG. 33, one longitudinal end portion of the lift arms 2154 is provided with the shape of a sideways facing “U”, and engages the first cams 2152. That is to say, the one longitudinal end portion of the lift arms 2154 forms first cam followers 2154a with respect to the first cams 2152 and these first cam followers 2154a are in constant contact with the cam faces of the first cams 2152. On the other hand, the other longitudinal end portion of the lift arms 2154 is fastened to the outer circumferential surface of the large diameter section 2122b of the turret 2122 (see FIG. 35), as noted above.

With the first cam mechanism 2150 configured in such a manner, when the input shaft 2110 rotates, the pair of first cams 2152 rotates integrally with the input shaft 2110. The first cam followers 2154a that are in constant contact with the cam faces of the rotating first cams 2152 reciprocate back and forth in the vertical direction owing to the change in the contact position between the cam faces and the first cam followers 2154a. Accordingly, the lift arms 2154 provided with the first cam followers 2154a also reciprocate in the vertical direction. Thus, by letting the lift arms 2154 reciprocate in the vertical direction, the turret 2122 to which the the lift arms 2154 are fastened, reciprocates in the axial direction of the support shaft 2134. As a result, the output section 2120 oscillates in the vertical direction integrally with the first transport platform 2012. In other words, by letting the lift arms 2154 reciprocate in the vertical direction in accordance with the shape of the cam faces of the first cams 2152 (that is, the cam profiles), the first cam mechanism 2150 imparts oscillations in the vertical direction on the first transport platform 2012 through the output section 2120. It should be noted that the stroke of the movement of the pair of lift arms 2154 in the vertical direction corresponds to the amplitude of the oscillations in the vertical direction imparted by the first cam mechanism 2150.

Second Cam Mechanism

The second cam mechanism 2140 is for letting the output section 2120 swivel around the support shaft 2134. In other words, the second cam mechanism 2140 lets the first transport platform 2012 oscillate in the revolving transport direction. As shown in FIGS. 31 and 34, the second cam mechanism 2140 includes a second cam 2142, a pair of second cam followers 2144, and a swing arm 2146.

The second cam 2142 is a cylindrical rib cam, and is for imparting oscillations in the revolving transport direction with the first oscillation imparting unit 2100. This second cam 2142 is supported at the center portion in the axial direction of the input shaft 2110. When the input shaft 2110 rotates, the second cam 2142 rotates integrally with the input shaft 2110. Moreover, rib-shaped cam faces are formed at both end surfaces in the axial direction of the second cam 2142, and the shape of these cam faces corresponds to the cam profile of the second cam 2142. The two second cam followers 2144 are rollers that rotate around rotation axes extending in the vertical direction, and abut against the cam faces, sandwiching the second cam 2142 between them. The spacing between the second cam followers 2144 is adjusted such that their circumferential faces are in constant contact with the cam faces of the second cam 2142. The swing arm 2146, which has a substantially rectangular shape, serves as a follower of the second cam 2142, and rotatably supports the pair of second cam followers 2144 at its one end portion in the longitudinal direction. Note that, one end portion in the longitudinal direction faces the second cam 2142 at a position that is a predetermined distance apart in the vertical direction from the second cam 2142. The other end portion in a longitudinal direction of the swing arm 2146 includes a fitting hole for fitting the small diameter section 2122a of the turret 2122 to the middle of the other longitudinal end portion. The other longitudinal end portion of the swing arm 2146 is bolted to the step 2122c of the turret 2122 with the small diameter section 2122a being fitted into this fitting hole.

With the second cam mechanism 2140 configured in this manner, when the input shaft 2110 rotates, the second cam 2142 rotates integrally with the input shaft 2110. Moreover, the pair of second cam followers 2144 roll around their rotation axes while constantly contacting the cam faces of the rotating second cams 2142, and swing in a direction along the axial direction of the input shaft 2110 due to the change in the contact position between the cam faces and each of the second cam followers 2144. This swinging motion of the second cam followers 2144 is transmitted to the swing arm 2146 that supports the second cam followers 2144, and as a result, the swing arm 2146 swivels around the support shaft 2134 integrally with the turret 2122. That is, the swinging motion in the direction along the axial direction of the pair of first cam followers 2144 is converted through the swing arm 2146 into a swiveling operation of the turret 2122. As a result, the output section 2120 oscillates in the revolving transport direction integrally with the first transport platform 2012. In other words, by letting the two second cam followers 2144 swing in a direction along the axial direction in accordance with the shape of the cam faces of the second cam 2142 (that is, the cam profiles), the second cam mechanism 2140 imparts oscillations in the revolving transport direction on the first transport platform 2012. It should be noted that the stroke over which the pair of second cam followers 2144 moves in the direction along the axial direction (in other words, the swiveling stroke when the swing arm 2146 swivels around the support shaft 2134) corresponds to the amplitude of the oscillations in the revolving transport direction that is imparted by the second cam mechanism 2140.

The Oscillations Imparted by the First Oscillation Imparting Unit 2100

The following is an explanation of the oscillations imparted by the first oscillation imparting unit 2100 with the above-described structure.

In the first oscillation imparting unit 2100, each of the first cam followers 2154a are in constant contact with the cam faces of the first cams 2152, and also each of the second cam followers 2144 are in constant contact with the cam faces of the second cam 2142. Therefore, the reciprocating operation of the output section 2120 in the vertical direction brought about by the first cam mechanism 2150 and the swiveling operation of the output section 2120 around the support shaft 2134 brought about by the second cam mechanism 2140 do not interfere with each other. As a result, the output section 2120 can perform the reciprocating operation in the vertical direction and the swiveling operation around the support shaft 2134 simultaneously. That is to say, the first transport platform 2012 oscillates in the revolving transport direction and the vertical direction (more precisely, in a compound direction of these two directions) owing to the cooperation of the first cam mechanism 2150 and the second cam mechanism 2140. Moreover, in the present embodiment, the cam profiles of the first cams 2152 and the cam profiles of the second cam 2142 are adjusted such that the number of oscillations in the vertical direction imparted by the first cam mechanism 2150 while the input shaft 2110 rotates once is the same as the number of oscillations in the revolving transport direction imparted by the second cam mechanism 2140. Therefore, if the position where the first cam followers 2154a contact the first cams 2152 and the position where the second cam followers 2144 contact the second cam 2142 are adjusted before the first oscillation imparting unit 2100 is driven, then it becomes possible to drive the first cam mechanism 2150 and the second cam mechanism 2140 in a state of complete synchronization while the first oscillation imparting unit 2100 is operated. As a result, the oscillations in the compound direction are properly imparted on the first transport platform 2012, so that the products on the first transport platform 2012 slip relatively to the first transport platform.

Configuration Example and Operation Example of the Second Oscillation Imparting Unit 2200

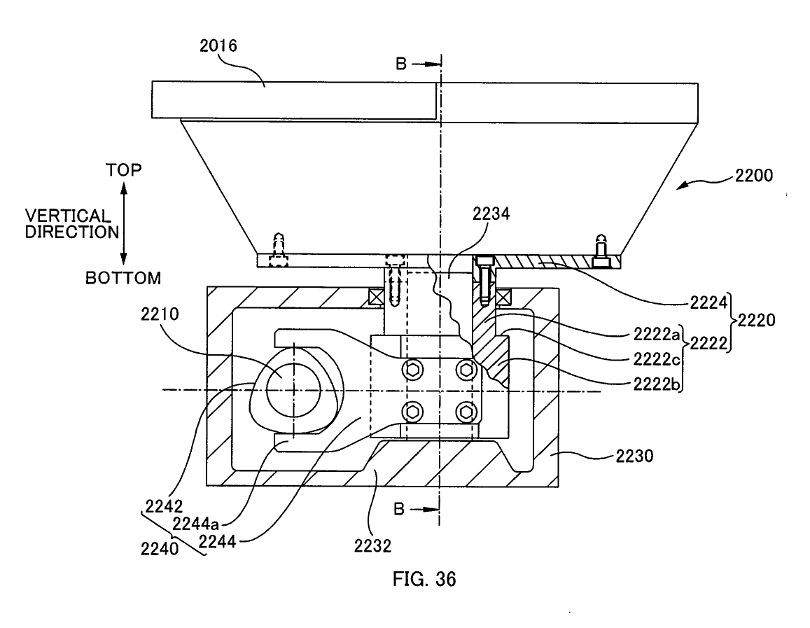

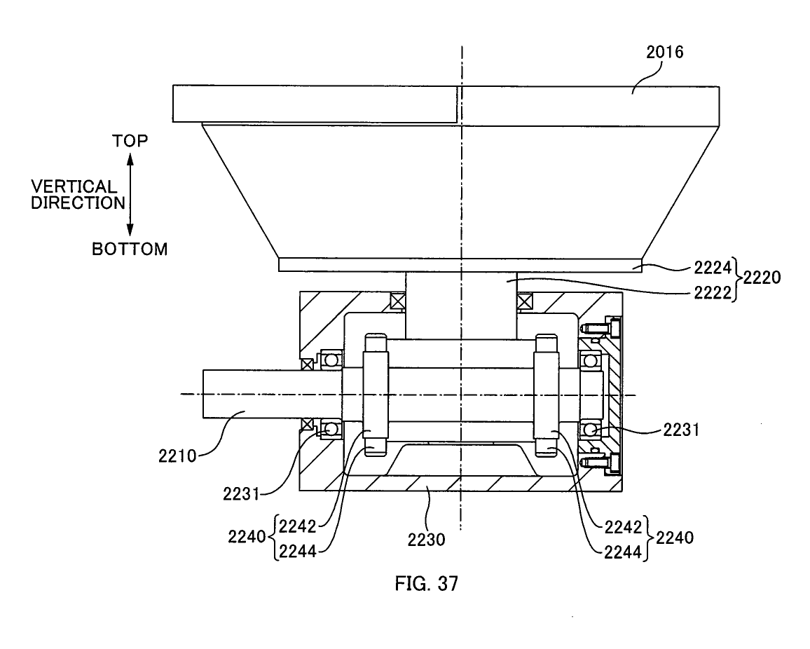

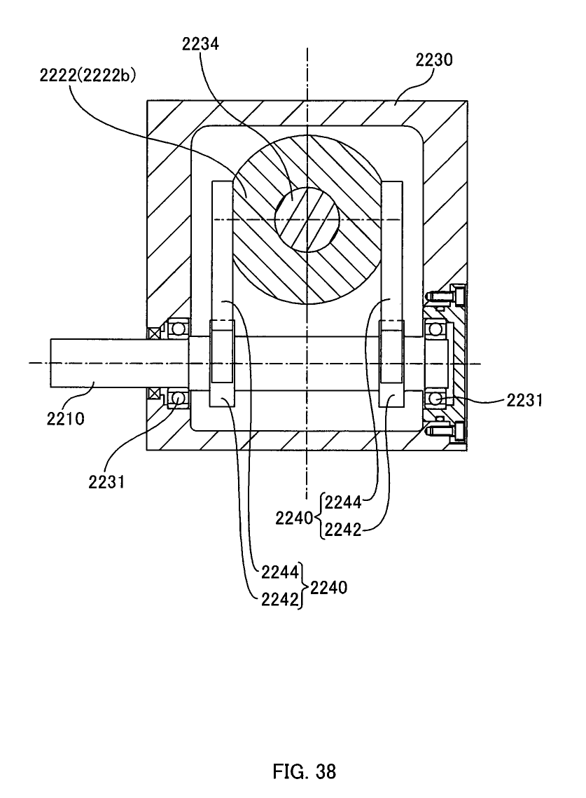

Referring to FIGS. 36 to 39 the following is an explanation of a configuration example and an operation example of the second oscillation imparting unit 2200. FIGS. 36 to 39 are schematic cross-sectional views showing the internal structure of the second oscillation imparting unit 2200. FIGS. 36 to 38 are cross-sectional views showing the main structural components of the second oscillation imparting unit 2200. FIG. 36 is a cross-sectional view of a section that intersects the axial direction of the input shaft 2210. FIG. 37 is a cross-sectional view along B-B in FIG. 36. FIG. 38 is a cross-sectional view of a section that intersects the vertical direction. FIG. 39 is a diagram illustrating the output section 2220. In FIGS. 36, 37, and 39, arrows indicate the vertical direction of the second oscillation imparting unit 2200.

The second oscillation imparting unit 2200 is arranged below the third transport platform 2016, and is a mechanism that imparts oscillations in the vertical direction (oscillations in the directions indicated by the arrows in the lower diagram in FIG. 29) on the third transport platform 2016. As shown by FIGS. 36 and 37, the second oscillation imparting unit 2200 is provided with a housing 2230, an input shaft 2210, an output section 2220, and a first cam mechanism 2240, and is fixed onto the base member 2040. That is to say, the second oscillation imparting unit 2200 imparts oscillations in the vertical direction generated by the first cam mechanism 2240 from below the third transport platform 2016 onto this third transport platform 2016.

As shown in FIGS. 36 to 39, the second oscillation imparting unit 2200 has substantially the same structure as the first oscillation imparting unit 2100, except for the fact that it is not provided with a cam mechanism for imparting oscillations in the revolving transport direction (that is, the second cam mechanism 2140 of the first oscillation imparting unit 2100). Consequently, the above-noted structural components of the second oscillation imparting unit 2200 are substantially the same as those that are also included in the first oscillation imparting unit 2100. For example, the first cam mechanism 2240 of the second oscillation imparting unit 2200 includes first cams 2242 for imparting oscillations in the vertical direction, and a pair of lift arms 2244 provided with first cam followers 2244a engaging the first cams 2242 at one end portion in the longitudinal direction. Moreover, the shape of the cam faces formed on the outer circumferential surface of the first cams 2242 (that is, the cam profile of the first cams 2242) is the same as the cam profile of the first cams 2152 with which the first oscillation imparting unit 2100 is provided. Therefore, the amplitude of the oscillation in the vertical direction that is imparted by the second oscillation imparting unit 2200 (that is, the movement stroke of the pair of lift arms 2244 in the vertical direction) is the same as the oscillation in the vertical direction that is imparted by the first oscillation imparting unit 2100.

As shown in FIG. 37, one end portion in the axial direction of the input shaft 2210 of the second oscillation imparting unit 2200 protrudes out of the housing 2230, and as noted above, is coupled via a shaft coupling 2302 to the input shaft 2110 of the first oscillation imparting unit 2100. Therefore, when the drive motor 2300 is started, the two input shafts 2110 and 2210 rotate simultaneously and with the same rotation speed.

The following is an explanation of the oscillations imparted by the second oscillation imparting unit 2200 with the above-described structure. The first cam mechanism 2240 lets the output section 2220 (the turret 2222 and the third transport platform attachment plate 2224) reciprocate in the vertical direction, so that the second oscillation imparting unit 2200 imparts oscillations in the vertical direction on the third transport platform 2016. As noted above, the cam profiles of the first cams 2242 with which the second oscillation imparting unit 2200 is provided are the same as the cam profiles of the first cams 2242 with which the first oscillation imparting unit 2100 is provided. Moreover, the input shaft 2110 of the first oscillation imparting unit 2100 rotates simultaneously and with the same rotation speed as the input shaft 2210 of the second oscillation imparting unit 2200. Thus, the number of oscillations imparted by the first oscillation imparting unit 2100 is the same as the number of oscillations imparted by the second oscillation imparting unit 2200. Consequently, if the timing at which the oscillations in the vertical direction are imparted by the first cam mechanism 2240 is adjusted before the driving of the second oscillation imparting unit 2200, then the timing at which the first oscillation imparting unit 2100 imparts oscillations is completely synchronized with the timing at which the second oscillation imparting unit 2200 imparts oscillations. That is to say, the first transport platform 2012 and the third transport 2016 oscillate in the vertical direction in a synchronized state. Furthermore, the amplitude of the oscillations in the vertical direction imparted by the second oscillation imparting unit 2200 is the same as the amplitude of the oscillations in the vertical direction imparted by the first oscillation imparting unit 2100. Therefore, if the first transport platform 2012 and the third transport platform 2016 are at the same position in the vertical direction before the oscillation is started, then the two transport platforms are at the same position in the vertical direction during the oscillations of the two transport platforms.

Drive Motor

The drive motor 2300 is a motor for rotating each of the input shafts 2110 and 2210 of the first oscillation imparting unit 2100 as well as the second oscillation imparting unit 2200. That is to say, the drive motor 2300 of the present embodiment is a common driving source of the first oscillation imparting unit 2100 and the second oscillation imparting unit 2200 and only one drive motor is provided in the product transport apparatus 2001. As noted above, the drive motor 2300 is fastened to the housing 2130 of the first oscillation imparting unit 2100, and the drive shaft (not shown) of the drive motor 2300 is directly coupled to one end portion in an axial direction of the input shaft 2110 of the first oscillation imparting unit 2100. Then, when the drive shaft of the drive motor 2300 rotates, its driving force is transmitted simultaneously to each of the input shafts 2110 and 2210 of the first oscillation imparting unit 2100 and the second oscillation imparting unit 2200.

Steel Belts

The steel belts 2030 are strip-shaped steel members straddling the product transfer sections 2012h, 2014h, 2016h, and 2018h with which each of the transport platforms are provided. These steel belts 2030 have a high strength with respect to loads in their transverse direction and their thickness direction (that is, the direction intersecting the transverse direction and the longitudinal direction), and hardly extend and contract in the longitudinal direction. On the other hand, the steel belts 2030 easily bend in the longitudinal direction. As shown in FIG. 29, such steel belts 2030 straddle the product transfer sections, bridging the gaps formed between the product transfer sections (that is, the steel belts 2030 are attached at four locations in the present embodiment). The two end portions in longitudinal direction of each of the steel belts 2030 are bolted to the side walls 2012b, 2014b, 2016b, and 2018b of the transport platforms. Therefore, the steel belts 2030 are coupled to each of the transport platforms in a state in which the shape in longitudinal direction of the steel belts 2030 is curved along the side walls 2012b, 2014b, 2016b, and 2018b (see upper diagram in FIG. 29). Thus, the steel belts 2030 straddling the product transfer sections link the transport platforms to each other, so that of two neighboring transport platforms, the oscillations of the transport platform on the upstream side are transmitted to the transport platform further on the downstream side through these steel belts 2030. Here, the steel belts 2030 bridge the gaps and are arranged in a state in which their shape in longitudinal direction is curved, so that oscillations of the transport platforms (in particular, oscillations in the revolving transport direction or the linear transport direction) can be transmitted without being disturbed. In the following, the mechanism by which each of the steel belts 2030 transmit oscillations is explained by way of example of the steel belt 2030 that straddles the product transfer section 2012h of the first transport platform 2012 and the product transfer section 2014h of the second transport platform 2014.

This steel belt 2030 transmits the oscillations in the revolving transport direction and the vertical direction that the first oscillation imparting unit 2100 imparts on the first transport platform 2012 from the first transport platform 2012 to the second transport platform 2014. In order to transmit the oscillations, this steel belt 2030 moves such that the bent portion of the steel belt 2030 shifts in the longitudinal direction of the steel belt 2030 in accordance with the oscillations of the first transport platform 2012 (more precisely, with the oscillations in the revolving transport direction). Explaining the movement of the steel belt 2030 in more detail, one end portion in a longitudinal direction of the steel belt 2030 fastened to the side wall 2012b of the first transport platform 2012 moves in the revolving transport direction integrally with the first transport platform 2012, brought about by the oscillations of the first transport platform 2012. In this situation, a gap is formed between the product transfer sections, so that the first transport platform 2012 can oscillate in the revolving transport direction without interfering with the second transport platform 2014. Then, since the movement of the one end portion in the longitudinal direction becomes the overall movement of the steel belt 2030, also the second transport platform 2014 to which the other end portion in the longitudinal direction of the steel belt 2030 is fastened moves integrally with it. In this situation, the curved portion in the longitudinal direction of the steel belt 2030 shifts in the longitudinal direction (in other words, the bending degree of the steel belt 2030 changes), and the one end portion in the longitudinal direction of the steel belt 2030 moves in the revolving transport direction, whereas the other end portion in longitudinal direction moves in the linear transport direction. Through this movement of the steel belt 2030, the oscillations in the revolving transport direction of the first transport platform 2012 are converted into oscillations in the linear transport direction of the second transport platform 2014. That is to say, the steel belt 2030 converts the oscillations of the first transport platform 2012 in the revolving transport direction into oscillations in the linear transport direction, and transmits these oscillations to the second transport platform 2014. Simultaneously, the steel belt 2030 transmits also the oscillations in the vertical direction of the first transport platform 2012 to the second transport platform 2014. As a result, the second transport platform 2014 to which the oscillations have been transmitted oscillates in the linear transport direction and the vertical direction.

With the foregoing mechanism, the steel belts 2030 straddling the product transfer sections transmit the oscillations imparted by the first oscillation imparting unit 2100. However, since the oscillations in the vertical direction attenuate easily, they are supplemented by the above-noted second oscillation imparting unit 2200. Consequently, the steel belts 2030 transmit not only the oscillations imparted by the first oscillation imparting unit 2100, but also the oscillations imparted by the second oscillation imparting unit 2200. Thus, the transport platforms can oscillate in the transport directions (the revolving transport direction or the linear transport direction), and also in the vertical direction. Furthermore, as noted above, the timings at which the oscillations are imparted by the first oscillation imparting unit 2100 and the second oscillation imparting unit 2200 are completely synchronized, so that each of the transport platforms oscillate in complete synchronization as well. As a result, the product transport apparatus 2001 of the present embodiment can transport products reliably at a constant speed along the oval track.

(3) Advantageous Effects of the Product Transport Apparatus According to the Present Embodiment

As described above, the product transport apparatus 2001 according to the present embodiment includes a first transport platform 2012 for revolvingly transporting the products through oscillations in the revolving transport direction and the vertical direction, a second transport platform 2014 for linearly transporting the products through oscillations in the linear transport direction and the vertical direction, a first oscillation imparting unit 2100 imparting oscillations on the first transport platform 2012, and a steel belt 2030 straddling the product transfer sections 2012h and 2014h of the transport platforms for transferring the products from the first transport platform 2012 to the second transport platform 2014 and transmitting the oscillations from the first transport platform 2012 to the second transport platform 2014. With the product transport apparatus 2001 of this configuration, it is possible to reduce the costs of the product transport apparatus 2001. The following is an explanation of the advantageous effects of the product transport apparatus 2001 according to this embodiment.

As explained in the Related Art section, during the transport of the products with the product transport apparatus, the products may be subjected to various kinds of operations, such as inspection, process, or printing. In order to perform these various operations on the products while they are being transported, it is necessary to ensure sufficient space and time for performing these operations. As a measure for ensuring this time and space, it is possible to form a long transport path by providing the product transport apparatus with a plurality of transport platforms and combining this plurality of transport platforms. Moreover, in order to line up the products in a straight line for the purpose of facilitating these operations, straight rail-shaped transport platforms may be included among the plurality of transport platforms. Moreover, with products such as pharmaceuticals, it may be necessary to carry out repeated inspections for a so-called validation, so that a circulating transport path may be formed by the plurality of transport platforms.

Now, in order to transport the products using oscillations of each of the transport platforms in the product transport apparatus provided with a plurality of transport platforms, it is necessary to oscillate each of the transport platforms in the transport direction and the vertical direction. Moreover, in order to oscillate each of the transport platforms, the product transport apparatus is provided with an oscillation imparting mechanism that imparts oscillations from outside the transport platforms. However, if such an oscillation imparting mechanism is provided for each transport platform, then the manufacturing cost of the product transport apparatus rises by the number of oscillation imparting mechanisms increased.

By contrast, the product transport apparatus 2001 of the present embodiment is provided with steel belts 2030 as “oscillation transmitting members”, and it is possible to transmit the oscillations imparted by the first oscillation imparting unit 2100 (that is, the oscillations in the revolving transport direction and the vertical direction) to all transport platforms with the steel belts 2030. Accordingly, it is not necessary to provide an oscillation imparting unit for each transport platform, so that the space for installing the oscillation imparting units can be reduced and also the number oscillation imparting units can be reduced. In particular if an oval track is formed by providing a plurality of transport platforms as in the present embodiment, it becomes possible to reduce the number of oscillation imparting units to the necessary minimum (two in the present embodiment) while letting all transport platforms oscillate properly, by letting the steel belts 2030 straddle the product transfer sections of all transport platforms. As a result, the manufacturing costs of the product transport apparatus 2001 are kept low, and so the costs of the product transport apparatus 2001 can be reduced.

### (3) Other Embodiments

In the foregoing, the product transport apparatus according to the present invention was explained by way of the above third embodiment, but the above-described third embodiment of the invention is merely for the purpose of a clear understanding of the present invention and is not to be interpreted as limiting the present invention. The invention can of course be altered and improved without departing from the gist thereof and includes functional equivalents.

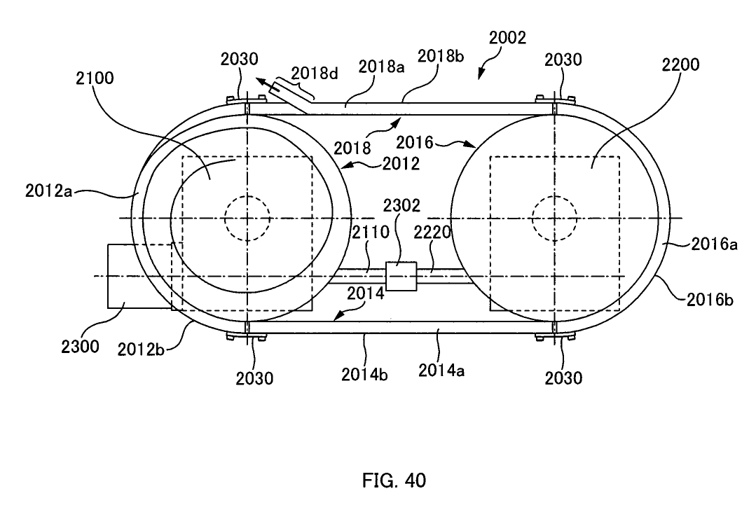

For example, the above third embodiment was explained for the case that the circulating oval track is formed by a plurality of transport platforms (hereafter referred to as the “main example”), but it is also possible that a non-circulating transport path is formed (hereafter referred to as the “first modified example), as shown in FIG. 40. FIG. 40 is a diagram showing a product transport apparatus 2002 according to the first modified example. The product transport apparatus 2002 according to the first modified example has substantially the same configuration as the product transport apparatus 2001 of the main example, but as shown in FIG. 40, it is provided with a product retrieval section 2018d at the end side in the linear transport direction of the fourth transport platform 2018, and products that are transported up to this product retrieval section 2018d are ejected from the product retrieval section 2018d and then moved to the next process.

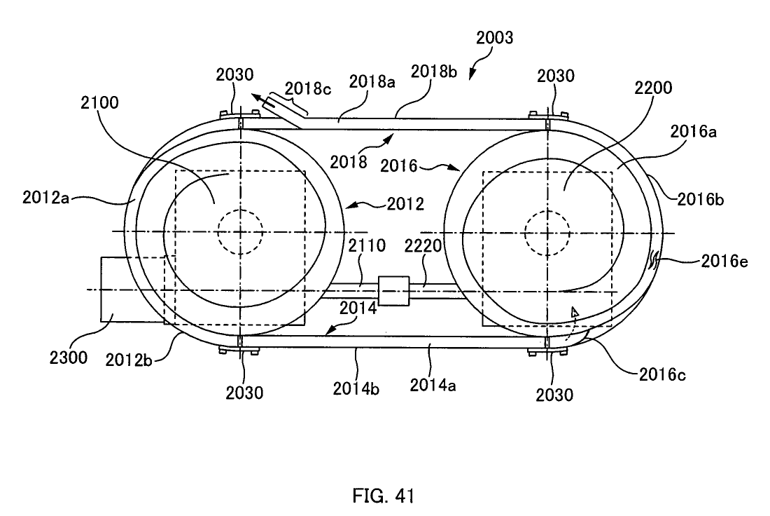

Moreover, the third embodiment was explained for a case in which the placement surface 2016a of the third transport platform 2016 is a flat surface that is curved to an arc shape along the circumference of the third transport platform 2016, but as shown in FIG. 41, it is also possible that the placement surface 2016a of the third transport platform 2016 is a spiral-shaped surface like the placement surface 2012a of the first transport platform 2012 (hereafter referred to as the “second modified example”), as shown in FIG. 41. FIG. 41 is a diagram showing a product transport apparatus 2003 according to this second modified example. If the placement surface 2016a of the third transport platform 2016 is a spiral-shaped surface, then the transport distance per round-trip around the oval track becomes longer than in the main example or the first modified example. More specifically, the products passing the product transfer section 2016h of the third transport platform 2016 are dropped to the deepest portion of the spiral-shaped placement surface 2016a (that is, the bottom of the third transport platform 2016) by a product returning section 2016c arranged at the tip of the product transfer section 2016h. After this, the dropped products move on the product placement surface 2012a such that they are moved upward on the spiral-shaped placement surface 2016a. Furthermore, a product flipping section 2016e for forcibly flipping over the orientation of the products is provided on the product surface 2016a of the third transport platform 2016 according to this modified example. This product flipping section 2016e is a member (a so-called “attachment”) that flips over the orientation of the products through a mechanical method. When a product passes this product flipping section 2016e, the product is flipped over, so that after it has passed the product flipping section 2016e, the reverse side of the product (the side that was facing the placement surface 2016a before passing the product flipping section 2016e) can be inspected. That is to say, with this modified example, it is possible to inspect the obverse side as well as the reverse side of the product. It should be noted that the members provided on the placement surface 2016a are not limited to the product flipping section 2016e, and it is also possible to provide, for example, an orientation judging member that lets only products of a desired orientation pass and drops products with other orientations to the bottom of the third transport platform 2016 to discard these products.

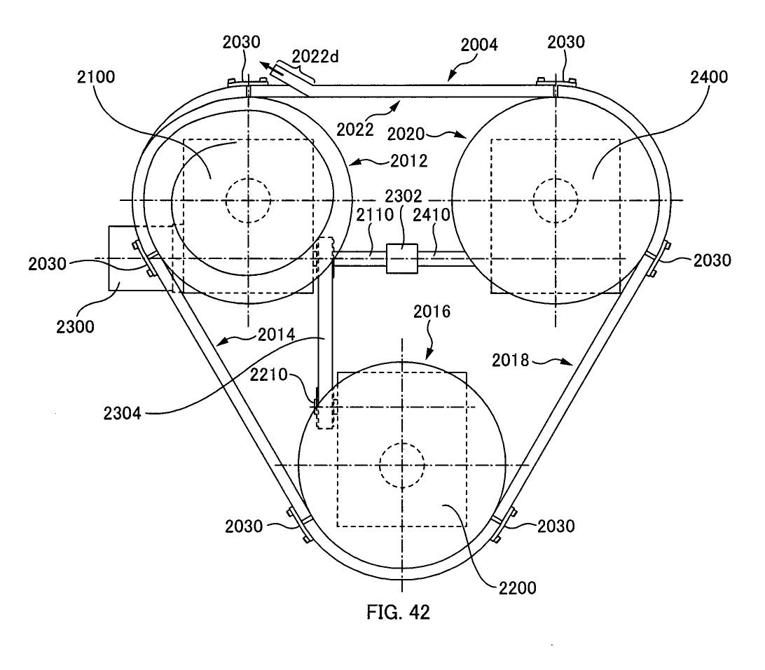

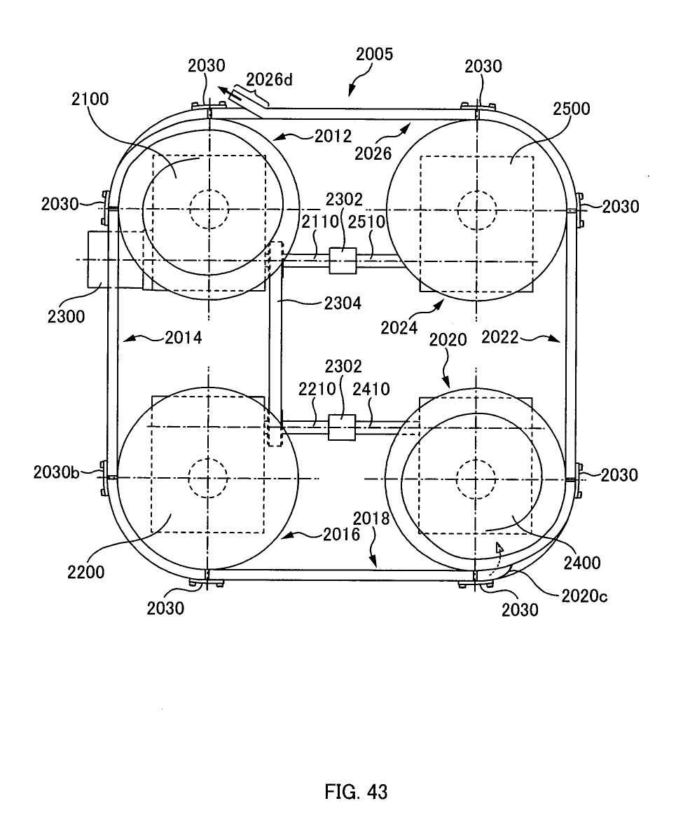

Moreover, the third embodiment was explained for the case that the oval track is formed by a plurality of transport platforms. If the transport path formed by the plurality of transport platforms is an oval track, then it is possible to ensure a sufficient transport distance for performing various operations on the products while they are being transported while reducing the set-up space for the product transport apparatus 2001. Moreover, since straight rail-shaped transport platforms (that is, the second transport platform 2014 and the fourth transport platform 2018) are provided, it becomes easy to perform operations on the products while they are lined up in a straight line. However, the shape of the transport path is not limited to an oval track. For example, it is also possible that the transport path is formed as substantially triangular (third modified example), as shown in FIG. 42, or that the transport path is formed as substantially quadrilateral (fourth modified example), as shown in FIG. 43. FIGS. 42 and 43 are diagrams showing a product transport apparatus 2004 according to the third modified example and a product transport apparatus 2005 according to the fourth modified example, respectively.

The product transport apparatus 2004 according to the third modified example includes, in addition to the transport platforms of the product transport apparatus 2001 of the main example, a fifth transport platform 2020 that revolvingly transports the products through oscillations in the revolving transport direction and the vertical direction, and a sixth transport platform 2022 that linearly transports the products through oscillations in the linear transport direction and the vertical direction. In the third modified example, after the products are introduced to the product accepting section of the first transport platform 2012, they move on the transport platforms in an orderly sequence from the first transport platform 2012 to the sixth transport platform 2022, and finally are ejected from the product retrieval section 2022d provided at the end side in the transport direction of the sixth transport platform 2022.

The product transport apparatus 2005 of the fourth modified example includes, in addition to the transport platforms of the product transport apparatus 2004 of the third modified example, a seventh transport platform 2024 that revolvingly transports the products through oscillations in the revolving transport direction and the vertical direction, and an eighth transport platform 2026 that linearly transports the products through oscillations in the linear transport direction and the vertical direction. In this modified example, after the products are introduced to the product accepting section of the first transport platform 2012, they move on the transport platforms in an orderly sequence from the first transport platform 2012 to the eighth transport platform 2026, and finally are ejected from the product retrieval section 2026d provided at the end side in transport direction of the eighth transport platform 2026.

Moreover, in the third modified example, the fifth transport platform 2020 is provided with a third oscillation imparting unit 2400 for imparting oscillations in the vertical direction, and in the fourth modified example, the seventh transport platform 2024 is further provided with a fourth oscillation imparting unit 2500 for imparting oscillations in the vertical direction. The third oscillation imparting unit 2400 and the fourth oscillation imparting unit 2500 have substantially the same structure as the above-explained second oscillation imparting unit 2200. Moreover, driving force from the driving motor 2300 is transmitted via the shaft coupling 2302 and the belt transmission 2304 to the input shafts 2410 and 2510 of the third oscillation imparting unit 2400 and the fourth oscillation imparting unit 2500. Consequently, also in the third modified example and the fourth modified example, the input shafts are driven by a single drive motor 2300. It should be noted that, as shown in FIG. 43, in the fourth modified example the placement surface of the fifth transport platform 2020 is spiral-shaped and the product returning section 2020c is arranged at the tip of the product transfer section at the beginning side in the revolving transport direction of the fifth transport platform 2020, but there is no limitation to this, and the placement surface of the fifth transport platform 2020 may also be formed as a flat surface that is curved to an arc shape.

Furthermore, the transport path may also be formed to a shape that is different from these modified examples. For example, there may also be fewer transport platforms than in the main examples, and the transport path may also be formed by only the first transport platform 2012 and the second transport platform 2014.

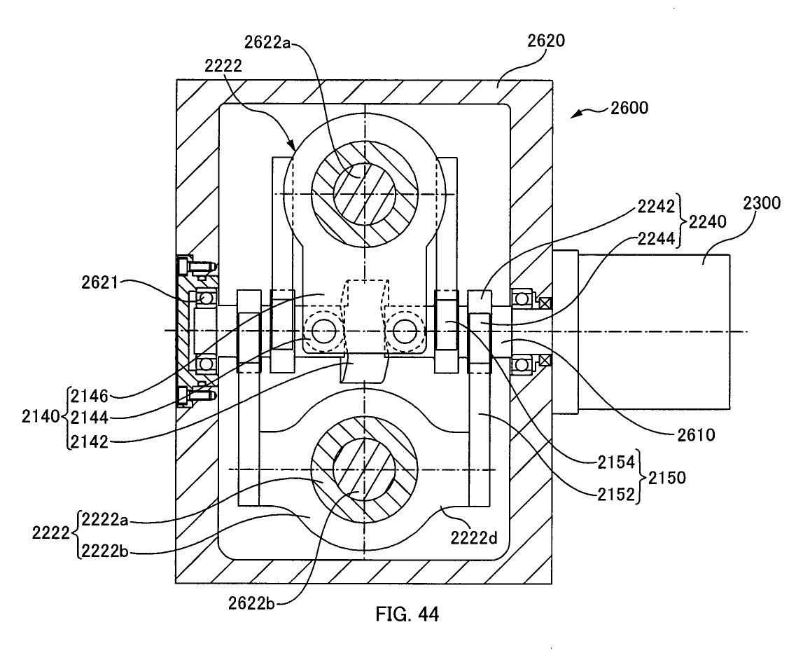

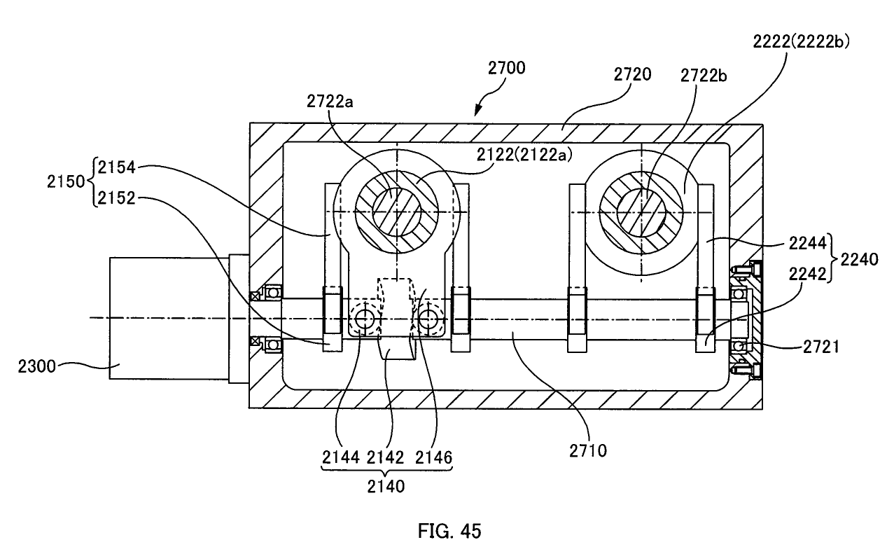

Moreover, the third embodiment was explained for the case that the first oscillation imparting unit 2100 and the second oscillation imparting unit 2200 are independent from one another. That is, the first oscillation imparting unit 2100 and the second oscillation imparting unit 2200 were explained to have their own housings 2130 and 2230, but there is no limitation to this. For example, it is also possible that the first oscillation imparting unit and the second oscillation imparting unit have a common housing. In other words, as shown in FIGS. 44 and 45, the output section 2120, the first cam mechanism 2150, and the second cam mechanism 2140 belonging to the first oscillation imparting unit 2100, as well as the output section 2220 and the first cam mechanism 2240 belonging to the second oscillation imparting unit 2200 may also be contained in the same housing. FIG. 44 is a schematic cross-sectional view of a first compound oscillation imparting unit 2600. FIG. 45 is a schematic cross-sectional view of a second compound oscillation imparting unit 2700. Both of the two diagrams show the main structural components of compound oscillation imparting units in a cross-sectional view of a section that intersects the vertical direction. The following is an explanation of the general configuration of these compound oscillation imparting units. It should be noted that in these compound oscillation imparting units, further explanations of components that are the same as the components of the above-described first oscillation imparting unit 2100 or the second oscillation imparting unit 2200 are omitted.

As shown in FIG. 44, the first compound oscillation imparting unit 2600 is provided with a common shaft 2610 driving a first cam mechanism 2150 and a second cam mechanism 2140 belonging to the first oscillation imparting unit 2100, and a first cam mechanism 2240 belonging to the second oscillation imparting unit 2200. The common shaft 2610 is fixed via bearings 2621 to the housing 2620 and one axial end portion of it is directly coupled to the drive motor 2300. Moreover, a supporting shaft 2622a supporting the turret 2122 belonging to the first oscillation imparting unit 2100 and a supporting shaft 2622b supporting the turret 2222 belonging to the second oscillation imparting unit 2200 are provided at opposite positions sandwiching the common shaft 2610. Therefore, as shown in FIG. 44, the first cam mechanism 2150 belonging to the first oscillation imparting unit 2100 and the first cam mechanism 2240 belonging to the second oscillation imparting unit 2200 are arranged to oppose each other sandwiching the common shaft 2610 inside the housing 2620. It should be noted that the lift arms 2244 belonging to the second oscillation imparting unit 2200 are positioned further outward in the axial direction of the common shaft 2610 than the lift arms 2244 belonging to the first oscillation imparting unit 2100. In order to realize this positional relation among the lift arms, the large diameter section 2222b of the turret 2222 belonging to the second oscillation imparting unit 2200 is provided with protruding sections 2222d protruding from the outer circumference of the large diameter section 2222b to the end portions in the axial direction of the common shaft 2610, and the lift arms 2244 belonging to the second oscillation imparting unit 2200 are fastened to the end portions in the longitudinal direction (that is, in the axial direction) of the protruding sections 2222d, as shown in FIG. 44.

On the other hand, as shown in FIG. 45, also in the second compound oscillation imparting unit 2700 the common shaft 2710 is supported by the housing 2720 through bearings 2721. Moreover, the support shaft 2722a supporting the turret 2122 belonging to the first oscillation imparting unit 2100 and the support shaft 2722b supporting the turret 2222 belonging to the second oscillation imparting unit 2200 are provided on the same side of the common shaft 2610 and are lined up in the axial direction of the common shaft 2610. Therefore, as shown in FIG. 45, the first cam mechanism 2150 and the second cam mechanism 2140 belonging to the first oscillation imparting unit 2100 and the first cam mechanism 2240 belonging to the second oscillation imparting unit 2200 are lined up in the axial direction.

Moreover, in the third embodiment, the oscillations imparted by the first oscillation imparting unit 2100 on the first transport platform 2012 are transmitted by the steel belt 2030 to the second transport platform 2014, but there is no limitation to this. For example, it is also possible that the first oscillation imparting unit 2100 imparts its oscillations on the second transport platform 2014 and these oscillations are transmitted from the second transport platform 2014 to the first transport platform 2012.

Furthermore, in the third embodiment, steel belts 2030 straddle the product transfer sections between all transport platforms, but there is no limitation to this. For example, it is also possible that, of the product transfer sections between the transport platforms, steel belts 2030 straddle only the product transfer sections 2012h and 2014h between the first transport platform 2012 and the second transport platform 2014. However, in the case of the third embodiment, the number of oscillation imparting units (in particular, the first oscillation imparting unit 2100) can be reduced to the necessary minimum, and the costs for the product transport apparatus 2001 are reduced. Furthermore, if steel belts 2030 are provided straddling between all of the product transfer sections of the transport platforms, then it becomes easier to synchronize the oscillations of all transport platforms. With regard to this aspect, the above-described third embodiment is preferable.

Moreover, in the third embodiment, the third transport platform 2016 is provided with a second oscillation imparting unit 2200 imparting oscillations in the vertical direction, but there is no limitation to this. For example, it is also possible that the third transport platform 2016 is not provided with an oscillation imparting unit imparting oscillation in the vertical direction. However, oscillations in the vertical direction attenuate easily, and it is difficult to oscillate all transport platforms in the vertical direction with only the oscillations in the vertical direction that are imparted by the first oscillation imparting unit 2100. Therefore, by providing the second oscillation imparting unit 2200, which supplements the oscillations in the vertical direction, it becomes possible to let all transport platforms oscillate properly in the vertical direction and perform a more proper product transport. Moreover, it is also possible that the third transport platform 2016 is provided with an oscillation imparting unit for imparting oscillations in the vertical direction and the revolving transport direction, but the oscillations in the revolving transport direction do not attenuate as easily as the oscillations in the vertical direction, and it is possible to transmit them properly with the steel belts 2030. Therefore, if a separate mechanism for imparting oscillations in the revolving transport direction were provided, then this would increase the costs of the product transport apparatus. That is to say, the product transport apparatus 2001 of the above-described embodiment achieves a good balance between performance and cost, so that with regard to this aspect, the third embodiment is preferable.

Moreover, in the third embodiment, a single drive motor 2300 for driving the first oscillation imparting unit 2100 and the second oscillation imparting unit 2200 is provided, but there is no limitation to this. For example, it is also possible to provide each of the first oscillation imparting unit 2100 and the second oscillation imparting unit 2200 with separate drive motors, each of these drive motors being servo-controlled. However, with the third embodiment, it is easier to synchronize the driving of the first oscillation imparting unit 2100 and the second oscillation imparting units 2200. Thus, it is possible to restrict shifts in the timing at which oscillations are imparted by the oscillation imparting units and to properly transmit the oscillations with oscillation transmitting members. As a result, it is possible to synchronize the oscillations of the transport platforms as well, so that it becomes possible to transport the products with the product transport apparatus more properly. Furthermore, with the third embodiment, it is sufficient to adjust the rotation speed of the rotation shaft of the drive motor 2300 when adjusting the transport speed of the products on each of the transport platforms (that is, the product transport speed), so that the adjustment of the product transport speed becomes easy. With regard to this aspect, the third embodiment is preferable.

Moreover, in the third embodiment, the number of oscillations imparted by the first oscillation imparting unit 2100 is the same as the number of oscillations imparted by the second oscillation imparting unit 2200. However, there is no limitation to this, and the two oscillation numbers may also be different. However, with the third embodiment, it is possible to suppress occurrence of an adverse influence on the product transport that may be caused by shifts in the oscillations of the transport platforms among the transport platforms. As a result, the product transport apparatus can transport the products more properly, so that with regard to this aspect, the third embodiment is preferable.

Moreover, in the third embodiment, the cam profiles of the first cams 2152 of the first oscillation imparting unit 2100 are the same as the cam profiles of the first cam 2242 of the second oscillation imparting unit 2220, but there is no limitation to this. That is, these cam profiles may also be different. However, if the third embodiment is employed, the amplitude of the oscillations of the transport platforms in the vertical direction becomes uniform, and it is possible to suppress occurrence of an adverse influence on the product transport that may occur when the amplitudes are different among the transport platforms. Thus, the transfer of the products between the product transfer sections can be performed properly, and the product transport apparatus can transport the products more properly. With regard to this aspect, the third embodiment is preferable.

Moreover, in the third embodiment, the strip-shaped steel bands 2030 straddle the product transfer sections bridging the gaps that are formed between the product transfer sections, but there is no limitation to this. It is also possible that the product transfer sections are straddled by oscillation transmitting members other than the steel belts 2030 (for example, by coil springs or the like). However, as mentioned above, the steel belts 2030 have a high strength with respect to loads in the transverse direction and the thickness direction, and they have the property of not contracting or expanding easily in the longitudinal direction. Consequently, the steel belts 2030 do not expand or contract in the longitudinal direction, bend in the transverse direction, or deform under their own weight and the like, and the oscillations are transmitted properly to all the transport platforms. Moreover, the steel belts 2030 do not resonate with the transport platforms, so that the oscillations of the transport platforms are not disturbed. Furthermore, since the steel belts 2030 straddle the product transfer sections bridging the gaps that are formed between the product transfer sections, then it becomes possible to transmit the oscillations of the transport platforms while the transport platforms oscillate without interfering with other transport platforms. With regard to this aspect, the third embodiment is preferable.

Moreover, in the third embodiment, the end portions in the longitudinal direction of the steel belts 2030 are fastened to the side walls 2012b, 2014b, 2016b, and 2018b of the transport platforms, but there is no limitation to this. It is also possible to fasten the end portions in the longitudinal direction of the steel belts 2030 to other portions of the transport platforms than the side walls 2012b, 2014b, 2016b, and 2018b (for example, the bottom surfaces of the transport platform). However, with the third embodiment, the fastening of the steel belts 2030 becomes easy. Furthermore, in the case of the third embodiment, the steel belts 2030 move such that their curved portions in the longitudinal direction move in this longitudinal direction with the oscillation of the transport platforms (more precisely, the oscillations in the transport direction of the transport platforms). Owing to this movement of the steel belts 2030, the oscillations in the revolving transport direction are converted into oscillations in the linear transport direction, and the oscillations in the linear transport direction are converted into oscillations in the revolving transport direction, and transmitted. That is to say, when the steel belts 2030 transmit the oscillations among two neighboring transport platforms from the transport platform on the upstream side to the transport platform on the downstream side, the oscillations of the transport platform on the upstream side are converted such that the transport platform on the downstream side is caused to properly oscillate in its transport direction, and these oscillations can be transmitted to the transport platform on the downstream side. As a result, the transport platforms oscillate properly and the product transport apparatus can transport the products more properly. With regard to this aspect, the third embodiment is preferable.

What is claimed is:

1. A product transport apparatus comprising:
a transport section that oscillates in a transport direction and a vertical direction in order to transport a product;
a plurality of oscillation imparting sections including a first cam mechanism for causing the transport section to oscillate in the transport direction and a second cam mechanism for causing the transport section to oscillate in the vertical direction; and
a single driving source that drives each of the plurality of oscillation imparting sections.

2. A product transport apparatus according to claim 1,
wherein the number of oscillations imparted by each of the plurality of oscillation imparting sections in the transport direction and the vertical direction is the same among the oscillation imparting sections.

3. A product transport apparatus according to claim 2,
wherein each of the plurality of oscillation imparting sections includes:
a housing for containing the first cam mechanism and the second cam mechanism;
an input shaft rotatably supported by the housing in order to drive the first cam mechanism and the second cam mechanism, and
an output section that fastens and supports the transport section above the output section, the output section being supported by the housing so that it can oscillate in the transport direction and the vertical direction, and
wherein the first cam mechanism and the second cam mechanism oscillate the output section and the transport section integrally.

4. A product transport apparatus according to claim 3,
wherein a rotatable first cam of the first cam mechanism and a rotatable second cam of the second cam mechanism are supported by the input shaft, and the first cam and the second cam rotate integrally with the input shaft.

5. A product transport apparatus according to claim 4,
wherein the first cam of each of the plurality of oscillation imparting sections has such a cam profile that the amplitude in the transport direction of the oscillations imparted by each of the plurality of oscillation imparting sections is the same among the oscillation imparting sections.

6. A product transport apparatus according to claim 5,
wherein the second cam of each of the plurality of oscillation imparting sections has such a cam profile that the amplitude in the vertical direction of the oscillations imparted by each of the plurality of oscillation imparting sections is the same among the oscillation imparting sections.

7. A product transport apparatus according to claim 2,
wherein the transport section includes a plurality of transport platforms that are lined up in the transport direction,
a gap is formed between the neighboring transport platforms, and
an oscillation imparting section is provided for each of the plurality of transport platforms.

8. A product transport apparatus according to claim 7,
wherein the plurality of transport platforms are lined up in the transport direction such that they form an oval path.

9. A product transport apparatus according to claim 2,
wherein the transport section is a rectangular transport platform whose longitudinal direction coincides with the transport direction, and
the plurality of oscillation imparting sections are lined up in a straight line in the longitudinal direction of the transport platform.

10. A product transport apparatus according to claim 2,
wherein the transport section is a rectangular transport platform whose transverse direction coincides with the transport direction, and
the plurality of oscillation imparting sections are lined up in a straight line in the longitudinal direction of the transport platform.

11. A product transport apparatus comprising:
an oscillation plate that oscillates in a transport direction and a vertical direction in order to linearly transport a product;
at least one first oscillation imparting unit that imparts oscillations in the transport direction to the oscillation plate through a cam mechanism; and
at least three second oscillation imparting units that impart oscillations in the vertical direction to the oscillation plate through a cam mechanism.

12. A product transport apparatus according to claim 11,
wherein the oscillation plate includes a rectangular placement surface for placing the product thereon,
the longitudinal direction and the transverse direction of the placement surface lie in a horizontal plane, and
the transport direction coincides with either the longitudinal direction or the transverse direction of the placement surface.

13. A product transport apparatus according to claim 12,
wherein the at least three second oscillation imparting units include:
a second oscillation imparting unit that imparts oscillations on the oscillation plate at a position that is different, with respect to the longitudinal direction of the placement surface, from another second oscillation imparting unit; and
a second oscillation imparting unit that imparts oscillations on the oscillation plate at a position that is different, with respect to the transverse direction of the placement surface, from another second oscillation imparting unit.

14. A product transport apparatus according to claim 13,
wherein each of the at least three second oscillation imparting units imparts oscillations at an end portion of the oscillation plate in at least one direction of the longitudinal direction and the transverse direction of the placement surface.

15. A product transport apparatus according to claim 11,
wherein a single drive motor is provided for driving the at least one first oscillation imparting unit and the at least three second oscillation imparting units.

16. A product transport apparatus according to claim 11,
wherein each of the at least one first oscillation imparting unit includes
a first output section that fastens and supports the oscillation plate by an upper surface of the first output section, a first output section being able to be oscillated in the transport direction, and
a first cam mechanism for oscillating the first output section and the oscillation plate integrally in the transport direction, and each of the at least three second oscillation imparting units includes
a second output section that fastens and supports the oscillation plate by an upper surface of the second output section, second output section being able to be oscillated in the vertical direction, and
a second cam mechanism for oscillating the second output section and the oscillation plate integrally in the vertical direction.

17. A product transport apparatus according to claim 16,
wherein a cam profile of a first cam provided in a first cam mechanism of each of the at least one first oscillation imparting unit is the same among the first oscillation imparting units; and
a cam profile of a second cam provided in a second cam mechanism of each of the at least three second oscillation imparting units is the same among the second oscillation imparting units.

18. A product transport apparatus according to claim 11,
wherein a number of oscillations in the transport direction imparted by each of the at least one first oscillation imparting unit is the same among the first oscillation imparting units,
a number of oscillations in the vertical direction imparted by each of the at least three second oscillation imparting units is the same among the second oscillation imparting units, and
the number of oscillations in the transport direction and the number of oscillations in the vertical direction are the same.

19. A product transport apparatus according to claim 11,
comprising only one first oscillation imparting unit.

20. A product transport apparatus comprising:
a transport platform for revolvingly transporting a product by oscillating in a revolving transport direction and a vertical direction;
a transport platform for linearly transporting the product by oscillating in a linear transport direction and a vertical direction;
a cam-type oscillation imparting mechanism that imparts oscillations on one of the two transport platforms; and
an oscillation transmitting member that transmits oscillations from one transport platform to another transport platform, the oscillation transmitting member straddling product transfer sections that are provided on each of the transport platforms for performing a product transfer from one transport platform to the other transport platform.

21. A product transport apparatus according to claim 20,
wherein the one transport platform is a first transport platform for revolvingly transporting the product by oscillating in the revolving transport direction and the vertical direction, and
the other transport platform is a second transport platform for linearly transporting the product by oscillating in the linear transport direction and the vertical direction.

22. A product transport apparatus according to claim 21,
wherein the oscillation transmitting member is a first oscillation transmitting member for transmitting the oscillations from the first transport platform to the second transport platform, and
the product transport apparatus further includes
a third transport platform for revolvingly transporting the product by oscillating in the revolving transport direction and the vertical direction, and
a second oscillation transmitting member that straddles product transfer sections that are provided on each of the second transport platform and the third transport platform for performing a product transfer from the second transport platform to the third transport platform, the second oscillation transmitting member transmitting the oscillations from the second transport platform to the third transport platform.

23. A product transport apparatus according to claim 22,
wherein the product transport apparatus further includes:
a fourth transport platform for linearly transporting the product by oscillating in the linear transport direction and the vertical direction; and
a third oscillation transmitting member that straddles product transfer sections that are provided on each of the third transport platform and the fourth transport platform for performing a product transfer from the third transport platform to the fourth transport platform, the third oscillation transmitting member transmitting the oscillations from the third transport platform to the fourth transport platform, and
the first transport platform, the second transport platform, the third transport platform, and the fourth transport platform forming an oval transport path.

24. A product transport apparatus according to claim 23,
wherein the first oscillation transmitting member, the second oscillation transmitting member, and the third oscillation transmitting member are strip-shaped steel belts; and
the steel belts straddle the product transfer sections bridging gaps that are formed between the product transfer sections.

25. A product transport apparatus according to claim 24,
wherein each of the first transport platform, the second transport platform, the third transport platform, and the fourth transport platform includes
a placement surface for placing the product, and
a side wall that is provided at an end portion in a width direction of the placement surface, so as to intersect the placement surface, and
both end portions in the longitudinal direction of the steel belts are fastened to the side walls.

26. A product transport apparatus according to claim 22,
wherein the cam-type oscillation imparting mechanism is a first cam-type oscillation imparting mechanism that imparts oscillations in the revolving transport direction and the vertical direction on the first transport platform; and
the product transport apparatus further comprises a second cam-type oscillation imparting mechanism that imparts oscillations in the vertical direction on the third transport platform.

27. A product transport apparatus according to claim 26,
wherein a single drive motor is provided for driving the first cam-type oscillation imparting mechanism and the second cam-type oscillation imparting mechanism.

28. A product transport apparatus according to claim 26,
wherein a number of oscillations imparted by the first cam-type oscillation imparting mechanism is the same as the number of oscillations imparted by the second cam-type oscillation imparting mechanism.

29. A product transport apparatus according to claim 26,
wherein a cam profile with which the first cam-type oscillation imparting mechanism is provided for imparting the oscillations in the vertical direction is the same as a cam profile with which the second cam-type oscillation imparting mechanism is provided for imparting the oscillations in the vertical direction.
